(19) United States
(12) Patent Application Publication
(10) Pub. No.: US 2025/0365730 A1
(43) Pub. Date: Nov. 27, 2025

(54) AVOIDANCE-BASED COEXISTENCE IN SHARED SPECTRUM

(71) Applicant: Samsung Electronics Co., Ltd., Suwon-si (KR)

(72) Inventors: Ebrahim MolavianJazi, San Jose, CA (US); Marian Rudolf, Longueuil (CA); Aristides Papasakellariou, Houston, TX (US)

(21) Appl. No.: 19/208,460

(22) Filed: May 14, 2025

Related U.S. Application Data
(60) Provisional application No. 63/651,873, filed on May 24, 2024.

(51) Int. Cl. H04W 72/1273; H04W 72/231; H04W 72/232; H04W 72/563

(52) U.S. Cl. CPC H04W 72/1273; H04W 72/231; H04W 72/232; H04W 72/563

(57) ABSTRACT

Methods and apparatuses for avoidance-based coexistence in shared spectrum. A method for a user equipment (UE) includes receiving first information for a number of resource patterns and receiving an indication of respective updated resources for first resource patterns, from the number of resource patterns. The respective updated resources for a first resource pattern, from the first resource patterns, add first resources to or exclude second resources from, respective resources of the first resource pattern as indicated by the first information. The method further includes receiving an indication of activated resource patterns from the number of resource patterns, receiving an indication of scheduling or activating a reception of a physical downlink shared channel (PDSCH) in third resources, determining applicable resource patterns, from the activated resource patterns, for the PDSCH reception based on an indication, determining fourth resources for the PDSCH reception, and receiving the PDSCH in the fourth resources.

### CROSS-REFERENCE TO RELATED AND CLAIM OF PRIORITY

The present application claims priority under 35 U.S.C. § 119 (e) to U.S. Provisional Patent Application No. 63/651,873 filed on May 24, 2024, which is hereby incorporated by reference in its entirety.

### TECHNICAL FIELD

The present disclosure relates generally to wireless communication systems and, more specifically, the present disclosure is related to apparatuses and methods for avoidance-based coexistence in shared spectrum.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to avoidance-based coexistence in shared spectrum.

In one embodiment, a method for a user equipment (UE) is provided. The method includes receiving first information, from higher layers, for a number of resource patterns and receiving a first downlink control information (DCI) format or a first medium-access-control control-element (MAC-CE) command indicating respective updated resources for first resource patterns, from the number of resource patterns. The respective updated resources for a first resource pattern, from the first resource patterns, have a respective periodicity different from, add first resources to, exclude second resources from, or correspond to a value of a parameter different from, respective resources of the first resource pattern as indicated by the first information. The method further includes receiving a second DCI format or a second MAC-CE command indicating activated resource patterns from the number of resource patterns, receiving a third DCI format scheduling or activating a reception of a physical downlink shared channel (PDSCH) in third resources, determining applicable resource patterns, from the activated resource patterns, for the PDSCH reception based on an indication, determining fourth resources for the PDSCH reception, and receiving the PDSCH in the fourth resources. The fourth resources are the third resources, except any resources overlapping with resources in resource patterns from the applicable resource patterns.

In another embodiment, a UE is provided. The UE includes a transceiver configured to receive first information, from higher layers, for a number of resource patterns and receive a first DCI format or a first MAC-CE command indicating respective updated resources for first resource patterns, from the number of resource patterns. The respective updated resources for a first resource pattern, from the first resource patterns, have a respective periodicity different from, add first resources to, exclude second resources from, or correspond to a value of a parameter different from, respective resources of the first resource pattern as indicated by the first information. The transceiver is further configured to receive a second DCI format or a second MAC-CE command indicating activated resource patterns from the number of resource patterns and receive a third DCI format scheduling or activating a reception of a PDSCH in third resources. The UE further includes a processor operably coupled with the transceiver. The processor is configured to determine applicable resource patterns, from the activated resource patterns, for the PDSCH reception based on an indication and determine fourth resources for the PDSCH reception. The fourth resources are the third resources, except any resources overlapping with resources in resource patterns from the applicable resource patterns. The transceiver is further configured to receive the PDSCH in the fourth resources.

In yet another embodiment, a base station is provided. The base station includes a transceiver configured to transmit first information, from higher layers, for a number of resource patterns and transmit a first DCI format or a first MAC-CE command indicating respective updated resources for first resource patterns, from the number of resource patterns. The respective updated resources for a first resource pattern, from the first resource patterns, have a respective periodicity different from, add first resources to, exclude second resources from, or correspond to a value of a parameter different from, respective resources of the first resource pattern as indicated by the first information. The transceiver is further configured to transmit a second DCI format or a second MAC-CE command indicating activated resource patterns from the number of resource patterns and transmit a third DCI format scheduling or activating a transmission of a PDSCH in third resources. The base station further includes a processor operably coupled with the transceiver. The processor is configured to determine applicable resource patterns, from the activated resource patterns, for the PDSCH transmission based on an indication and determine fourth resources for the PDSCH transmission. The fourth resources are the third resources, except any resources overlapping with resources in resource patterns from the applicable resource patterns. The transceiver is further configured to transmit the PDSCH in the fourth resources.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates a flowchart of an example procedure for multi-radio access technologies (RAT) spectrum sharing (MRSS) mechanism(s) according to embodiments of the present disclosure;

FIG. 6 illustrates a flowchart of an example procedure for MRSS mechanism(s) according to embodiments of the present disclosure;

FIG. 7 illustrates a flowchart an example procedure for MRSS mechanism(s) according to embodiments of the present disclosure;

FIG. 8 illustrates a flowchart of an example procedure for MRSS mechanism(s) according to embodiments of the present disclosure;

FIG. 9 illustrates a flowchart of an example procedure for avoidance-based MRSS mechanism(s) according to embodiments of the present disclosure;

FIG. 10 illustrates a flowchart of an example procedure for avoidance-based MRSS mechanism(s) according to embodiments of the present disclosure;

FIG. 11 illustrates a flowchart of an example procedure for avoidance-based MRSS mechanism(s) according to embodiments of the present disclosure;

FIG. 12 illustrates a flowchart of an example procedure for avoidance-based MRSS mechanism(s) according to embodiments of the present disclosure;

FIG. 13 illustrates a flowchart of an example procedure for avoidance-based MRSS mechanism(s) according to embodiments of the present disclosure;

FIG. 14 illustrates a flowchart of an example procedure for avoidance-based MRSS mechanism(s) according to embodiments of the present disclosure;

FIG. 15 illustrates a flowchart of an example procedure for avoidance-based MRSS mechanism(s) according to embodiments of the present disclosure;

FIG. 16 illustrates a flowchart of an example procedure for reverse interference avoidance-based mechanism(s) according to embodiments of the present disclosure; and

FIG. 17 illustrates a flowchart of an example procedure for reverse interference avoidance-based mechanism(s) according to embodiments of the present disclosure.

### DETAILED DESCRIPTION

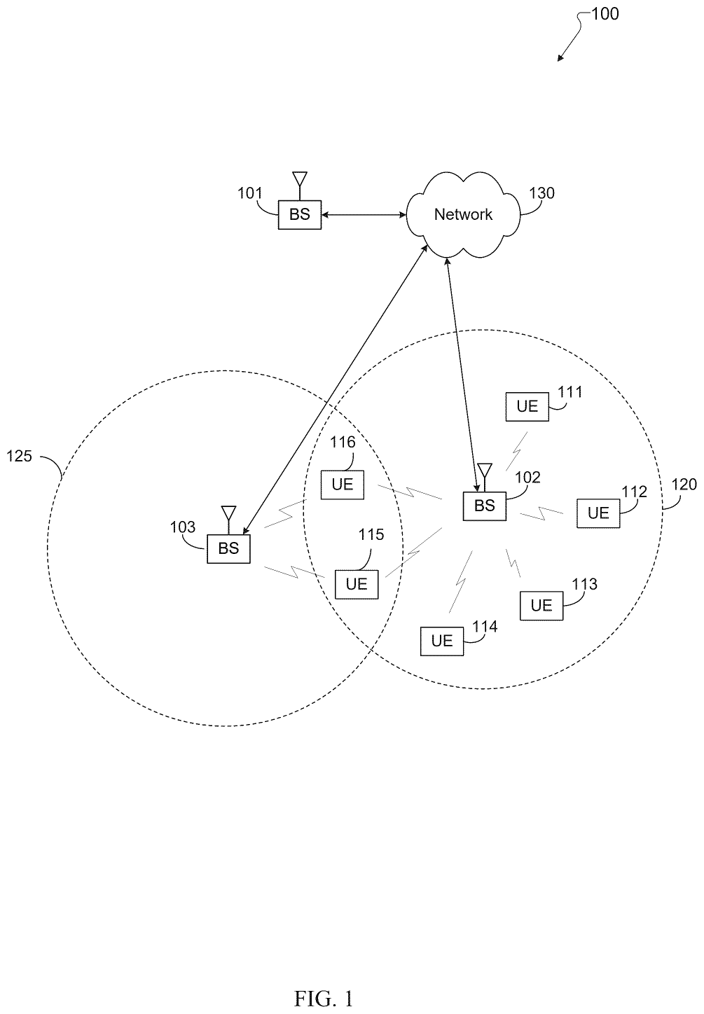

FIGS. 1-17, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents and standards descriptions are hereby incorporated by reference into the present disclosure as if fully set forth herein: [REF 1] 3GPP TS 38.211 Rel-18 v18.2.0, “NR; Physical channels and modulation;” [REF 2] 3GPP TS 38.212 Rel-18 v18.2.0, “NR; Multiplexing and channel coding;” [REF 3] 3GPP TS 38.213 Rel-18 v18.2.0, “NR; Physical layer procedures for control;” [REF 4] 3GPP TS 38.214 Rel-18 v18.2.0, “NR; Physical layer procedures for data;” [REF 5] 3GPP TS 38.215 Rel-18 v18.2.0, “NR; Physical layer measurements;” [REF 6] 3GPP TS 38.321 Rel-18 v18.1.0, “NR; Medium Access Control (MAC) protocol specification;” [REF 7] 3GPP TS 38.331 Rel-18 v18.1.0, “NR; Radio Resource Control (RRC) protocol specification;” and [REF 8] 3GPP TS 38.300 Rel-18 v18.1.0, “NR; NR and NG-RAN Overall Description; Stage 2.”

FIGS. 1-3 below describe various embodiments implemented in wireless communications systems and with the use of orthogonal frequency-division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for avoidance-based coexistence in shared spectrum. In certain embodiments, one or more of the gNBs 101-103 include circuitry, programing, or a combination thereof to provide for avoidance-based coexistence in shared spectrum.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

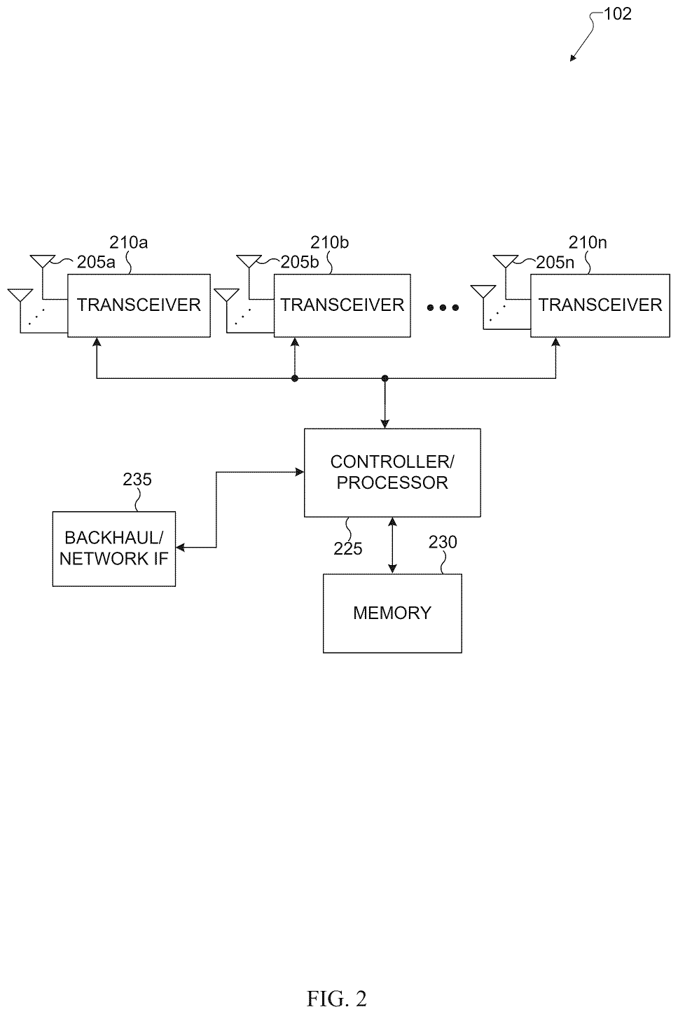

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as providing for avoidance-based coexistence in shared spectrum. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The backhaul or network interface 235 could support communications over any suitable wired or wireless connection(s). For example, when the gNB 102 is implemented as part of a cellular communication system (such as one supporting 5G/NR, LTE, or LTE-A), the backhaul or network interface 235 could allow the gNB 102 to communicate with other gNBs over a wired or wireless backhaul connection. When the gNB 102 is implemented as an access point, the backhaul or network interface 235 could allow the gNB 102 to communicate over a wired or wireless local area network or over a wired or wireless connection to a larger network (such as the Internet). The backhaul or network interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

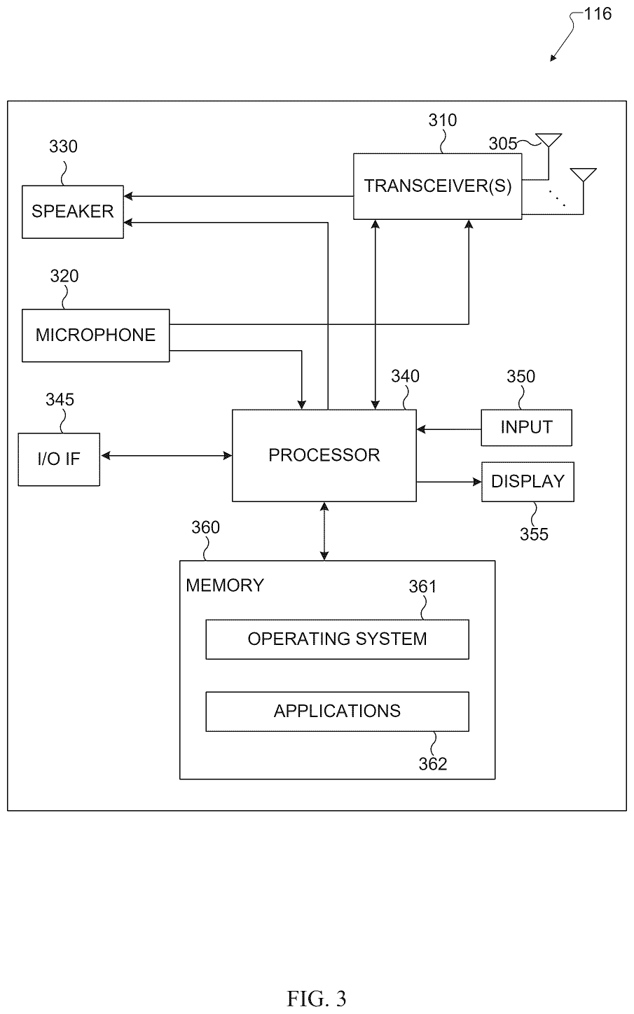

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support avoidance-based coexistence in shared spectrum as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

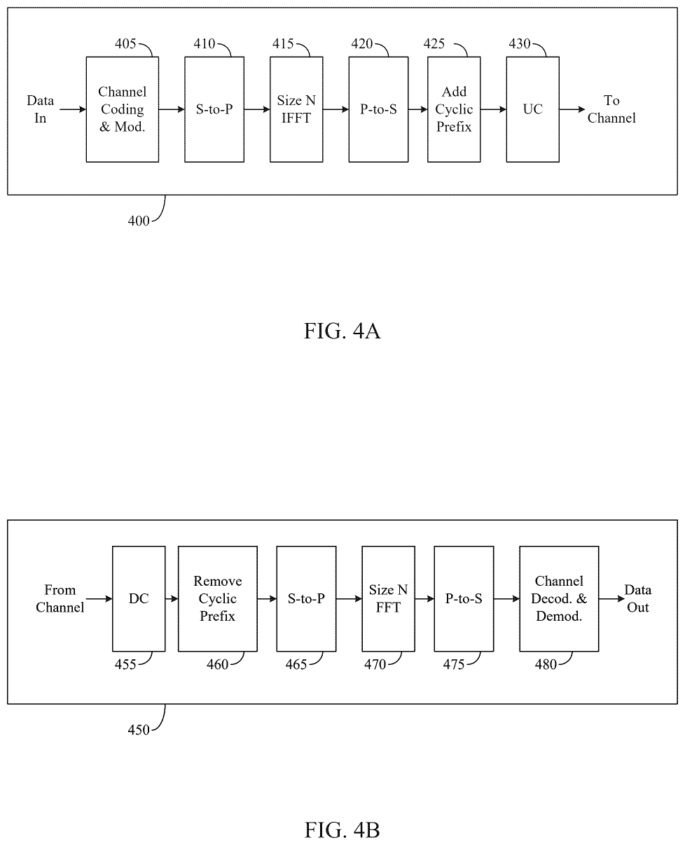

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for avoidance-based coexistence in shared spectrum as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

Due to limited spectrum availability, particularly in frequency bands below 6 GHz, also known as frequency range 1 (FR1), cellular operators may not possess sufficient spectrum to operate 6G in dedicated 6G frequency bands. Therefore, 5G NR (or even 4G LTE) spectrum may need to be re-used and/or co-exist with 6G spectrum for 6G operation, while 5G/4G base stations and UEs remain present and operate in those frequency bands.

In addition, even for higher frequency bands, such as mmWave bands that are also known as FR2, where spectrum availability is not scarce, operators may have existing 5G NR deployments with high capital expenditures (CAPEX), or high operation cost (OPEX), or that are relatively underutilized. Therefore, the operators may not prefer to deploy separate, dedicated frequency bands for their 6G network. Instead, such operators may opt to operate 6G in the same frequency bands as existing 5G NR deployments.

In such cases of multi-RAT spectrum sharing (MRSS), coexistence mechanisms need to be applied to ensure compatible and efficient usage of the shared spectrum between 6G and 5G or 4G.

To reduce implementation costs, accelerate 6G deployments, and increase spectrum efficiency, a 6G cell can operate in a spectrum that is shared with a 5G NR cell, or with other cellular releases, such as 4G LTE. In such cases, corresponding 6G BS/UEs need to coexist with 5G BS/UEs (or 4G BS/UEs) that operate in a same spectrum such as, for example, a same frequency band.

Accordingly, embodiments of the present disclosure recognize that, there is a need to introduce mechanisms to facilitate the 6G/5G (or 6G/5G/4G) coexistence, also referred to as multi-RAT spectrum sharing (MRSS), while reducing or eliminating inter-RAT interference or any other performance degradation.

Embodiments of the present disclosure further recognize that there is another need to ensure robust MRSS mechanisms to facilitate simple implementation of 6G (and later releases of 5G/4G) base stations and UEs, including semi-static MRSS, as well as adaptive MRSS mechanisms to facilitate efficient usage of the spectrum, including dynamic MRSS with low latency, when possible.

The present disclosure provides methods and apparatus for multi-RAT spectrum sharing (MRSS) operation, wherein 6G BS/UEs transmit or receive in resources, such as time/frequency/spatial (T/F/S) resources, that are separate from resources used by 5G BS/UEs (or 4G BS/UEs) to avoid or minimize multi-RAT interference or performance degradation. MRSS mechanisms can be based on inter-NB coordination or signaling (with or without core network involvement), or can be based on signaling to or procedures by the UEs, such as the 6G UEs, or 5G/4G UEs.

The embodiments may apply to any deployments, verticals, or scenarios including in FR1, FR2, FR3, FR4, with enhanced mobile broadband (eMBB), ultra-reliable low latency communications (URLLC) and industrial internet of things (IIOT), massive machine-type communications (mMTC) and internet of things (IoT) including LTE BS-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

The present disclosure provides methods and apparatus for multi-RAT spectrum sharing (MRSS) operation, wherein 6G BS/UEs transmit or receive in resources, such as time/frequency/spatial (T/F/S) resources, that are separate from resources used by 5G BS/UEs (or 4G BS/UEs) to avoid or minimize multi-RAT interference or performance degradation. MRSS mechanisms can be based on inter-NB coordination or signaling (with or without core network involvement), or can be based on signaling to or procedures by the UEs, such as the 6G UEs, or 5G/4G UEs.

The embodiments may apply to any deployments, verticals, or scenarios including in FR1, FR2, FR3, FR4, with eMBB, URLLC and IIoT, mMTC and IoT including LTE BS-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Embodiments of the disclosure are summarized in the following and are fully elaborated further herein. Combinations of the embodiments are also applicable but are not described in detail for brevity.

The present disclosure describes various embodiments, methods, or examples in terms of different RATs, such as coexistence of 6G RAT/UEs with 5G/4G RATs/UEs, or the like, and
corresponding operations such as avoidance or reuse. Such embodiments, methods, or examples can also apply to other scenarios, such as:
coexistence of different UE types, such as baseline-capability UEs, reduced capability UEs, high-capability UEs, NTN-capable UEs, fixed wireless access (FWA) UEs, V2X/sidelink UEs, IoT UEs, and so on;
coexistence of different BS types or network (NW) nodes, such as different BS/NW entities, BS/NW functions, such as NCRs, IABs, RISs, and so on;
coexistence of different cells, such as macro-cell, micro-cell, pico-cell, or other small cells, or TRPs of different kind such as TRPs with coordinated joint transmission (CJT) or with non-coordinated joint transmission (NCJT), and so on;

In various embodiments or examples throughout the present disclosure, at least the following scenarios can apply to coexistence of 6G RAT with one or both of 4G LTE RAT and 5G NR RAT.
Scenario #1 (multi-RAT spectrum sharing/MRSS): A 6G RAT operates in a spectrum that is shared with one or both of 5G RAT or 4G RAT. For example, a 6G UE operates in a spectrum/bandwidth that is shared for operation by one or both of 5G UEs or 4G UEs.
Scenario #2 (multi-RAT spectrum aggregation/MRSA, also referred to as multi-RAT carrier aggregation/MRCA): A 6G UE operates in a first 6G cell and in a second 5G/4G cell that coordinate/cooperate or otherwise jointly operate.
Scenario #3 (multi-RAT spectrum composition/MRSC, also referred to as multi-RAT connectivity/MRC): A 6G UE operates in a first 6G cell and in a second 5G/4G cell that operate independently of each other.

The MRSS objective (Scenario #1 according to one or more embodiments described herein) can be achieved using avoidance methods that preclude any interference between a 6G RAT and a 5G/4G RAT, or using reuse/cooperation/sharing methods that rely on coordination, assistance, or cooperation of the 6G RAT and the 5G/4G RAT. Herein, avoidance refers to UE-BS/inter-BS signaling, configurations, procedures, methods, and so on, that preclude a 6G UE/cell from transmitting, receiving, or otherwise using for 6G procedure/operation any T/F/S resource in which a 5G/4G UE/cell would transmit, receive, or otherwise use for a 5G/4G operation.
In a first method (BS-based avoidance), MRSS avoidance can be based on inter-BS signaling (with or without assistance/signaling from the Core Network (CN)), such as between a 6G BS/cell and a 5G/4G BS/cell in order to coordinate the corresponding T/F/S resources. For example, the 5G/4G BS can indicate information of first T/F/S resources used by the 5G/4G cell/UEs to the 6G BS, and the 6G BS can apply such information when configuring/indicating second T/F/S resources used by the 6G cell/UEs.
In a second method (UE-based avoidance), MRSS avoidance can be based on operation of 6G UEs with or without signaling between the 6G BS and the 6G UEs. For example, a 6G UE can determine or be provided information of first T/F/S resources associated with 5G/4G cell/UEs. For example, it can be predetermined in the specifications of system operation whether or how the 6G UE can receive/transmit in T/F/S resources that overlap with the first T/F/S resources.

There can be various approaches for how a 6G UE determines T/F/S resources corresponding to 5G/4G cell/UEs, such as predetermined information from the specifications of system operation, or based on certain procedures by the 6G UE, such as by acquisition of the 5G/4G system information, or by resource ‘sensing’, or from information provided by higher layer configuration or L1/L2 indication by the 6G BS.

In one embodiment, a 6G UE is provided one or multiple T/F/S patterns or one or multiple sets or groups or lists of T/F/S patterns. The 6G UE is to avoid transmissions/receptions using those patterns, for example because those patterns can be used by 5G/4G cell/UEs. The 6G UE can be predetermined to avoid configured T/F/S patterns, or the 6G UE can be indicated a number of “active” T/F/S patterns, from the configured T/F/S patterns, to avoid. In another method, the 6G UE can be provided information of priority levels for a 6G signal or channel and/or priority levels for the configured or activated T/F/S patterns, and the 6G UE avoids T/F/S patterns that have higher priority level (or same priority level) as the 6G signal or channel, while the 6G UE does not avoid T/F/S patterns that have lower priority level (or same priority level) as the 6G signal or channel. In other embodiments, parameters of the T/F/S patterns can be updated by L1/L2 signaling, such as by an indication of muting/disabling or enabling certain time occasions, frequency occasions, or transmission configuration indication (TCI) states from a T/F/S pattern.

In one embodiment, various attributes can apply to first T/F/S resources that 6G BS/UEs are to avoid. Such attributes can include, for example, a link direction, such as DL or UL, a corresponding time pattern, such as periodic, semi-persistent, or aperiodic, a priority flag or level, a granularity, and so on, as subsequently described.

In one embodiment, MRSS avoidance may apply to 5G/4G BSs, such as MRSS-aware 5G/4G UEs, that can be provided information of second T/F/S resources associated with 6G cell/UEs. For example, a 5G/4G BS can use such information when configuring/indicating resources for 5G/4G cells/UEs. In one approach (BS-based reverse avoidance), the 5G/4G BS may not need to indicate any information about the second T/F/S resources to 5G/4G UEs to perform avoidance. In another approach (UE-based reverse avoidance), the 5G/4G BS may indicate certain information about the second T/F/S resources to the 5G/4G UEs, such as MRSS-aware 5G/4G UEs, in order to avoid transmissions/receptions that use some of the second T/F/S resources.

In the following, unless otherwise noted, a parameter referenced in italics is provided by higher layers such as by RRC.

Throughout the present disclosure, a base station (BS) can refer to any base station, such as a 4G LTE eNB or a 5G NR gNB or a base station for 6G RAT that may be referred to, for example, as a uNB or a xNB or simply a NB. For example, the terms BS and NB/gNB may be used interchangeably.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A BS (such as the BS 102) transmits one or more of multiple types of RS including channel state information RS (CSI-RS) and demodulation RS (DM-RS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process including NZP CSI-RS and CSI-IM resources.

A UE (such as the UE 116) can determine CSI-RS transmission parameters through DL control signaling or higher layer signaling, such as radio resource control (RRC) signaling, from a BS (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a BS to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The BS can configure the UE to transmit signals on a cell within an active UL bandwidth part (BWP) of the cell UL BW.

UCI includes hybrid automatic repeat request (HARQ) acknowledgement (ACK) information, indicating correct or incorrect detection of data transport blocks (TBs) in a PDSCH, scheduling request (SR) indicating whether a UE has data in a buffer, and CSI reports enabling a BS to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a BS of a largest modulation and coding scheme (MCS) for the UE to detect a data TB with a predetermined block error rate (BLER), such as a 10% BLER (see NR specification), of a precoding matrix indicator (PMI) informing a BS how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A BS can use a DM-RS to demodulate information in a respective PUSCH or PUCCH. SRS is transmitted by a UE to provide a BS with an UL CSI and, for a time division duplexing (TDD) system, an SRS transmission can also provide a PMI for DL transmission. Additionally, in order to establish synchronization or an initial higher layer connection with a BS, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a synchronization signal/physical broadcast channel (SS/PBCH) block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as synchronization signal blocks (SSBs)) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are quasi co-location (QCL) with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPer (C. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot

$$( n + 3 {N}_{slot}^{subframe , μ} ) .$$

In some examples, the term ‘beam’ is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the following and throughout the disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the following, unless otherwise explicitly noted, providing a parameter value by higher layers includes providing the parameter value by master information block (MIB) or a system information block (SIB), such as a SIB1, or by a common RRC signaling, or by UE-specific RRC signaling.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with SCells or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an master cell group (MCG) or secondary cell group (SCG). A TDD UL-DL frame configuration designates a slot or symbol as one of types ‘D’, ‘U’ or ‘F’ using at least one time-domain pattern with configurable periodicity.

In the following, for brevity of description, slot format indication (SFI) refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [REF 3].

The Synchronization Signal and PBCH block (SSB) including primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The time locations of SSBs within a half-frame are determined by sub-carrier spacing and the periodicity of the half-frames where SSBs are transmitted is configured by the network (e.g., the network 130). During a half-frame, different SSBs may be transmitted in different spatial directions (i.e. using different beams, spanning the coverage area of a cell).

Within the frequency span of a carrier, multiple SSBs can be transmitted. The physical cell IDs (PCIs) of SSBs transmitted in different frequency locations do not have to be unique, i.e. different SSBs in the frequency domain can have different PCIs. However, when an SSB is associated with a remaining minimum system information (RMSI), the SSB is referred to as a Cell-Defining SSB (CD-SSB). A PCell is associated to a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed demodulation reference signal (DMRS). QPSK modulation is used for PBCH.

Measurement time resource(s) for SSB-based reference signal received power (RSRP) measurements may be confined within a SSB Measurement Time Configuration (SMTC). The SMTC configuration provides a measurement window periodicity/duration/offset information for UE radio resource management (RRM) measurement per carrier frequency. For intra-frequency connected mode measurement, up to two measurement window periodicities can be configured. For RRC_IDLE, a single SMTC is configured per carrier frequency for measurements. For inter-frequency mode measurements in RRC_CONNECTED, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for received signal strength indicator (RSSI) are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (AMC: adaptive modulation and coding) with various modulation schemes and channel coding rates is applied to the PDSCH. The same coding and modulation is applied to groups of resource blocks belonging to the same L2 protocol data unit (PDU) scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the BS to be used in link adaptation.

Measurement reports are required to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The Master Information Block (MIB) on PBCH provides the UE with parameters (e.g. CORESET #0 configuration) for monitoring of PDCCH for scheduling PDSCH that carries the System Information Block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System Information (SI) including a MIB and a number of SIBs, which are divided into Minimum SI and Other SI (OSI):
Minimum SI comprises basic information required for initial access and information for acquiring any other SI. Minimum SI including:
   MIB contains cell barred status information and essential physical layer information of the cell required to receive further system information, e.g. CORESET #0 configuration. MIB is periodically broadcast on BCH.
   SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
Other SI (OSI) encompasses SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI).

Paging allows the network to reach UEs in RRC_IDLE and in RRC_INACTIVE state through Paging messages, and to notify UEs in RRC_IDLE, RRC_INACTIVE and RRC_CONNECTED state of system information change and earthquake and tsunami warning system (ETWS)/commercial mobile alert service (CMAS) indications through Short Messages. Both Paging messages and Short Messages are addressed with paging radio network temporary identifier (P-RNTI) on PDCCH, but while the former is sent on paging control channel (PCCH), the latter is sent over PDCCH directly (see clause 6.5 of [REF 7]).

The random access procedure is triggered by a number of events:
Initial access from RRC_IDLE;
RRC Connection Re-establishment procedure;
DL or UL data arrival, during RRC_CONNECTED or during RRC_INACTIVE while small data transmission (SDT) procedure (see clause 18.0) is ongoing, when UL synchronisation status is “non-synchronised”;
UL data arrival, during RRC_CONNECTED or during RRC_INACTIVE while SDT procedure is ongoing, when there are no PUCCH resources for SR available;
Handover;
—SR failure;
Explicit request by RRC upon synchronous reconfiguration;
RRC Connection Resume procedure from RRC_INACTIVE;
To establish time alignment for a primary or a secondary TAG;
Request for Other SI (see clause 7.3);
Beam failure recovery;
Consistent UL listen-before-talk (LBT) failure on SpCell;
SDT in RRC_INACTIVE (see clause 18);
Positioning purpose during RRC_CONNECTED requiring random access procedure, e.g., when timing advance is needed for UE positioning;
Early UL synchronization with an L1/L2-triggered mobility (LTM) candidate cell;
random access channel (RACH)-based LTM cell switch.

Two types of random access procedure are supported: 4-step RA type with MSG1 and 2-step RA type with MSGA. Both types of RA procedure support contention-based random access (CBRA) and contention-free random access (CFRA).

The MSG1 of the 4-step RA type includes a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure. For CBRA, if contention resolution is successful upon receiving the network response, the UE ends the random access procedure; while if fallback indication is received in MSGB, the UE performs MSG3 transmission using the UL grant scheduled in the fallback indication and monitors contention resolution. If contention resolution is not successful after MSG3 (re) transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it. To support UE power ramping, the UE may perform MSG1 retransmission as indicated by the network.

For random access in a cell configured with supplementary uplink (SUL), the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, uplink transmissions of the random access procedure remain on the selected carrier.

The network can associate a set of RACH resources with feature(s) applicable to a Random Access procedure: Network Slicing (see clause 16.3), (e) RedCap (see clause 16.13), SDT (see clause 18), and NR coverage enhancement (see clause 19). A set of RACH resources associated with a feature is only valid for random access procedures applicable to at least that feature; and a set of RACH resources associated with several features is only valid for random access procedures having at least these features. The UE (e.g., the UE 116) selects the set(s) of applicable RACH resources, after uplink carrier (i.e. normal uplink (NUL) or supplementary uplink (SUL)) and BWP selection and before selecting the RA type.

When carrier aggregation (CA) is configured, random access procedure with 2-step RA type is only performed on PCell while contention resolution can be cross-scheduled by the PCell.

When CA is configured, for random access procedure with 4-step RA type, the first three steps of CBRA occur on the PCell while contention resolution (step 4) can be cross-scheduled by the PCell. The three steps of a CFRA started on the PCell remain on the PCell. CFRA on SCell can only be initiated by the BS (e.g., the BS 102) to establish timing advance for a secondary TAG: the procedure is initiated by the BS with a PDCCH order (step 0) that is sent on an activated SCell of the secondary TAG, preamble transmission (step 1) takes place on the SCell, and Random Access Response (step 2) takes place on PCell.

When two TAG IDs are configured for the serving cell, the TAG for which the TA command is applied is indicated in Random Access Response message or in MSGB.

The following describes methods for PDSCH resource mapping.

When receiving the PDSCH scheduled with SI-RNTI and the system information indicator in DCI is set to 0, the UE shall assume that no SS/PBCH block, after puncturing if applicable, is transmitted in REs used by the UE for a reception of the PDSCH.

When receiving the PDSCH scheduled with SI-RNTI and the system information indicator in DCI is set to 1, random access (RA)-RNTI, MSGB-RNTI, P-RNTI or TC-RNTI, the UE assumes SS/PBCH block transmission according to ssb-PositionsInBurst, and if the PDSCH resource allocation overlaps with physical resource blocks (PRBs) containing SS/PBCH block transmission resources the UE shall assume that the PRBs containing SS/PBCH block transmission resources, after puncturing if applicable, are not available for PDSCH in the OFDM symbols where SS/PBCH block is transmitted.

A UE expects a configuration provided by ssb-PositionsInBurst in ServingCellConfigCommon to be same as a configuration provided by ssb-PositionsInBurst in SIB1.

When receiving PDSCH scheduled by PDCCH with cyclic redundancy check (CRC) scrambled by cell RNTI (C-RNTI), modulation and coding scheme-cell (MCS-C)-RNTI, configured scheduling RNTI (CS-RNTI), group RNTI (G-RNTI), group configures scheduling RNTI (G-CS-RNTI), multicast/broadcast services control channel (MCCH)-RNTI, multicast-MCCH-RNTI or PDSCHs with semi-persistent scheduling (SPS), the REs corresponding to the configured or dynamically indicated resources in Clauses 5.1.4.1, 5.1.4.2 are not available for PDSCH. Furthermore, the UE assumes SS/PBCH block transmission according to ssb-PositionsInBurst if the PDSCH resource allocation overlaps with PRBs containing SS/PBCH block transmission resources, after puncturing if applicable, and the UE shall assume that the PRBs containing SS/PBCH block transmission resources, after puncturing if applicable, are not available for PDSCH in the OFDM symbols where SS/PBCH block associated with the same PCI is transmitted.

A UE is not expected to handle the case where PDSCH DM-RS REs are overlapping, even partially, with any RE(s) not available for PDSCH.

For operation with shared spectrum channel access, SS/PBCH block transmission according to ssb-PositionsInBurst represents the candidate SS/PBCH blocks corresponding to SS/PBCH block indices provided by ssb-PositionsInBurst as described in Clause 4.1 of [REF 3].

The following describes methods for PDSCH resource mapping with RB symbol level granularity.

The procedures for PDSCH scheduled by PDCCH with DCI format 1_1 described in this clause equally apply to PDSCH scheduled by PDCCH with DCI format 1_2, by applying only the parameters of rateMatchPatternGroup IDCI-1-2, rateMatchPatternGroup2DCI-1-2 instead of rateMatchPatternGroup1 and rateMatchPatternGroup2. The procedures for PDSCH scheduled by PDCCH with DCI format 1_1 described in this clause equally apply to PDSCH scheduled by PDCCH with DCI format 1_3. The procedures for PDSCH scheduled by PDCCH with DCI format 1_0 described in this clause equally apply to PDSCH scheduled by PDCCH with DCI format 4_0, by applying only the parameters of rateMatchPatternToAddModList configured in pdsch-ConfigMCCH or pdsch-ConfigMTCH.

The procedures for PDSCH scheduled by PDCCH with DCI format 1_0 described in this clause equally apply to PDSCH scheduled by PDCCH with DCI format 4_1, and the procedures for PDSCH scheduled by DCI format 1_1 described in this clause equally apply to PDSCH scheduled by PDCCH with DCI format 4_2 by applying only the parameters of rateMatchPattern ToAddModList, rateMatchPatternGroup1 and rateMatchPatternGroup2 configured in pdsch-ConfigMulticast.

A UE may be configured with any of the following higher layer parameters indicating REs declared as not available for PDSCH:
rateMatchPatternToAddModList given by PDSCH-Config, by pdsch-ConfigMulticast, by ServingCellConfig or by ServingCellConfigCommon, or by pdsch-ConfigMCCH or pdsch-ConfigMTCH and configuring up to 4 RateMatchPattern(s) per BWP and up to 4 RateMatchPattern(s) per serving-cell. The RateMatchPatterns configured for MBS multicast are counted into the ones that are configured per BWP. The RateMatchPattern(s) configured for MBS broadcast or for MBS multicast in RRC_INACTIVE_state is counted into the ones that are configured per serving-cell. A RateMatchPattern may contain:
   within a BWP, when provided by PDSCH-Config or pdsch-ConfigMulticast or within a serving cell when provided by ServingCellConfig or ServingCellConfigCommon, or by pdsch-ConfigMCCH or pdsch-ConfigMICH, a pair of reserved resources with numerology provided by higher layer parameter subcarrierSpacing given by RateMatchPattern when configured per serving cell or by numerology of associated BWP when configured per BWP. The pair of reserved resources are respectively indicated by an RB level bitmap (higher layer parameter resourceBlocks given by RateMatchPattern) with 1RB granularity and a symbol level bitmap spanning one or two slots (higher layer parameters symbolsInResourceBlock given by RateMatchPattern) for which the reserved RBs apply. A bit value equal to 1 in the RB and symbol level bitmaps indicates that the corresponding resource is not available for PDSCH. For each pair of RB and symbol level bitmaps, a UE may be configured with a time-domain pattern (higher layer parameter periodicityAndPattern given by RateMatchPattern), where each bit of periodicityAndPattern corresponds to a unit equal to a duration of the symbol level bitmap, and a bit value equal to 1 indicates that the pair is present in the unit. The periodicityAndPattern can be {1, 2, 4, 5, 8, 10, 20 or 40} units long, but maximum of 40 msec. The first symbol of periodicityAndPattern every 40 msec/P periods is a first symbol in frame nf mod 4=0, where P is the duration of periodicity AndPattern in units of msec. When periodicityAndPattern is not configured for a pair, for a symbol level bitmap spanning two slots, the bits of the first and second slots correspond respectively to even and odd slots of a radio frame, and for a symbol level bitmap spanning one slot, the bits of the slot correspond to every slot of a radio frame. The pair can be included in one or two groups of resource sets (higher layer parameters rateMatchPatternGroup1 and rate MatchPatternGroup2). The rateMatchPatternToAddModList given by ServingCellConfig or ServingCellConfigCommon configuration in numerology u applies only to PDSCH of the same numerology u.
   within a BWP, a frequency domain resource of a CORESET configured by ControlResourceSet with controlResourceSetld or ControlResourceSetZero and time domain resource determined by the higher layer parameters monitoringSlotPeriodicityAndOffset, duration and monitoringSymbolsWithinSlot of search-space-sets configured by SearchSpace and time domain resource of search-space-set zero configured by searchSpaceZero associated with the CORESET as well as CORESET duration configured by ControlResourceSet with controlResourceSetld or ControlResourceSetZero. This resource not available for PDSCH can be included in one or two groups of resource sets (higher layer parameters rateMatchPatternGroup1 and rateMatchPatternGroup2)

A configured group rateMatchPatternGroup1 or rateMatchPatternGroup2 contains a list of indices of RateMatchPattern(s) forming a union of resource-sets not available for a PDSCH dynamically if a corresponding bit of the ‘Rate matching indicator’ field of the DCI format 1_1 scheduling the PDSCH is equal to 1. The REs corresponding to the union of resource-sets configured by RateMatchPattern(s) that are not included in either of the two groups are not available for a PDSCH scheduled by a DCI format 1_0, a PDSCH scheduled by a DCI format 1_1, and PDSCHs with SPS. When receiving a PDSCH scheduled by a DCI format 1_0 or PDSCHs with SPS activated by a DCI format 1_0, the REs corresponding to configured resources in rate MatchPatternGroup1 or rateMatchPatternGroup2 are not available for the scheduled PDSCH or the activated PDSCHs with SPS. When receiving PDSCHs with SPS activated by a DCI format 1_1, the REs corresponding to configured resources in rateMatchPatternGroup1 or rateMatchPatternGroup2 are not available for the PDSCHs with SPS if a corresponding bit of the Rate matching indicator field of the DCI format 1_1 activating the PDSCHs with SPS is equal to 1.

For a bitmap pair included in one or two groups of resource sets, the dynamic indication of availability for PDSCH applies to a set of slot(s) where the rateMatchPatternToAddModList is present among the slots of scheduled PDSCH.

If a UE monitors PDCCH candidates of aggregation levels 8 and 16 with the same starting control channel element (CCE) index in non-interleaved CORESET spanning one OFDM symbol:
and if a detected PDCCH scheduling the PDSCH has aggregation level 8, the resources corresponding to the aggregation level 16 PDCCH candidate are not available for the PDSCH;
when at least one of the PDCCH candidates of aggregation levels 8 and 16 linked as indicated by higher layer parameter searchSpaceLinkingld, the PDCCH candidates of aggregation level 16 and any other PDCCH candidate(s) linked with any of the PDCCH candidates of aggregation level 8 and 16 are not available for the PDSCH reception at the UE, if a detected PDCCH scheduling the PDSCH is associated with the PDCCH candidates of aggregation level 8 or 16.

If a PDSCH scheduled by a PDCCH would overlap with resources in the CORESET containing the PDCCH, the resources corresponding to a union of the detected PDCCH that scheduled the PDSCH and associated PDCCH DM-RS are not available for the PDSCH. When the PDCCH reception includes two PDCCH candidates from two respective search space sets, as described in clause 10.1 of [REF 3], the resources corresponding to a union of the two PDCCH candidates scheduling the PDSCH and the associated PDCCH DM-RS are not available for the PDSCH. When precoderGranularity configured in a CORESET where the PDCCH was detected is set to ‘allContiguousRBs’, the associated PDCCH DM-RS are DM-RS in REGs of the CORESET. Otherwise, the associated DM-RS are the DM-RS in REGs of the PDCCH.

The following describes methods for PDSCH resource mapping with RE symbol level granularity.

The procedures for PDSCH scheduled by PDCCH with DCI format 1_1 described in this clause equally apply to PDSCH scheduled by PDCCH with DCI format 1_2, by applying the parameters of aperiodicZP-CSI-RS-ResourceSetsToAddModListDCI-1-2 instead of aperiodic-ZP-CSI-RS-ResourceSetsToAddModList. The procedures for PDSCH scheduled by PDCCH with DCI format 1_1 described in this clause equally apply to PDSCH scheduled by PDCCH with DCI format 1_3.

The procedures for PDSCH scheduled by PDCCH with DCI format 1_0 described in this clause equally apply to PDSCH scheduled by PDCCH with DCI format 4_1 and the procedures for PDSCH scheduled by PDCCH with DCI format 1_1 described in this clause equally apply to PDSCH scheduled by PDCCH with DCI format 4_2, by applying the parameters of aperiodicZP-CSI-RS-ResourceSetsToAddModList in pdsch-ConfigMulticast instead of aperiodic-ZP-CSI-RS-ResourceSetsToAddModList in PDSCH-Config.

A UE may be configured with any of the following higher layer parameters:
REs indicated by the ‘RateMatchPatternLTE-CRS’ in lte-CRS-ToMatchAround in ServingCellConfig or ServingCellConfigCommon configuring cell-specific RS, in 15 kHz subcarrier spacing applicable only to 15 kHz subcarrier spacing PDSCH, of one LTE carrier in a serving cell are declared as not available for PDSCH.
REs indicated by ‘RateMatchPatternLTE-CRS’ in lte-(RS-PatternList1-r16 or lte-CRS-PatternList3-r18 in ServingCellConfig configuring cell-specific RS, in 15 kHz subcarrier spacing applicable only to 15 kHz subcarrier spacing PDSCH, of one LTE carrier in a serving cell are declared as not available for PDSCH.
For the UE for broadcast reception or multicast reception in RRC_INACTIVE_state, REs indicated by ‘RateMatchPatternLTE-CRS’ in pdsch-ConfigMCCH or pdsch-ConfigMTCH configuring cell-specific RS, in 15 kHz subcarrier spacing applicable only to 15 kHz subcarrier spacing PDSCH, of one LTE carrier in a serving cell are declared as not available for broadcast PDSCH. The total number of RateMatchPatternLTE-CRS for broadcast reception or multicast reception in RRC_INACTIVE_state that a UE can be configured with is the same as for unicast in Rel-15.
Each RateMatchPatternLTE-CRS configuration contains v-Shift including LTE-CRS-vshift(s), nrofCRS-Ports including LTE-CRS antenna ports 1, 2 or 4 ports, carrierFreqDL. representing the offset in units of 15 kHz subcarriers from (reference) point A to the LTE carrier centre subcarrier location, carrierBandwidthDL representing the LTE carrier bandwidth, and may also configure mbsfn-SubframeConfigList representing multimedia broadcast multicast service single frequency network (MBSFN) subframe configuration. A UE determines the CRS position within the slot according to Clause 6.10.1.2 in [15, TS 36.211], where slot corresponds to LTE subframe.
If the UE is configured by higher layer parameter PDCCH-Config with two different values of coresetPoolIndex in ControlResourceSet and is also configured by the higher layer parameter lte-CRS-PatternList1-r16 and lte-CRS-PatternList2-r16 in ServingCellConfig, the following REs are declared as not available for PDSCH:
   if the UE is configured with crs-RateMatch-PerCoresetPoolIndex, REs indicated by the CRS pattern(s) in lte-(RS-PatternList1-r16 if the PDSCH is associated with coresetPoolIndex set to ‘0’, or the CRS pattern(s) in lte-CRS-PatternList2-r16 if PDSCH is associated with coresetPoolIndex set to ‘1’;
   otherwise, REs indicated by lte-CRS-PatternList1-r16 and lte-(RS-PatternList2-r16, in ServingCellConfig.
If the UE is not configured by higher layer parameter PDCCH-Config with two different values of coresetPoolIndex in ControlResourceSet, and if the UE is configured by higher layer parameter lte-CRS-PatternList3-r18 and lte-CRS-PatternList4-r18 in Serving CellConfig, REs indicated by lte-CRS-PatternList3-r18 and lte-CRS-PatternList4-r18 are declared as not available for PDSCH.
If the UE is configured by higher layer parameter PDCCH-Config with two different values of coresetPoolIndex in ControlResourceSet and is also configured by the higher layer parameter lte-CRS-PatternList3-r18 and lte-CRS-PatternList4-r18 in ServingCellConfig, the following REs are declared as not available for PDSCH:
   if the UE is configured with crs-RateMatch-PerCoresetPoolIndex, REs indicated by the CRS pattern(s) in lte-CRS-PatternList3-r18 if the PDSCH is associated with coresetPoolIndex set to ‘0’, or the CRS pattern(s) in lte-CRS-PatternList4-r18 if PDSCH is associated with coresetPoolIndex set to ‘1’;
   otherwise, REs indicated by lte-CRS-PatternList3-r18 and lte-(RS-PatternList4-r18, in ServingCellConfig.
Within a BWP, the UE can be configured with one or more ZP CSI-RS resource set configuration(s) for aperiodic, semi-persistent and periodic time-domain behaviours (higher layer parameters aperiodic-ZP-CSI-RS-Resource SetsToAddModList, sp-ZP-CSI-RS-Resource SetsToAddModList and p-ZP-CSI-RS-ResourceSet respectively comprised in PDSCH-Config), with each ZP CSI-RS resource set including at most 16 ZP CSI-RS resources (higher layer parameter ZP-CSI-RS-Resource) in numerology of the BWP. The REs indicated by p-ZP-CSI-RS-ResourceSet are declared as not available for PDSCH. The REs indicated by sp-ZP-CSI-RS-ResourceSetsToAddModList and aperiodic-ZP-CSI-RS-ResourceSetsToAddModList are declared as not available for PDSCH when their triggering and activation are applied, respectively. The following parameters are configured via higher layer signaling for each ZP CSI-RS resource configuration:
   zp-CSI-RS-ResourceId in ZP-CSI-RS-Resource determines ZP CSI-RS resource configuration identity.
   nrofPorts in CSI-RS-ResourceMapping defines the number of CSI-RS ports, where the allowable values are given in Clause 7.4.1.5 of [REF 1].
   cdm-Type in CSI-RS-ResourceMapping defines CDM values and pattern, where the allowable values are given in Clause 7.4.1.5 of [REF 1].
   resourceMapping in ZP-CSI-RS-Resource defines the OFDM symbol and subcarrier occupancy of the ZP CSI-RS resource within a slot that are given in Clause 7.4.1.5 of [REF 1].
   periodicityAndOffset in ZP-CSI-RS-Resource defines the ZP-CSI-RS periodicity and slot offset for periodic/semi-persistent ZP CSI-RS.
For the UE in RRC_CONNECTED mode for multicast reception, p-ZP-CSI-RS-ResourceSet can be configured in pdsch-ConfigMulticast for group common (GC)-PDSCH rate matching, subject to UE capability. The REs indicated by p-ZP-CSI-RS-Resource Set are declared as not available for GC-PDSCH. The REs indicated by p-ZP-CSI-RS-ResourceSet configured in PDSCH-Config for unicast do not apply for GC-PDSCH and the REs indicated by p-ZP-CSI-RS-ResourceSet configured in pdsch-ConfigMulticast for multicast do not apply for unicast PDSCH. The total number of periodic ZP-CSI-RS-Resources that a UE can be configured with is the same as for unicast in Rel-16. If p-ZP-CSI-RS-ResourceSet is configured in both PDSCH-Config and pdsch-ConfigMulticast, it is subject to UE capability whether the p-ZP-CSI-RS-Resource Set configured in pdsch-ConfigMulticast can be different from the p-ZP-CSI-RS-ResourceSet configured in PDSCH-Config.
For the UE in RRC_CONNECTED mode for multicast reception, sp-ZP-CSI-RS-ResourceSet can be configured in pdsch-ConfigMulticast for GC-PDSCH rate matching, subject to UE capability. The REs indicated by sp-ZP-CSI-RS-ResourceSet are declared as not available for GC-PDSCH when their triggering and activation delivered by unicast PDSCH are applied. The REs indicated by sp-ZP-CSI-RS-ResourceSet configured in PDSCH-Config for unicast do not apply for GC-PDSCH and the REs indicated by sp-ZP-CSI-RS-ResourceSet configured in pdsch-ConfigMulticast for multicast do not apply for unicast PDSCH. The total number of semi-persistent ZP-CSI-RS-Resources that a UE can be configured with is the same as for unicast.

The UE may be configured with a DCI field for triggering the aperiodic ZP CSI-RS. A list of ZP-CSI-RS-ResourceSet(s), provided by higher layer parameter aperiodic-ZP-CSI-RS-ResourceSetsToAddModList in PDSCH-Config, is configured for aperiodic triggering. The maximum number of aperiodic ZP-CSI-RS-ResourceSet(s) configured per BWP is 3. The bit-length of DCI field ZP CSI-RS trigger depends on the number of aperiodic ZP-CSI-RS-ResourceSet(s) configured (up to 2 bits). Each non-zero codepoint of ‘ZP CSI-RS’ trigger in DCI format 1_1 triggers one aperiodic ‘ZP-CSI-RS-ResourceSet’ in the list aperiodic-ZP-CSI-RS-ResourceSetsToAddModList by indicating the aperiodic ZP CSI-RS resource set ID. The DCI codepoint ‘01’ triggers the resource set with ‘ZP-CSI-RS-ResourceSetId’ set to ‘1’, the DCI codepoint ‘10’ triggers the resource set with ‘ZP-CSI-RS-ResourceSetId’ set to ‘2’, and the DCI codepoint ‘11’ triggers the resource set with ‘ZP-CSI-RS-ResourceSetId’ set to ‘3’. Codepoint ‘00’ is reserved for not triggering aperiodic ZP CSI-RS. When receiving PDSCH scheduled by DCI format 1_0 or PDSCHs with SPS activated by DCI format 1_0, the REs corresponding to configured resources in aperiodic-ZP-CSI-RS-ResourceSetsToAddModList or in aperiodicZP-CSI-RS-ResourceSetsToAddModListDCI-1-2 are available for PDSCH.

When the UE is configured with multi-slot and single-slot PDSCH scheduling or pdsch-Time DomainAllocationListForMultiPDSCH, the triggered aperiodic ZP CSI-RS is applied to the slot(s) of the PDSCH(s) scheduled or the PDSCHs with SPS activated by the PDCCH containing the trigger.

For a UE configured with a list of semi-persistent ZP-CSI-RS-ResourceSet(s) provided by higher layer parameter sp-ZP-CSI-RS-ResourceSetsToAddModList:
when the UE would transmit a PUCCH with HARQ-ACK information in slot n corresponding to the PDSCH carrying the activation command, as described in clause 6.1.3.19 of [REF 6], for ZP CSI-RS resource(s), the corresponding action in [REF 6] and the UE assumption on the PDSCH RE mapping corresponding to the activated ZP CSI-RS resource(s) shall be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where □ is the subcarrier spacing (SCS) configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided.
when the UE would transmit a PUCCH with HARQ-ACK information in slot n corresponding to the PDSCH carrying the deactivation command, as described in clause 6.1.3.19 of [REF 6], for activated ZP CSI-RS resource(s), the corresponding action in [REF 6] and the UE assumption on cessation of the PDSCH RE mapping corresponding to the de-activated ZP CSI-RS resource(s) shall be applied starting from the first slot that is after slot

$$n + 3 {N}_{slot}^{subframe , μ} + \frac{{2}^{μ}}{{2}^{{μ}_{{K}_{mac}}}} \cdot {k}_{mac}$$

where □ is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided.

For a CORESET configured by the ControlResourceSet IE:

$${N}_{RB}^{CORESET}$$

is given by the higher-layer parameter frequencyDomainResources;

$${N}_{symb}^{CORESET}$$

is given by the higher-layer parameter duration, wherein

$${N}_{symb}^{CORESET} = 3$$

is supported only if the higher-layer parameter dmrs-Type A-Position equals 3;
interleaved or non-interleaved mapping is given by the higher-layer parameter cce-REG-MappingType;
L equals 6 for non-interleaved mapping and is given by the higher-layer parameter reg-BundleSize for interleaved mapping;
R is given by the higher-layer parameter interleaverSize;
n_{shift} ∈{0,1, . . . ,274} is given by the higher-layer parameter shiftIndex if provided, otherwise

$${n}_{shift} = {N}_{ID}^{cell} ;$$

for both interleaved and non-interleaved mapping:
   if the higher-layer parameter precoderGramilarity equals sameAsREG-bundle the UE may assume the same precoding being used within a REG bundle
   if the higher-layer parameter precoderGramilarity equals allContiguousRBs,
      the UE (e.g., the UE 116) may assume the same precoding being used across the resource-element groups within the set of contiguous resource blocks in the CORESET;
      the UE may assume that no resource elements in the CORESET overlap with an SSB;
      if the UE is not provided with the higher-layer parameter pdcchCandidateReception-WithCRSOverlap, the UE may assume that no resource elements in the CORESET overlap with LTE cell-specific reference signals as indicated by the higher-layer parameter lte-CRS-ToMatchAround, lte-CRS-PatternList1, lte-CRS-PatternList2, lte-CRS-PatternList3, or lte-CRS-PatternList4.

For monitoring of a PDCCH candidate by a UE, if the UE
has received ssb-PositionsInBurst in SIB1 and has not received ssb-PositionsInBurst in ServingCellConfigCommon for a serving cell, and
does not monitor PDCCH candidates in a Type0-PDCCH common search space (CSS) set, and
at least one RE for a PDCCH candidate overlaps with at least one RE of a candidate SS/PBCH block, after puncturing if applicable, corresponding to a SS/PBCH block index provided by ssb-PositionsInBurst in SIB1,
   the UE is not required to monitor the PDCCH candidate.

For monitoring of a PDCCH candidate by a UE, if the UE
has received ssb-PositionsInBurst in ServingCellConfigCommon for a serving cell, and
does not monitor PDCCH candidates in a Type0-PDCCH CSS set, and
at least one RE for a PDCCH candidate overlaps with at least one RE of a candidate SS/PBCH block, after puncturing if applicable, corresponding to a SS/PBCH block index provided by ssb-PositionsInBurst in ServingCellConfigCommon,
   the UE is not required to monitor the PDCCH candidate.

For monitoring of a PDCCH candidate by a UE, if the UE
has received ssb-PositionsInBurst in SSB-MTC AdditionalP (I for a serving cell, and
at least one RE for a PDCCH candidate overlaps with at least one RE of a candidate SS/PBCH block, after puncturing if applicable, corresponding to a SS/PBCH block index provided by ssb-PositionsInBurst in SSB-MTCAdditionalPCI with same physical cell identity as the one associated with a RS having same quasi-collocation properties as a CORESET for the PDCCH candidate,
   the UE is not required to monitor the PDCCH candidate.

A UE is not required to monitor PDCCH candidates for a Type0/0A/0B/1/1A/2/2A-PDCCH CSS set when the active TCI state for a corresponding CORESET is not associated with physCellId in ServingCellConfigCommon.

If a UE monitors the PDCCH candidate for a Type0-PDCCH CSS set on the serving cell according to the procedure described in [REF 3] clause 13, the UE may assume that no SS/PBCH block is transmitted in REs used for monitoring the PDCCH candidate on the serving cell.

If at least one RE of a PDCCH candidate for a UE on the serving cell overlaps with at least one RE of lte-CRS-ToMatchAround or of LTE-CRS-PatternList, the UE
is not required to monitor the PDCCH candidate if the UE is not provided pdcchCandidate Reception-WithCRSOverlap,
monitors the PDCCH candidate if the UE is provided pdcchCandidateReception-WithCRSOverlap and the UE indicates an associated capability corresponding to the configuration of lte-CRS-ToMatchAround or of LTE-CRS-PatternList [TS 38.306].

If a UE is provided availableRB-SetsPerCell, the UE is not required to monitor PDCCH candidates that overlap with any RB from RB sets that are indicated as unavailable for receptions by an available RB set indicator field in DCI format 2_0 as described in [REF 3] clause 11.1.1. If the UE does not obtain the available RB set indicator for a symbol, the UE monitors PDCCH candidates on RB sets in the symbol.

For each DL BWP configured to a UE in a serving cell, the UE can be provided by higher layer signalling with
P≤3 CORESETs if coresetPoolIndex is not provided, or if a value of coresetPoolIndex is same for CORESETs if coresetPoolIndex is provided
P≤5 CORESETs if coresetPoolIndex is not provided for a first CORESET, or is provided and has a value 0 for a first CORESET, and is provided and has a value 1 for a second CORESET

For each CORESET, the UE is provided the following by ControlResourceSet:
a CORESET index p, by controlResourceSetld or by controlResourceSetld-v1610, where
   0<p<12 if coresetPoolIndex is not provided, or if a value of coresetPoolIndex is same for CORESETs if coresetPoolIndex is provided;
   0<p<16 if coresetPoolIndex is not provided for a first CORESET, or is provided and has a value 0 for a first CORESET, and is provided and has a value 1 for a second CORESET;
a DM-RS scrambling sequence initialization value by pdcch-DMRS-ScramblingID;
a precoder granularity for a number of REGs in the frequency domain where the UE can assume use of a same DM-RS precoder by precoderGramilarity;
a number of consecutive symbols provided by duration;
a set of resource blocks provided by frequencyDomainResources;
CCE-to-REG mapping parameters provided by cce-REG-MappingType;
an antenna port quasi co-location, from a set of antenna port quasi co-locations provided by TCI-State, indicating quasi co-location information of the DM-RS antenna port for PDCCH reception;
an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect
to be configured a set of resource blocks of a CORESET that includes more than four sub-sets of resource blocks that are not contiguous in frequency
any RE of a CORESET to overlap with any RE determined from
lte-CRS-ToMatchAround or LTE-CRS-PatternList, if the UE is not provided pdcchCandidate Reception-WithCRSOverlap, or
a SS/PBCH block.

An NG-RAN node is either:
a BS, providing NR user plane and control plane protocol terminations towards the UE; or
an ng-BS, providing E-UTRA user plane and control plane protocol terminations towards the UE.

The BSs and ng-BSs are interconnected with each other by means of the Xn interface. The BSs and ng-BSs are also connected by means of the NG interfaces to the 5GC, more specifically to the AMF (Access and Mobility Management Function) by means of the NG-C interface and to the UPF (User Plane Function) by means of the NG-U interface (see TS 23.501). Note that the architecture and the F1 interface for a functional split are defined in TS 38.401.

The BS (e.g., the BS 102) and ng-BS host the following functions:
Functions for Radio Resource Management: Radio Bearer Control, Radio Admission Control, Connection Mobility Control, Dynamic allocation of resources to UEs in uplink, downlink and sidelink (scheduling);
IP and Ethernet header compression, uplink data decompression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or operation and management (OAM));
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for non access stratum (NAS) messages;
Radio access network sharing;
Dual Connectivity;
Tight interworking between NR and E-UTRA;
Maintain security and radio configuration for User Plane CIOT 5GS Optimisation, as defined in TS 23.501 (ng-BS only).

Note that BL UE or UE in enhanced coverage is only supported by ng-BS, see TS 36.300. Note that NB-IoT UE is only supported by ng-BS, see TS 36.300.

The Xn User plane (Xn-U) interface is defined between two NG-RAN nodes. The transport network layer is built on IP transport and general packet radio service (GPRS) tunneling protocol user plane (GTP-U) is used on top of UDP/IP to carry the user plane PDUs.

Xn-U provides non-guaranteed delivery of user plane PDUs and supports the following functions:
Data forwarding;
Flow control.

Further details of Xn-U can be found in TS 38.420.

The Xn control plane interface (Xn-C) is defined between two NG-RAN nodes. The transport network layer is built on stream control transmission protocol (SCTP) on top of IP. The application layer signalling protocol is referred to as XnAP (Xn Application Protocol). The SCTP layer provides the guaranteed delivery of application layer messages. In the transport IP layer point-to-point transmission is used to deliver the signalling PDUs.

The Xn-C interface supports the following functions:
Xn interface management;
UE mobility management, including context transfer and RAN paging;
Dual connectivity.

Further details of Xn-C can be found in TS 38.420.

The inter-BS procedure for Resource Status Reporting Initiation is described in the following.

This procedure is used by an NG-RAN node to request the reporting of load measurements to another NG-RAN node.

The procedure uses non UE-associated signalling.

NG-RAN node₁ initiates the procedure by sending the RESOURCE STATUS REQUEST message to NG-RAN node₂ to start a measurement, stop a measurement or add cells to report for a measurement. Upon receipt, NG-RAN node₂:
shall initiate the requested measurement according to the parameters given in the request in case the Registration Request IE set to “start”; or
shall stop cells measurements and terminate the reporting in case the Registration Request IE is set to “stop”; or
shall add cells indicated in the Cell To Report List IE to the measurements initiated before for the given measurement IDs, in case the Registration Request IE is set to “add”. If measurements are already initiated for a cell indicated in the Cell To Report List IE, this information shall be ignored.

If the Registration Request IE is set to “start” in the RESOURCE STATUS REQUEST message and the Report Characteristics IE indicates cell specific measurements, the Cell To Report List IE shall be included.

If Registration Request IE is set to “add” in the RESOURCE STATUS REQUEST message, the Cell To Report List IE shall be included.

If NG-RAN node₂ is capable to provide requested resource status information, it shall initiate the measurement as requested by NG-RAN node₁ and respond with the RESOURCE STATUS RESPONSE message.

When starting a measurement, the Report Characteristics IE in the RESOURCE STATUS REQUEST indicates the type of objects NG-RAN node₂ shall perform measurements on. For each cell, NG-RAN node₂ shall include in the RESOURCE STATUS UPDATE message:
the Radio Resource Status IE, if the first bit, “PRB Periodic” of the Report Characteristics IE included in the RESOURCE STATUS REQUEST message is set to “1”. If NG-RAN node₂ is a BS and if the cell for which Radio Resource Status IE is requested to be reported supports more than one SSB, the Radio Resource Status IE for such cell shall include the SSB Area Radio Resource Status Item IE for SSB areas supported by the cell. If the SSB To Report List IE is included for a cell, the Radio Resource Status IE for such cell shall include the requested SSB Area Radio Resource Status List IE; If the cell for which Radio Resource Status IE is requested to be reported supports more than one slice, and if the Slice To Report List IE is included for a cell, the Radio Resource Status IE for such cell shall, if supported, include the requested Slice Radio Resource Status Item IE; If the cell for which Radio Resource Status IE is requested to be reported supports MIMO, the Radio Resource Status IE for such cell may include the MIMO PRB usage Information IE.
the TNI. Capacity Indicator IE, if the second bit, “TNL Capacity Ind Periodic” of the Report (Characteristics IE included in the RESOURCE STATUS REQUEST message is set to “1”. The received TNI, Capacity Indicator IE represents the lowest TNL capacity available for the cell, only taking into account interfaces providing user plane transport.
the Composite Available Capacity Group IE, if the third bit, “Composite Available Capacity Periodic” of the Report Characteristics IE included in the RESOURCE STATUS REQUEST message is set to “1”. If the Cell Capacity Class Value IE is included within the Composite Available Capacity Group IE, this IE is used to assign weights to the available capacity indicated in the Capacity Value IE. If NG-RAN node₂ is a BS and if the cell for which Composite Available Capacity Group IE is requested to be reported supports more than one SSB, the Composite Available Capacity Group IE for such cell shall include the SSB Area Capacity Value List for SSB areas supported by the cell, providing the SSB area capacity with respect to the Cell Capacity Class Value. If the SSB To Report List IE is included for a cell, the Composite Available Capacity Group IE for such cell shall include the requested SSB Area Capacity Value List IE.
If the cell for which Composite Available Capacity Group IE is requested to be reported supports more than one slice, and if the Slice To Report List IE is included for a cell, the Slice Available Capacity IE for such cell shall include the requested Slice Available Capacity Value Downlink IE and Slice Available Capacity Value Uplink IE, providing the slice capacity with respect to the Cell Capacity Class Value.
the Number of Active UEs IE, if the fourth bit, “Number of Active UEs Periodic” of the Report Characteristics IE included in the RESOURCE STATUS REQUEST message is set to “1”;
the RRC Connections IE, if the fifth bit, “RRC Connections Periodic” of the Report Characteristics IE included in the RESOURCE STATUS REQUEST message is set to “1”.
the NR-UJ Channel List IE, if the sixth bit, “NR-U Channel List Periodic” of the Report Characteristics IE included in the RESOURCE STATUS REQUEST message is set to “1”.

If the Reporting Periodicity IE in the RESOURCE STATUS REQUEST is present, this indicates the periodicity for the reporting of periodic measurements. The NG-RAN node₂ shall report only once, unless otherwise requested within the Reporting Periodicity IE.

The RESOURCE STATUS REQUEST message is sent by NG-RAN node₁ to NG-RAN node₂ to initiate the requested measurement according to the parameters given in the message.

Direction: NG-RAN node₁→NG-RAN node₂.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| NG-RAN node1 | M | | INTEGER | Allocated by | YES | reject |
| Measurement ID | | | (1 . . . 4095, . . .) | NG-RAN node₁ | | |
| NG-RAN node2 | C- | | INTEGER | Allocated by | YES | ignore |
| Measurement ID | ifRegistrationRe- | | (1 . . . 4095, . . .) | NG-RAN node₂ | | |
| | questStoporAdd | | | | | |
| Registration Request | M | | ENUMERATED | Type of request | YES | reject |
| | | | (start, stop, | for which the | | |
| | | | add, . . .) | resource status | | |
| | | | | is required. | | |
| Report | C- | | BITSTRING | Each position | YES | reject |
| Characteristics | ifRegistrationRe- | | (SIZE(32)) | in the bitmap | | |
| | questStart | | | indicates | | |
| | | | | measurement | | |
| | | | | object the NG- | | |
| | | | | RAN node2 is | | |
| | | | | requested to | | |
| | | | | report. | | |
| | | | | First Bit = PRB | | |
| | | | | Periodic, | | |
| | | | | Second Bit = | | |
| | | | | TNL Capacity | | |
| | | | | Ind Periodic, | | |
| | | | | Third Bit = | | |
| | | | | Composite | | |
| | | | | Available | | |
| | | | | Capacity | | |
| | | | | Periodic, Fourth | | |
| | | | | Bit = Number | | |
| | | | | of Active UEs | | |
| | | | | Periodic, | | |
| | | | | Fifth Bit = RRC | | |
| | | | | connections | | |
| | | | | Periodic, | | |
| | | | | Sixth Bit = NR- | | |
| | | | | U Channel List | | |
| | | | | Periodic. | | |
| | | | | Other bits shall | | |
| | | | | be ignored by | | |
| | | | | the NG-RAN | | |
| | | | | node2. | | |
| Cell To Report List | | 0 . . . 1 | | Cell ID list to | YES | ignore |
| | | | | which the | | |
| | | | | request applies. | | |
| >Cell To Report Item | | 1 . . . | | | — | |
| | | <maxnoofCellsinNG- | | | | |
| | | RANnode> | | | | |
| >>Cell ID | M | | Global NG-RAN | | — | |
| | | | Cell Identity | | | |
| | | | 9.2.2.27 | | | |
| >>SSB To Report | | 0 . . . 1 | | SSB list to | — | |
| List | | | | which the | | |
| | | | | request applies. | | |
| >>>SSB To | | 1 . . | | | — | |
| Report Item | | <maxnoofSSBAreas> | | | | |
| >>>>SSB-Index | M | | INTEGER | | — | |
| | | | (0 . . . , 63 . . .) | | | |
| >>Slice To Report | | 0 . . . 1 | | S-NSSAI list | — | |
| List | | | | to which the | | |
| | | | | request applies. | | |
| >>>Slice To | | 1 . . . | | | — | |
| Report Item | | <maxnoofBPLMNs> | | | | |
| >>>>PLMN | M | | 9.2.2.4 | Broadcast | — | |
| Identity | | | | PLMN | | |
| >>>>S-NSSAI | | 1 | | | — | |
| List | | | | | | |
| >>>>>S-NSSAI | | 1 . . . | | | — | |
| Item | | <maxnoofSliceItems> | | | | |
| >>>>>>S- | M | | 9.2.3.21 | | — | |
| NSSAI | | | | | | |
| Reporting Periodicity | O | | ENUMERATED | Periodicity that | YES | ignore |
| | | | (500 ms, 1000 ms, | can be used for | | |
| | | | 2000 ms, 5000 ms, | reporting of | | |
| | | | 10000 ms, . . .) | indicated | | |
| | | | | measurements. | | |
| | | | | Also used as the | | |
| | | | | averaging | | |
| | | | | window length | | |
| | | | | for | | |
| | | | | measurement | | |
| | | | | object if | | |
| | | | | supported. | | |
| | | | | This IE is | | |
| | | | | ignored if the | | |
| | | | | Registration | | |
| | | | | Request IE is | | |
| | | | | set to “add”. | | |

| Condition | Explanation |
|---|---|
| ifRegistrationRequestStoporAdd | This IE shall be present if the |
| | Registration Request IE is set |
| | to the value “stop” or “add”. |
| ifRegistrationRequestStart | This IE shall be present if the |
| | Registration Request IE is set |
| | to the value “start”. |

| Range bound | Explanation |
|---|---|
| maxnoofCellsinNG-RANnode | Maximum no. cells that can |
| | be served by a NG-RAN node. |
| | Value is 16384. |
| maxnoofSSBAreas | Maximum no. SSB Areas that can |
| | be served by a NG-RAN node |
| | cell. Value is 64. |
| maxnoofSliceItems | Maximum no. of signalled slice |
| | support items. Value is 1024. |

The inter-BS procedure for Resource Status Reporting is described in the following.

This procedure is initiated by an NG-RAN node to report the result of measurements admitted by the NG-RAN node following a successful Resource Status Reporting Initiation procedure.

The procedure uses non UE-associated signalling.

NG-RAN node₂ shall report the results of the admitted measurements in RESOURCE STATUS UPDATE message. The admitted measurements are the measurements that were successfully initiated during the preceding Resource Status Reporting Initiation procedure.

If some results of the admitted measurements in RESOURCE STATUS UPDATE message are missing, NG-RAN node₁ shall consider that these results were not available at NG-RAN node₂.

The RESOURCE STATUS RESPONSE message is sent by NG-RAN node₂ to NG-RAN node₁ to indicate that the requested measurement, for the measurement objects included in the measurement is successfully initiated.

Direction: NG-RAN node₂→NG-RAN node₁.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.3.1 | | YES | reject |
| NG-RAN node1 | M | INTEGER | Allocated by | YES | reject |
| Measurement ID | | (1 . . . 4095, . . .) | NG-RAN | | |
| | | | node₁ | | |
| NG-RAN node2 | M | INTEGER | Allocated by | YES | reject |
| Measurement ID | | (1 . . . 4095, . . .) | NG-RAN | | |
| | | | node₂ | | |
| Criticality | O | 9.2.3.3 | | YES | ignore |
| Diagnostics | | | | | |

This Served Cell Information NR IE contains cell configuration information of an NR cell that a neighbouring NG-RAN node may need for the Xn AP interface.

| | | | IE type and | Semantics | | Assigned |
|---|---|---|---|---|---|---|
| IE/Group Name | Presence | Range | reference | description | Criticality | Criticality |
| NR-PCI | M | | INTEGER | NR Physical | — | |
| | | | (0 . . . 1007, . . .) | Cell ID | | |
| NR CGI | M | | 9.2.2.7 | | — | |
| TAC | M | | 9.2.2.5 | Tracking Area | — | |
| | | | | Code | | |
| RANAC | O | | RAN Area | | — | |
| | | | Code | | | |
| | | | 9.2.2.6 | | | |
| Broadcast PLMNs | | 1 . . . | | Broadcast | — | |
| | | <maxnoofBPLMNs> | | PLMNs | | |
| | | | | contained in | | |
| | | | | the SIB1 | | |
| | | | | message as | | |
| | | | | specified in | | |
| | | | | [REF 7], | | |
| | | | | associated to | | |
| | | | | the NR Cell | | |
| | | | | Identity in the | | |
| | | | | NR CGI IE. | | |
| >PLMN Identity | M | | 9.2.2.4 | | — | |
| CHOICE NR- | M | | | | — | |
| Mode-Info | | | | | | |
| >FDD | | | | | | |
| >>FDD Info | | 1 | | | — | |
| >>>UL NR | M | | NR Frequency | This IE is | — | |
| Frequency Info | | | Info | ignored for NR | | |
| | | | 9.2.2.19 | operating | | |
| | | | | bands for | | |
| | | | | which uplink | | |
| | | | | range of N_{REF} | | |
| | | | | is not defined | | |
| | | | | in section | | |
| | | | | 5.4.2.3 of TS | | |
| | | | | 38.104 [24]. | | |
| >>>DL NR | M | | NR Frequency | | — | |
| Frequency Info | | | Info | | | |
| | | | 9.2.2.19 | | | |
| >>>UL | M | | NR | This IE is | — | |
| Transmission | | | Transmission | ignored for NR | | |
| Bandwidth | | | Bandwidth | operating | | |
| | | | 9.2.2.20 | bands for | | |
| | | | | which uplink | | |
| | | | | range of N_{REF} | | |
| | | | | is not defined | | |
| | | | | in section | | |
| | | | | 5.4.2.3 of TS | | |
| | | | | 38.104 [24]. | | |
| >>>DL | M | | NR | | — | |
| Transmission | | | Transmission | | | |
| Bandwidth | | | Bandwidth | | | |
| | | | 9.2.2.20 | | | |
| >>>UL Carrier | O | | NR Carrier List | If included, the | YES | ignore |
| List | | | 9.2.2.63 | UL | | |
| | | | | Transmission | | |
| | | | | Bandwidth IE | | |
| | | | | shall be | | |
| | | | | ignored. | | |
| >>>DL Carrier | O | | NR Carrier List | If included, the | YES | ignore |
| List | | | 9.2.2.63 | DL | | |
| | | | | Transmission | | |
| | | | | Bandwidth IE | | |
| | | | | shall be | | |
| | | | | ignored. | | |
| >>>BS-DU Cell | O | | BS-DU Cell | Contains FDD | YES | ignore |
| Resource | | | Resource | UL resource | | |
| Configuration- | | | Configuration | configuration | | |
| FDD-UL | | | 9.2.2.95 | of BS-DU's | | |
| | | | | cell. Only | | |
| | | | | applicable if | | |
| | | | | the BS-DU is | | |
| | | | | an IAB-DU or | | |
| | | | | an IAB-donor- | | |
| | | | | DU. | | |
| >>>BS-DU Cell | O | | BS-DU Cell | Contains FDD | YES | ignore |
| Resource | | | Resource | UL resource | | |
| Configuration- | | | Configuration | configuration | | |
| FDD-DL | | | 9.2.2.95 | of BS-DU's | | |
| | | | | cell. Only | | |
| | | | | applicable if | | |
| | | | | the BS-DU is | | |
| | | | | an IAB-DU or | | |
| | | | | an IAB-donor- | | |
| | | | | DU. | | |
| >TDD | | | | | | |
| >>TDD Info | | 1 | | | — | |
| >>>Frequency | M | | NR Frequency | | — | |
| Info | | | Info | | | |
| | | | 9.2.2.19 | | | |
| >>>Transmission | M | | NR | | — | |
| Bandwidth | | | Transmission | | | |
| | | | Bandwidth | | | |
| | | | 9.2.2.20 | | | |
| >>>Intended | O | | 9.2.2.40 | | YES | ignore |
| TDD DL-UL | | | | | | |
| Configuration | | | | | | |
| NR | | | | | | |
| >>>TDD UL- | O | | OCTET | Includes the | YES | ignore |
| DL | | | STRING | tdd-UL-DL- | | |
| Configuration | | | | Configuration | | |
| Common NR | | | | Common | | |
| | | | | contained in | | |
| | | | | the SIB1 | | |
| | | | | message as | | |
| | | | | defined in | | |
| | | | | [REF 7] | | |
| >>>Carrier List | O | | NR Carrier List | If included, the | YES | ignore |
| | | | 9.2.2.63 | Transmission | | |
| | | | | Bandwidth IE | | |
| | | | | shall be | | |
| | | | | ignored. | | |
| >>>BS-DU Cell | O | | BS-DU Cell | Contains FDD | YES | ignore |
| Resource | | | Resource | UL resource | | |
| Configuration- | | | Configuration | configuration | | |
| TDD | | | 9.2.2.95 | of BS-DU's | | |
| | | | | cell. Only | | |
| | | | | applicable if | | |
| | | | | the BS-DU is | | |
| | | | | an IAB-DU or | | |
| | | | | an IAB-donor- | | |
| | | | | DU. | | |
| Measurement | M | | OCTET | Includes the | — | |
| Timing | | | STRING | Measure- | | |
| Configuration | | | | mentTimingCon- | | |
| | | | | figuration | | |
| | | | | inter-node | | |
| | | | | message for the | | |
| | | | | served cell, as | | |
| | | | | defined in | | |
| | | | | [REF 7]. | | |
| Connectivity | M | | 9.2.2.28 | | — | |
| Support | | | | | | |
| Broadcast PLMN | | 0 . . . | | This IE | YES | ignore |
| Identity Info List | | <maxnoofBPLMNs> | | corresponds to | | |
| NR | | | | information | | |
| | | | | provided in the | | |
| | | | | PLMN- | | |
| | | | | IdentityInfoList | | |
| | | | | IE and the | | |
| | | | | NPN- | | |
| | | | | IdentityInfoList | | |
| | | | | IE (if | | |
| | | | | available) in | | |
| | | | | SIB1 as | | |
| | | | | specified in | | |
| | | | | [REF 7]. | | |
| | | | | PLMN | | |
| | | | | Identities and | | |
| | | | | associated | | |
| | | | | information | | |
| | | | | contained in | | |
| | | | | the PLMN- | | |
| | | | | IdentityInfoList | | |
| | | | | IE and NPN | | |
| | | | | identities and | | |
| | | | | associated | | |
| | | | | information | | |
| | | | | contained in | | |
| | | | | the NPN- | | |
| | | | | IdentityInfoList | | |
| | | | | IE (if | | |
| | | | | available) are | | |
| | | | | included and | | |
| | | | | provided in the | | |
| | | | | same order as | | |
| | | | | broadcast in | | |
| | | | | the SIB1 | | |
| | | | | message. | | |
| | | | | NOTE: In case | | |
| | | | | of NPN-only | | |
| | | | | cell, the PLMN | | |
| | | | | Identities and | | |
| | | | | associated | | |
| | | | | information | | |
| | | | | contained in | | |
| | | | | the PLMN- | | |
| | | | | IdentityInfoList | | |
| | | | | IE are not | | |
| | | | | included. | | |
| >Broadcast | | 1 . . . | | Broadcast | — | |
| PLMNs | | <maxnoofBPLMNs> | | PLMNs in the | | |
| | | | | SIB1 message, | | |
| | | | | associated to | | |
| | | | | the NR Cell | | |
| | | | | Identity IE. | | |
| >>PLMN | M | | 9.2.2.4 | | — | |
| Identity | | | | | | |
| >TAC | M | | 9.2.2.5 | | — | |
| >NR Cell Identity | M | | BIT STRING | | — | |
| | | | (SIZE(36)) | | | |
| >RANAC | O | | RAN Area | | — | |
| | | | Code 9.2.2.6 | | | |
| >Configured TAC | O | | 9.2.2.39a | NOTE: This IE | YES | ignore |
| Indication | | | | is associated | | |
| | | | | with the TAC | | |
| | | | | in the | | |
| | | | | Broadcast | | |
| | | | | PLMN Identity | | |
| | | | | Info List NR IE | | |
| >NPN Broadcast | O | | 9.2.2.71 | If this IE is | YES | reject |
| Information | | | | included the | | |
| | | | | content of the | | |
| | | | | Broadcast | | |
| | | | | PLMNs IE in | | |
| | | | | the Broadcast | | |
| | | | | PLMN Identity | | |
| | | | | Info List NR IE | | |
| | | | | is ignored. | | |
| Configured TAC | O | | 9.2.2.39a | NOTE: This IE | YES | ignore |
| Indication | | | | is associated | | |
| | | | | with the TAC | | |
| | | | | on top-level of | | |
| | | | | the Served Cell | | |
| | | | | Information | | |
| | | | | NR IE | | |
| NPN Broadcast | O | | 9.2.2.71 | If this IE is | YES | reject |
| Information | | | | included the | | |
| | | | | content of the | | |
| | | | | Broadcast | | |
| | | | | PLMNs IE in | | |
| | | | | the top Served | | |
| | | | | Cell | | |
| | | | | Information | | |
| | | | | NR IE is | | |
| | | | | ignored. | | |
| SSB Positions In | O | | 9.2.2.64 | | YES | ignore |
| Burst | | | | | | |
| NR Cell PRACH | O | | OCTET | Includes the | YES | ignore |
| Configuration | | | STRING | NR Cell | | |
| | | | | PRACH | | |
| | | | | Configuration | | |
| | | | | IE as defined | | |
| | | | | in section | | |
| | | | | 9.3.1.139 in TS | | |
| | | | | 38.473 [41]. | | |
| CSI-RS | O | | ENUMERATED | This IE | YES | ignore |
| Transmission | | | (activated, | indicates the | | |
| Indication | | | deactivated, . . .) | CSI-RS | | |
| | | | | transmission | | |
| | | | | status of the | | |
| | | | | given cell. | | |
| | | | | If the | | |
| | | | | Additional | | |
| | | | | Measurement | | |
| | | | | Timing | | |
| | | | | Configuration | | |
| | | | | List IE is | | |
| | | | | present, this IE | | |
| | | | | is ignored. | | |
| SFN Offset | O | | 9.2.2.75 | | YES | ignore |
| Supported MBS | | 0 . . . | | Shall contain | YES | ignore |
| FSA ID List | | <maxnoofMBSFSAs> | | MBS | | |
| | | | | Frequency | | |
| | | | | Selection Area | | |
| | | | | Identities | | |
| | | | | associated to | | |
| | | | | the NR Cell | | |
| | | | | Identity in the | | |
| | | | | NR CGI IE. | | |
| >MBS Frequency | M | | OCTET | Corresponds to | — | |
| Selection Area | | | STRING(3) | information | | |
| Identity | | | | provided in the | | |
| | | | | MBS-FSAI IE | | |
| | | | | as defined in | | |
| | | | | [REF 7]. | | |
| NR-U Channel | | 0 . . . 1 | | | YES | ignore |
| Info List | | | | | | |
| >NR-U Channel | | 1 . . . | | | — | |
| Info Item | | <maxnoofNR- | | | | |
| | | UChannelIDs> | | | | |
| >>NR-U | M | | INTEGER (1 . . . | Index to | — | |
| Channel ID | | | maxnoofNR- | uniquely | | |
| | | | UChannelIDs, . . .) | identify the | | |
| | | | | part of the NR- | | |
| | | | | U Channel | | |
| | | | | Bandwidth | | |
| | | | | including a | | |
| | | | | contiguous set | | |
| | | | | of resource | | |
| | | | | blocks (RBs) | | |
| | | | | on which a | | |
| | | | | channel access | | |
| | | | | procedure is | | |
| | | | | performed in | | |
| | | | | shared | | |
| | | | | spectrum. | | |
| | | | | Value 1 | | |
| | | | | represents the | | |
| | | | | first part of the | | |
| | | | | NR-U Channel | | |
| | | | | Bandwidth on | | |
| | | | | which a | | |
| | | | | channel access | | |
| | | | | procedure is | | |
| | | | | performed. | | |
| | | | | Value 2 | | |
| | | | | represents the | | |
| | | | | second part of | | |
| | | | | the NR-U | | |
| | | | | Channel | | |
| | | | | Bandwidth on | | |
| | | | | which a | | |
| | | | | channel access | | |
| | | | | procedure is | | |
| | | | | performed, and | | |
| | | | | so on. | | |
| >>NR ARFCN | M | | INTEGER (0 . . . | It represents | — | |
| | | | maxNRARFCN) | the centre | | |
| | | | | frequency of | | |
| | | | | the NR-U | | |
| | | | | Channel | | |
| | | | | Bandwidth for | | |
| | | | | NR bands | | |
| | | | | restricted to | | |
| | | | | operation with | | |
| | | | | shared | | |
| | | | | spectrum | | |
| | | | | channel access, | | |
| | | | | as defined in | | |
| | | | | TS 37.213 | | |
| | | | | [51]. Allowed | | |
| | | | | values are | | |
| | | | | specified in | | |
| | | | | 38.101-1 [52] | | |
| | | | | in Table | | |
| | | | | 5.4.2.3-2, Table | | |
| | | | | 5.4.2.3-3 and | | |
| | | | | Table 5.4.2.3-4. | | |
| >>Bandwidth | M | | ENUMERATED | | — | |
| | | | (10 MHz, 20 MHz, | | | |
| | | | 40 MHz, 60 MHz, | | | |
| | | | 80 MHz, . . . , | | | |
| | | | 100 MHz) | | | |
| Additional | O | 1 . . . | | | YES | ignore |
| Measurement | | <maxnoofMTCItems> | | | | |
| Timing | | | | | | |
| Configuration List | | | | | | |
| >Measurement | M | | INTEGER | “0” refers to | — | |
| Timing | | | (0 . . . 16) | the | | |
| Configuration | | | | configuration | | |
| Index | | | | contained in | | |
| | | | | the | | |
| | | | | Measurement | | |
| | | | | Timing | | |
| | | | | Configuration | | |
| | | | | IE. | | |
| | | | | Any value | | |
| | | | | between “1” | | |
| | | | | and “16” refers | | |
| | | | | to a | | |
| | | | | configuration | | |
| | | | | within the | | |
| | | | | Additional | | |
| | | | | Measurement | | |
| | | | | Timing | | |
| | | | | Configuration | | |
| | | | | List IE. | | |
| >CSI- RS MTC | M | 1 . . . | | This list | — | |
| Configuration | | <maxnoofCSIRScon- | | explicitly | | |
| List | | figurations> | | expresses the | | |
| | | | | CSI-RS | | |
| | | | | configurations | | |
| | | | | contained in | | |
| | | | | the MTC | | |
| >>CSI-RS Index | M | | INTEGER | Index of CSI- | — | |
| | | | (0 . . . 95) | RS as in MTC | | |
| >>CSI-RS Status | M | | ENUMERATED | This IE | — | |
| | | | (activated, | indicates the | | |
| | | | deactivated, . . .) | CSI-RS | | |
| | | | | transmission | | |
| | | | | status of the | | |
| | | | | configuration. | | |
| >>CSI-RS | O | 1 . . . | | This list | — | |
| Neighbour List | | <maxnoofCSIRSneigh- | | expresses the | | |
| | | bourCells> | | cells and CSI- | | |
| | | | | RSs | | |
| | | | | neighbouring | | |
| | | | | the CSI-RS in | | |
| | | | | the CSI-RS | | |
| | | | | Index IE. | | |
| >>>NR CGI | M | | 9.2.2.7 | | — | |
| >>>CSI-RS | O | 1 . . . | | This list | — | |
| MTC | | <maxnoofCSIRSneigh- | | expresses the | | |
| Neighbour List | | bourCellsInMTC> | | CSI-RSs | | |
| | | | | served by the | | |
| | | | | NR CGI, | | |
| | | | | which are | | |
| | | | | neighbouring | | |
| | | | | the CSI-RS of | | |
| | | | | the served cell | | |
| | | | | and contained | | |
| | | | | in the MTC | | |
| | | | | indicated by | | |
| | | | | the | | |
| | | | | neighbouring | | |
| | | | | NR cell. | | |
| >>>>CSI-RS | M | | INTEGER | | — | |
| Index | | | (0 . . . 95) | | | |
| RedCap Broadcast | O | | BIT STRING | The presence | YES | ignore |
| Information | | | (SIZE(8)) | of this IE | | |
| | | | | indicates that | | |
| | | | | the | | |
| | | | | intraFreqRe- | | |
| | | | | selectionRedCap | | |
| | | | | is broadcast in | | |
| | | | | the SIB1 | | |
| | | | | message of the | | |
| | | | | corresponding | | |
| | | | | cell, see [REF | | |
| | | | | 7]. | | |
| | | | | Each position | | |
| | | | | in the bitmap | | |
| | | | | indicates which | | |
| | | | | RedCap UEs | | |
| | | | | are allowed | | |
| | | | | access, | | |
| | | | | according to | | |
| | | | | the setting of | | |
| | | | | RedCap | | |
| | | | | barring | | |
| | | | | indicators in | | |
| | | | | the SIB1 | | |
| | | | | message, see | | |
| | | | | [REF 7]. | | |
| | | | | First bit = 1Rx, | | |
| | | | | second bit = | | |
| | | | | 2Rx, | | |
| | | | | third bit = | | |
| | | | | halfDuplex, | | |
| | | | | other bits | | |
| | | | | reserved for | | |
| | | | | future use. | | |
| | | | | Value ‘1’ | | |
| | | | | indicates | | |
| | | | | ‘access | | |
| | | | | allowed’. Value | | |
| | | | | ‘0’ indicates | | |
| | | | | ‘access not | | |
| | | | | allowed”. | | |
| eRedCap Broadcast | O | | BIT STRING | The presence | YES | ignore |
| Information | | | (SIZE(8)) | of this IE | | |
| | | | | indicates that | | |
| | | | | the | | |
| | | | | intraFreqReselection- | | |
| | | | | eRedCap IE is | | |
| | | | | broadcast in | | |
| | | | | SIB1 of the | | |
| | | | | corresponding | | |
| | | | | cell, see [REF | | |
| | | | | 7]. | | |
| | | | | Each position | | |
| | | | | in the bitmap | | |
| | | | | indicates which | | |
| | | | | eRedCap UEs | | |
| | | | | are allowed | | |
| | | | | access, | | |
| | | | | according to | | |
| | | | | the setting of | | |
| | | | | the barring | | |
| | | | | indicators in | | |
| | | | | SIB1, see [REF | | |
| | | | | 7]. | | |
| | | | | First bit = 1Rx, | | |
| | | | | second bit = | | |
| | | | | 2Rx, | | |
| | | | | third bit = half- | | |
| | | | | duplex, | | |
| | | | | other bits | | |
| | | | | reserved for | | |
| | | | | future use. | | |
| | | | | Value ‘1’ | | |
| | | | | indicates | | |
| | | | | ‘access | | |
| | | | | allowed’. Value | | |
| | | | | ‘0’ indicates | | |
| | | | | ‘access not | | |
| | | | | allowed’. | | |
| Mobile IAB Cell | O | | 9.2.2.106 | | YES | ignore |

| Range bound | Explanation |
|---|---|
| maxnoofBPLMNs | Maximum no. of broadcast |
| | PLMNs by a cell. Value |
| | is 12. |
| maxnoofMBSFSAs | Maximum no. of MBS FSAs |
| | by one BS. Value is 256. |
| maxnoofNR-UChannelIDs | Maximum no. NR-U channel |
| | IDs in a cell. Value is 16. |
| maxnoofMTCItems | Maximum no. of measurement |
| | timing configurations |
| | associated with the neighbour |
| | cell. Value is 16. |
| maxnoofCSIRSconfigurations | Maximum number of CSI RS |
| | configurations reported |
| | in the MTC. Value is 96 |
| maxnoofCSIRSneighbourCells | Maximum number of cells |
| | neighbouring a CSI-RS |
| | coverage area. Value is 16 |
| maxnoofCSIRSneighbourCellsInMTC | Maximum number of CSI-RS |
| | coverage areas neighbouring |
| | a specific CSI-RS coverage |
| | area. Value is 16 |

NG-RAN supports radio access network sharing as defined in TS 23.501.

If NR access is shared, system information broadcast in a shared cell indicates a TAC and a Cell Identity for each subset of PLMNs, PNI-NPNs and SNPNs. NR access provides only one TAC and one Cell Identity per cell per PLMN, SNPN or PNI-NPN. In this version of the specification, a Cell Identity can only belong to one network type among PLMN, PNI-NPN or SNPN as defined in TS 23.501.

Each Cell Identity associated with a subset of PLMNs, SNPNs or PNI-NPNs identifies its serving NG-RAN node.

In various embodiments of the present disclosure, a 6G base station (6G BS) or a 5G/4G BS can be replaced with other corresponding network nodes, such as 6G integrated access and backhaul (IAB) or 6G network-controlled repeater (NCR) or 6G reconfigurable intelligent surface (RIS), or such as 5G network-controlled repeater (NCR)/or IAB node, or a 4G relay or repeater node. In various embodiments, a 6G UE or a 5G/4G UE (e.g., the UE 116) can operate in relation with multiple network nodes corresponding to a certain RAT (same RAT as that for the UE, or different RAT than that for the UE), such as both a 6G BS (e.g., the BS 102) and a 6G integrated access and backhaul (IAB)/network-controlled repeater (NCR)/RIS, or both a 5G BS and a 5G IAB/NCR, or both a 4G BS and 4G relay/repeater node.

In various embodiments of the present disclosure, a 6G/5G BS or a 4G BS can refer to a central unit (CU) or a distributed unit (DU) or a remote unit (RU) or a transmission-reception point (TRP) or other architectural units or functional/logical entities for a corresponding base station, or a variation or collection or combination thereof.

In various embodiments of the present disclosure, at least the following scenarios can apply to coexistence of 6G RAT with one or both of 4G LTE RAT and 5G NR RAT.

A 6G RAT/BS operates a 6G cell in a spectrum that is shared with a cell operated by one or both of 5G RAT/BS or 4G RAT/BS. For example, a 6G UE operates in a cell that is also operated by one or both of 5G RAT/BS or 4G RAT/BS.
For example, a 6G UE and a 5G/4G UE operate in overlapping time durations in a same cell, or in different cells of a same band, and the operation may also overlap in the frequency domain or the spatial domain.
For example, 6G UEs operate in a cell that is also operated by 5G/4G RAT/BS for 5G/4G UEs.
For example, 6G UEs operate in a 6G cell where transmissions or receptions overlap in frequency domain with transmissions or receptions associated on a 5G/4G cell operated by 5G/4G RAT/BS for 5G/4G UEs.
Herein, the cell(s) are at least serving cell(s), or non-serving cell(s), e.g., for the purpose of inter-cell beam management, mobility, and so on.

At least the following sub-scenarios can apply for Scenario #1:
Scenario #1a: a 6G UE operates on only one 6G cell that is shared with 5G/4G RAT;
Scenario #1b: a 6G UE operates on a set of more than one 6G cells, and only a subset of the set of the 6G cells is shared with 5G/4G RATs, while remaining from the set of cells are not shared with 5G/4G RATs;
Scenario #1c: a 6G UE operates on a set of more than one 6G cells, and cells in the set of the 6G cells are shared with 5G/4G RATs.
Note 1: Scenarios #1b and #1c can also include cases with DL cells only, or UL cells only, or both DL cells and UL cells (or cells that are both DL and UL).
Note 2: Scenarios #1b and #1c can also include cases that the “more than one 6G cells” are in a same frequency band (intra-band CA) or in different frequency bands (inter-band CA), or a combination thereof.
Note 3: Scenario #la can be regarded as a “single-carrier MRSS” or “MRSS without CA”, while Scenarios #1b and #1c can be regarded as “multi-carrier MRSS” or “MRSS with CA” or “CA-based MRSS”.

Various network deployment assumptions can apply to Scenario #1:
For example, a same BS or network entity operates both the 6G RAT and the 5G/4G RAT;
For example, separate BSs or network entities operate the 6G RAT and the 5G/4G RATs, and the 6G RAT and the 5G/4G RATs share corresponding spectrum/frequency resources.
   For example, the BSs cooperate/coexist or otherwise have signaling exchange with practically negligible signaling latency.

The following core network (CN) assumptions can apply to Scenario #1:
The 6G RAT that operates the 6G cell/UEs is associated with a 6G core network (6G-CN);
The 5G/4G RAT that operates the 5G/4G cell/UEs is associated with a 5G/4G core network (5G/4G-CN).

The objective of Scenario #1 is to enable a BS/network entity (or cooperating BSs/network entities) to allocate shared/overlapping T/F/S resources for operation of the 6G cell and/or the corresponding 6G UEs such that there is no interference or otherwise performance degradation to the operation of the 5G/4G cell and/or the corresponding 5G/4G UEs.

Another objective for Scenario #1 can be to ensure compatible design for the 6G with 5G/4G RATs, to reduce implementation efforts, or facilitate reuse of existing implementations for 5G/4G RATs for 6G RATs, when operating in shared or re-farmed spectrum.

A 6G UE operates in a first 6G cell and in a second 5G/4G cell that coordinate/cooperate or otherwise jointly operate for scheduling of UEs.

Scenario #2 can be regarded as a “multi-RAT” carrier aggregation (CA) operation, where different cells are associated with different RATs, such as NR-6G CA (N6-CA) or EUTRA-6G CA (E6-CA), unlike the “single-RAT” carrier aggregation that operates with a number of cells associated with a same RAT, such as 4G LTE CA, or 5G NR CA, or 6G CA.

At least the following sub-scenarios can apply to Scenario #2:
Scenario #2a: a first 6G cell is in a same/shared spectrum with a second 5G/4G cell (shared multi-RAT “MR” cells)
Scenario #2b: a first 6G cell is in a same frequency band as a second 5G/4G cell (intra-band MRSA);
Scenario #2c: a first 6G cell is in a different frequency band than a second 5G/4G cell (inter-band MRSA).

Various network deployment assumptions can apply to Scenario #2:
For example, a 5G/4G RAT, such as an MRSS-aware 5G/4G RAT, operates both a 5G/4G cell and a 6G cell.
For example, a 6G RAT operates both a 6G cell and a 5G/4G cell.
For example, a 6G RAT operates a 6G cell and a 5G/4G RAT operates a 5G/4G cell, wherein the 6G RAT and 5G/4G RAT coordinate/cooperate their corresponding operations, such as scheduling, resource allocation, or configuration among the RATs.
   For example, different RATs share certain signaling, or transmissions/receptions, or procedures, and so on, such as by using inter-BS signaling with negligible latency.
   For example, a first RAT (e.g., 6G RAT) offloads certain signaling, or transmissions/receptions, or procedures, and so on, to the other RAT (e.g., 5G RAT).

Various core network (CN) assumptions can apply to Scenario #2:
For example, the 5G/4G RAT is associated with a 5G core network (5G-CN) that can support both 5G/4G and 6G operations.
For example, the 6G RAT is associated with an extended 6G core network (ext-6G-CN) that can support both 6G and 5G/4G operations.
For example, both the 6G RAT and the 5G/4G RAT are associated with a 5G core network (5G-CN) or an extended 5G core network (ext-5G-CN) that can support both 6G and 5G/4G operations. For example, the 6G RAT is a certain extended 6G RAT (ext-6G RAT) that can operate in association with a 5G-CN or ext-5G-CN.
For example, both the 6G RAT and the 5G/4G RAT are associated with an extended 6G core network (ext-6G-CN) that can support both 6G and 5G/4G operations. For example, the 5G/4G RAT is a certain extended 5G/4G RAT (ext-5G/4G RAT) that can operate in association with a 6G-CN or ext-6G-CN.
For example, the 6G RAT is associated with a 6G-CN and the 5G RAT is associated with a 5G-CN that coordinate/cooperate their corresponding operations, e.g., based on signaling exchange with negligible latency between the two core networks.

The objective of Scenario #2 is to enable the BS/network entity (or the cooperating BSs/network entities) to operate 6G cells and 5G/4G cells jointly and provide coordinated/cooperative support for a 6G UE with MRSA capability. Herein, the coordination/cooperation can be in the physical layer (L1) and/or in higher layers such as MAC/RLC (L2/L3). This scenario offers increased throughput and reduced latency or signaling overhead, that is achieved by e.g. reusing the existing network (e.g., the network 130) infrastructure for 5G.

A 6G UE operates in a first 6G cell and in a second 5G/4G cell, wherein the first 6G cell and the second 5G/4G cell operate independently.

Scenario #3 can be regarded as 5G-6G dual connectivity (N6-DC) or 4G-6G dual connectivity (E6-DC), or 4G-5G-6G tri-connectivity (EN6-TC).

At least the following sub-scenarios can apply to Scenario #2:
Scenario #3a: the first 6G cell is in a same/shared spectrum with the second 5G/4G cell (shared multi-RAT “MR” cells)
Scenario #3b: the first 6G cell is in the same frequency band as the second 5G/4G cell (intra-band MRC);
Scenario #3c: the first 6G cell is in a different frequency band than the second 5G/4G cell (inter-band MRC).

Various network deployments (RAN) can apply to Scenario #3.
For example, a 6G RAT operates the first 6G cell and a 5G/4G RAT operates the second 5G/4G cell.
For example, the 6G RAT and 5G/4G RAT do not coordinate/cooperate for their corresponding operations, e.g., for scheduling, resource allocation, or configurations among the RATs.
For example, different RATs have separate schedulers.
For example, configurations, transmissions/receptions, and procedures, are independent among the RATs.

Various core network (CN) assumptions can apply to Scenario #3.
For example, the 6G RAT is associated with a 6G core network (6G-CN) and the 5G/4G RAT is associated with a 5G/4G core network (5G/4G-CN).
For example, both the 6G RAT and the 5G/4G RAT are associated with a 5G/4G-CN.
For example, both the 6G RAT and the 5G/4G RAT are associated with a 6G-CN or an extended 6G core network (ext-6G-CN) that can handle both 6G and 5G/4G.

The objective of Scenario #3 is to enable the 6G UE to establish a 5G/4G connection in addition to the 6G connection which can facilitate increased throughput for the 6G UE.

The MRSS objective (Scenario #1) can be achieved using avoidance methods that preclude interference between the 6G RAT and the 5G/4G RAT, or using cooperation/sharing methods that rely on coordination, assistance, or cooperation between the 6G RAT and the 5G/4G RAT. Herein, avoidance refers to UE-BS/inter-BS signaling, configurations, procedures, methods, and so on, that preclude a 6G UE/cell from transmitting, receiving, or otherwise using for a 6G procedure/operation any T/F/S resource in which a 5G/4G UE/cell may transmit, receive, or otherwise use for a 5G/4G operation.

For example, T/F/S resources are semi-statically shared between 6G BS/UE/cell and 5G/4G BS/UE/cell, such as one set of frequency/F/S resources allocated to the 6G BS/UE/cell, and another set of T/F/S resources allocated to the 5G BS/UE/cell, wherein the two sets are predetermined or semi-statically configured or indicated by L1/L2 signaling, and the two sets do not overlap, for example, by using frequency division multiplexing (FDM) or time division multiplexing (TDM) or space division duplexing (SDM) methods.

For example, T/F/S resources are shared between 6G BS/UE/cell and 5G/4G BS/UE/cell based on L1/L2 signaling, such as one set of T/F/S resources allocated to the 6G BS/UE/cell, and another set of T/F/S resources allocated to the 5G BS/UE/cell. For example, the two sets can be separately indicated for each DL reception or each UL transmission, such as by using the triggering or scheduling signaling, for example, by a scheduling DCI format or an activation MAC-CE command, or by a triggering DCI or MAC-CE, and so on. For example, T/F/S resources can be per associated signal or channel. In another example, a standalone L1/L2 signaling such as a standalone (or repurposed) DCI format or MAC-CE, for example, a group-common DCI format, can be used for indication of such T/F/S resources. For example, T/F/S resources can be indicated per time unit or per frequency unit or per spatial unit or per TCI state, such as per symbol or per slot or per sub-slot, or per a number or group of symbols/slots/sub-slots, or per sub-carrier/resource elements (RE)/resource blocks (RB)/resource block group (RBG) or a number or group of sub-carriers/REs/RBs/RBGs, or per index or per a set/group of indexes of: TCI state or SSB or CSI-RS or SSB (coverage) area or per predetermined or higher later indicated geographical zones and so on, or such indication of T/F/S resources can be per absolute units. Similar to semi-static spectrum sharing, the two indicated sets of T/F/S resources do not overlap, for example, by using FDM or TDM or SDM methods.

For example, T/F/S resources can be linked or associated with unified TCI states, and application of an avoidance method can be based on updates of the unified TCI states. For example, when the UE receives an indication for update of a unified TCI state for a cell, the UE applies such unified TCI state to the list of T/F/S resources. For example, when a cell is associated with a first unified TCI state and a second unified TCI state, such as for multi-TRP operation, each list of T/F/S resources can include an association with a first TCI state or with a second TCI state, and an update to any such unified TCI state can be implicitly/automatically applied to corresponding list of T/F/S resources.

For example, T/F/S resources for 6G transmissions or receptions can overlap with T/F/S resources for 5G/4G transmissions or receptions, and avoidance mechanisms define methods, such as puncturing or rate matching or dropping, to avoid the overlapping T/F/S resources. For example, dropping can apply to the entire signal or channel that has overlap with a T/F/S resources that are to be avoided, or only for the resources of the signal or channel that are overlapped with the T/F/S resources (while the UE continues to transmit or receives the remaining resources of the signal or channel). For example, an overlap with T/F/S resource to be avoided can include an actual overlap or can include being in vicinity of the T/F/S resources. For example, certain avoidance method, such as dropping or rate matching or puncturing can apply, also when a signal or channel is less than a number X of symbols or slots from a list of T/F/S resources to be avoided, or less than a number Y of REs or RBs from a list of T/F/S resources to be avoided, and so on.

For example, avoidance methods such as configuration or indication of T/F/S resources (or code-domain or other domain) to be avoided, such as by puncturing or rate matching or dropping, can apply to one or both of DL signals/channels and UL signals/channels. For example, such configuration or indication can be separate for DL and UL, or can be jointly for both DL and UL. For example, for efficient indication of TDRA or FDRA, the UE can be scheduled a PUSCH, PUCCH, or AP SRS, or other UL signals or channels that overlaps with periodic or semi-persistent (SP) UL signals and channels, such as PRACH, periodic PUCCH, periodic SRS, SP PUCCH (for example, for SP CSI reporting), SP SRS, and so on. For example, the UE can receive activation for CG PUSCH or SP PUCCH or SP SRS, or other UL signals or channels that overlap with periodic (or semi-persistent) UL signals and channels, as previously described. For example, the UE applies an avoidance method, as previously described, for reception of such scheduled PUSCH/PUCCH/AP SRS, or activated CG PUSCH/SP PUCCH/SP SRS, and so on. For example, an UL DCI format, such as a DCI format 0_0/0_1/0_2/0_3 can include an UL rate matching pattern indicator fields, that indicates a list of RM patterns that the UE is to avoid when transmitting a scheduled PUSCH or PUCCH or AP SRS. For example, such indication of UL rate matching can apply to any UL transmission until a next indication is received. For example, an indication of UL rate matching pattern can be provided by an GC-DCI format in a CSS set. For example, a configuration of certain UL channels can include an IE for such RM pattern indication.

For example, avoidance can rely on other mechanisms, such as power domain methods, or spatial domain methods, or duplex methods, or non-orthogonal multiple access (NOMA) methods, and so on, such as application of different DL/UL power control parameters or power offset values, or different beams or spatial filters or TCI states/SSB/CSI-RS index or application of joint phase time array (JPTA) or multi-panel antenna transmission, or application of sub-band full duplex (SBFD), or application of different NOMA signatures, and so on.

For example, the 6G UE/BS identifies, for transmission or reception of a DL/UL signal or channel, first parameters when T/F/S resources associated with the DL/UL signal or channel do not overlap with 5G/4G resources, and second parameters when T/F/S resources associated with the DL/UL signal or channel overlap with 5G/4G resources. For example, the first and the second parameters can include first and second [nominal] BS Tx power values or target UE Rx power values or pathloss references or power offset values, or first and second beams or TCI states, or first and second NOMA signatures (such as without NOMA signature and with NOMA signature, respectively), or first and second TDD UL-DL configurations or SBFD configurations (or L1/L2 variations thereof, such as dynamic SFI, and so on). For example, the 6G UE/BS switches an applicable power control parameter, or beam, or NOMA signature, or TDD UL-DL or SBFD configuration, depending on whether or not an associated DL/UL signal or channel overlaps with 5G resources.

For example, the 6G BS can be indicated whether or not an overlap with 5G or 4G signals/channels/resources applies via inter-BS signaling, such as signaling with a corresponding 5G or 4G BS. For example, the 6G UE can be indicated whether or not an overlap with 5G or 4G signals/channels/resources applies via higher layer indication or via L1/L2 signaling, wherein the indication can be for a specific 6G signal or channel, such as in a scheduling or activation or triggering DCI format or MAC-CE command, or can be for a T/F/S regardless of an associated 6G signal or channel. For example, such methods can apply to a 6G CORESET or PDCCH or PUCCH or CSI-RS or SRS and so on.

For example, when a UE receives an indication to avoid certain T/F/S resources, or receives an indication to update a previous signaling/higher layer configuration for avoiding certain T/F/S resources, the UE starts to apply such indication or update after a certain processing time, such as from a first slot that is after a slot of such indication or update (or a slot for transmission of a HARQ-ACK to indicate reception of such indication or update) by at least a certain number of symbols or slots associated with UE processing (for such indication or update). In another example, such processing timeline can include an inter-NW signaling or inter-gNB signaling timeline, such as processing timeline for the Xn interface or for interface between RU and DU/CU, such as for a communication and/or processing time for a second gNB or a second NW entity/CU/DU that transmits or stops transmitting certain periodic or semi-persistent signal or channel in a same frequency band as a first gNB/NW entity/RU that applies the indication or update.

For example, information for time resources, frequency resources, or spatial resources corresponding to MRSS avoidance methods can be provided separately or jointly, such as a first indication for time resources, a second indication for frequency resources, and a third indication for spatial resources, and a fourth indication for code-domain resources. In one example, the 6G UE/BS avoids the provided time resources for any frequency/spatial resource, or in frequency allocations or spatial allocations, or avoids the provided frequency resources or TCI states in time allocations. In another example, the 6G UE/BS avoids resources that are in the intersection of indications, such as, the provided frequency resources in the provide time resources and the provided spatial resources, when any.

For example, information for T/F/S resources corresponding to MRSS avoidance methods can be provided jointly, such as a single joint indication for both time and frequency and spatial resources or a single joint indication for both time and frequency and a separate indication for spatial resources, when any. For example, similar joint indication can include other domains, such as the code domain. For example, the 6G UE/BS avoids the T/F/S resources that are provided by the single joint indication.

For example, such T/F/S resources correspond to, e.g., predetermined, always-on signals or channels associated with 5G/4G UEs/cells, as subsequently described.

For example, there can be separate handling, such as signaling or configuration or procedure for SSBs as they can be on-off for SCells, or for PRACH resources. Also, the SSB location is not fixed and there can be both cell defining (CD)-SSB and non-cell defining (NCD)-SSB. For example, a DL/UL resource pattern can directly or explicitly indicate avoidance, such as rate matching or puncturing or dropping, relative to a certain SSB, such as CD-SSB or NCD-SSB, as for a CORESET, or for a PRACH configuration. For example, the T/F/S resource list or resource pattern can indicate avoidance relative to a certain SSB or SSB index or range of SSB indexes or certain PRACH resources, and the UE applies such avoidance based on a latest update (within a processing time) for the corresponding SSB or PRACH, such as on-demand activation or deactivation or update of resources, without any further signaling.

For example, the T/F/S resources can be (at least partially) predetermined from the 5G/4G specifications for system operation, such as for NR SSB or LTE common reference signal (CRS) or LTE PSS/SSS/PBCH or LTE MBSFN. For example, certain parameters for the 5G/4G signals or channels or resources can be provided by higher layers, such as a corresponding cell ID or number of antenna ports, and so on. In another example, a structure of the T/F/S resources are predetermined, such as a number of OFDM symbols or a number of RB/REs for NR SSB or a (maximum) number of supported beams, while an actual placement of the T/F/S resources, such as a time/frequency offset of the NR SSB relative to the CRB grid or actually transmitted SSB indexes can be provided by inter-BS signaling or by higher layer signaling or by L1/L2 indication.

For example, NR SSB T/F resources may not be fully predetermined—there may or may not be NCD SSB and the location of the SSB on the channel raster may not be known by a 6G UE. SSBs may also exist for some beams but not for others.

For example, the T/F/S resources can be selected by the 5G/4G cell/BS to be within a certain set of T/F/S resources, such as PDCCH/PDSCH for SIB1 or for random access response (RAR)/Msg2/4/B or for paging or permanent equipment identifier (PEI) or low power wake up signal (LP-WUS), or repetitions or retransmissions thereof, if applicable, that are within 5G NR CORESET #0 or BWP #0, i.e., the initial DL/UL BWP.

For example, some beams serve only NR UEs while others serve only 6G UEs and in that case spatial resource partitioning can apply.

For example, the T/F/S resources can be selected or configured or indicated by the 5G/4G cell/BS, via 5G/4G higher layers or MAC-CE or DCI, and may have no predetermined resource allocation or restriction.

For example, spatial resource partitioning can apply for the T/F/S resources among 5G and 6G. For example, NR UEs are served using first beams and 6G UEs are served using second beams. For example, the first UEs are associated with first TCI states or SSB indexes or CSI-RS resource indexes or SRS resource indexes, or groups thereof, and the second UEs are associated with second TCI states or SSB indexes or CSI-RS resource indexes or SRS resource indexes, or groups thereof. For example, the first beams/TCI states/SSB indexes/CSI-RS resource indexes/SRS resource indexes are different from second ones. For example, the BS can distinguish whether a UE is a 5G NR UE or a 6G UE based on an SSB that is used in association with a PRACH that a UE has used for establishing RRC connection or for making any request to the NW.

Various methods can apply for MRSS avoidance handling.

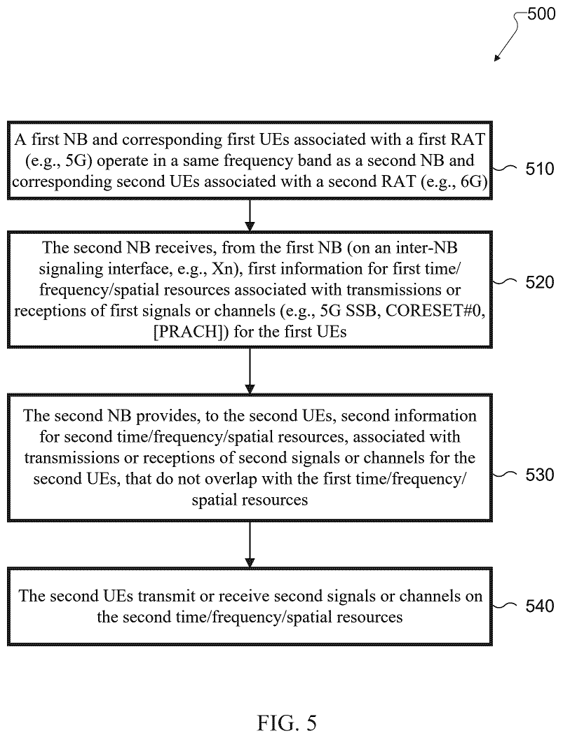

FIG. 5 illustrates a flowchart of an example procedure 500 for MRSS mechanism(s) according to embodiments of the present disclosure. For example, procedure 500 can be performed by the BS 102 and the BS 103, and the UE 111 and the UE 112 of FIG. 1. This example is for illustration only and other embodiments can be used without departing from the scope of the present disclosure.

A first BS and corresponding first UEs associated with a first RAT (e.g., 5G) operate in a same frequency band as a second BS and corresponding second UEs associated with a second RAT (e.g., 6G), 510. The second BS receives, from the first BS (on an inter-NB signaling interface, e.g., Xn), first information for first T/F/S resources associated with transmissions or receptions of first signals or channels (e.g., 5G SSB, PDCCH in CORESET #0, PRACH) for the first UEs, 520. The second BS provides, to the second UEs, second information for second T/F/S resources, associated with transmissions or receptions of second signals or channels for the second UEs, that do not overlap with the first T/F/S resources (e.g., TDM, FDM, SDM), 530. The second UEs transmit or receive the second signals or channels on the second T/F/S resources, 540.

MRSS avoidance can be based on inter-BS signaling (with or without assistance/signaling from the Core Network (CN)), such as between a 6G BS/cell and a 5G/4G BS/cell in order to coordinate corresponding T/F/S resources. For example, the 5G/4G BS can indicate use of first T/F/S resources to the 6G BS, and the 6G BS can consider the first T/F/S resources as unavailable.
For example, such inter-BS signaling can be based on X2/Xn interface or on a new interface, or on signaling exchange with the CN, or can be realized via implementation-based signaling, e.g., when the 6G BS and the 5G/4G BS correspond to same or cooperating operators.
For example, the 6G BS can avoid collision between use of the second T/F/S resources for 6G cell/UEs and use of the first T/F/S resources for 5G/4G cell/UEs. For example, the 6G BS may not indicate any information about the first T/F/S resources to 6G UEs. For example, the 6G BS can exclude the first T/F/S resources from resource allocation to 6G signals or channels. For example, the 6G BS can apply TDM or FDM or SDM of the second T/F/S resources with the first T/F/S resources and such multiplexing can be transparent to a UE.
For example, such method can apply when operation of 6G cell/UEs includes few or none always-on/predetermined 6G signals or channels with predetermined T/F/S resources. For example, operation of 6G cell/UEs can be based on 6G signals or channels with associated T/F/S resources that are selected/configured/indicated by a 6G BS and avoid collision with T/F/S resources associated with 5G/4G cell/UEs.

With reference to FIG. 5, an example procedure is shown for BS-based avoidance-based mechanism for MRSS.

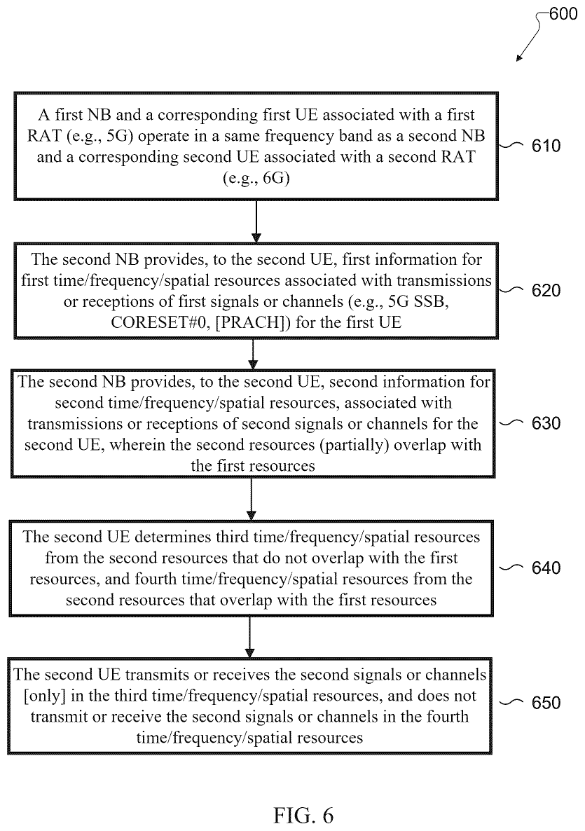

FIG. 6 illustrates a flowchart of an example procedure 600 for MRSS mechanism(s) according to embodiments of the present disclosure. For example, procedure 600 can be performed by the BS 102 and BS 103, and the UE 112 and the UE 113 of FIG. 1. This example is for illustration only and other embodiments can be used without departing from the scope of the present disclosure.

A first BS and a first UE that communicate using a first RAT (e.g., 5G) operate in a same frequency band as a second BS and a second UE that communicate using a second RAT (e.g., 6G), 610. The second BS provides to the second UE first information for first T/F/S resources associated with possible transmissions or receptions of first signals or channels (e.g., 5G SSBs, PDCCHs in CORESET #0, PRACH resources) for the first RAT, 620. The second BS provides, to the second UE, second information for second T/F/S resources, associated with transmissions or receptions of second signals or channels for the second UE, wherein the second resources overlap with the first resources, 630. The second UE determines third T/F/S resources from the second resources that do not overlap with the first resources, and fourth T/F/S resources from the second resources that overlap with the first resources, 640. The second UE transmits or receives the second signals or channels in the third T/F/S resources, and does not transmit or receive the second signals or channels in the fourth T/F/S resources, 650.

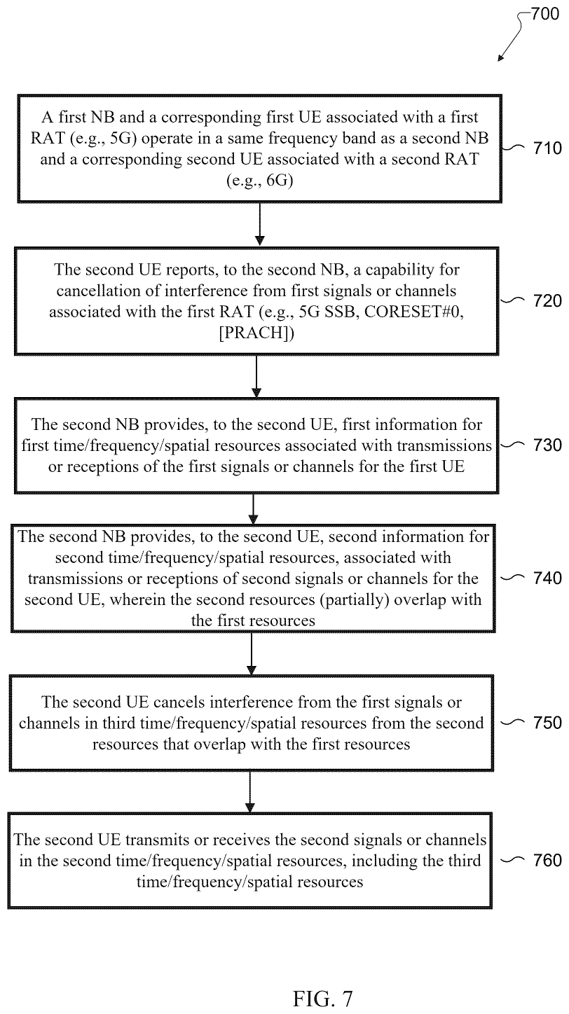

FIG. 7 illustrates a flowchart an example procedure 700 for MRSS mechanism(s) according to embodiments of the present disclosure. For example, procedure 700 can be performed by the BS 102 and the BS 103, and the UE 113 and the UE 114 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 710. The second UE reports to the second BS a capability for cancellation of interference from first signals or channels associated with the first RAT (e.g., 5G SSB, PDCCHs in CORESET #0, PRACH), 720. The second BS provides to the second UE first information for first T/F/S resources associated with transmissions or receptions of the first signals or channels (e.g., 5G SSB, PDCCHs in CORESET #0, PRACH) for the first UE, 730. The second BS provides to the second UE second information for second T/F/S resources, associated with transmissions or receptions of second signals or channels for the second UE, wherein the second resources overlap with the first resources, 740. The second UE cancels interference from the first signals or channels in third T/F/S resources from the second resources that overlap with the first resources, 750. The second UE transmits or receives the second signals or channels in the second T/F/S resources, including the third T/F/S resources, 760.

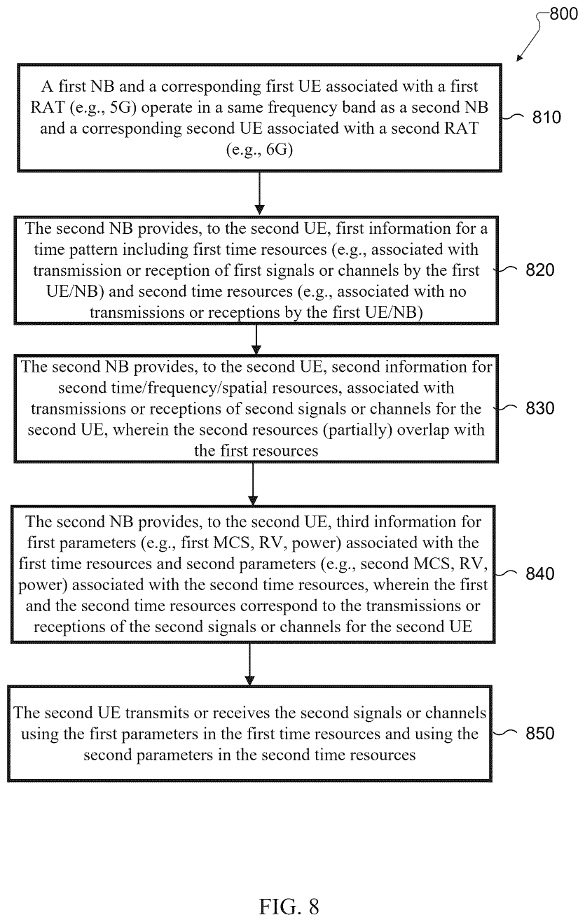

FIG. 8 illustrates a flowchart of an example procedure 800 for MRSS mechanism(s) according to embodiments of the present disclosure. For example, procedure 800 can be performed by the BS 102 and the BS 103, and the UE 114 and the UE 115 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 810. The second BS provides to the second UE first information for a time pattern including first time-domain resources (e.g., associated with transmission or reception of first signals or channels by the first UE/BS) and second time-domain resources (e.g., associated with no transmissions or receptions by the first UE/BS), 820. The second BS provides to the second UE second information for second T/F/S resources, associated with transmissions or receptions of second signals or channels for the second UE, wherein the second resources overlap with the first resources, 830. The second BS provides to the second UE third information for first parameters (e.g., first MCS, RV, transmit or target receive power) associated with the first time-domain resources and second parameters (e.g., second MCS, RV, transmit or target receive power) associated with the second time-domain resources, wherein the first and the second time resources correspond to the transmissions or receptions of the second signals or channels for the second UE, 840. The second UE transmits or receives the second signals or channels using the first parameters in the first time-domain resources and using the second parameters in the second time-domain resources, 850.

MRSS can be based on a 6G UEs determining first T/F/S resources that are unavailable for transmissions/receptions by the 6G UE. For example, it can be predetermined in the specifications of system operation whether or how the 6G UE can receive/transmit in T/F/S resources that overlap with the first T/F/S resources.
For example, a 6G UE (e.g., the UE 116) is not expected to (or does not expect to) receive a DL signal or channel, or to transmit an UL signal or channel, in second T/F/S resources that overlap with the first T/F resources.
For example, a 6G UE can receive a DL signal or channel or transmit an UL signal or channel in second T/F/S resources that overlap with the first T/F/S resources, and the UE avoids the first T/F/S resources e.g. by rate matching or by puncturing the DL/UL signal or channel around the first T/F/S resources. For example, the 6G UE can receive the DL signal or channel or transmit the UL signal or channel in T/F/S resources from the second T/F resources that do not overlap with the first T/F/S resources.
For example, a 6G UE can receive a DL signal or channel or transmit an UL signal or channel in T/F/S resources that overlap with the first T/F/S resources, by additional handling, such as by UE interference cancellation/processing (such as interference cancellation of NR SSB or of PDCCH receptions in CORESET #0) or by transmission power adjustments by the UE/BS, and so on. For example, the 6G UE can indicate a separate capability for such handling.
For example, the 6G UE can be configured or indicated a time pattern such as a TDM pattern and can transmit or receive only in valid/allowed symbols or slots based on the indicated time/TDM pattern. For example, remaining symbols or slots are reserved and are not available for transmissions/receptions by the 6G UE. For example, the 6G UE does not expect to be configured/indicated to receive or transmit in symbols or slots that are not valid/allowed for 6G. For example, when the 6G UE is configured or indicated to receive or transmit a signal or channel in symbols or slots that are not valid/allowed for 6G, the 6G UE drops the signal or channel transmission, or drops the transmission only in the symbols or slots that are not valid/allowed, for example by performing puncturing or rate-matching around those symbols or slots. For example, the UE can fully drop PUSCH/PUCCH and drop SRS only in colliding symbols. For example, a 6G UE, such as a UE indicating a capability for interference cancellation, can receive 6G signals or channels in symbols or slots that are not valid/available for the 6G, such as by decoding and canceling/removing potential interference from any 5G/4G signals or channels received in such symbols or slots.
For example, the 6G UE can be indicated a TDM pattern (also referred to as “soft TDM” pattern) wherein first symbols or slots of the TDM pattern are associated with first/“normal” 6G operation, and second symbols or slots of the pattern are associated with for second/“modified” 6G operation. For example, the first symbols or slots are those with little/no usage by the 5G/4G BS/cell/UEs, while the second symbols or slots are those with moderate/high usage by the 5G/4G BS/cell/UEs. For example, the 6G UE can transmit or receive 6G signals or channels in the first symbols or slots using first parameters, such as parameters associated with operation without interference to transmissions to/from 5G/4G UEs, and can transmit or receive 6G signals or channels with second parameters, such as parameters associated with operation with interference to transmissions to/from 5G/4G UEs.
   For example, for a 6G UE, a first MCS table can be used for transmissions/receptions in the first symbols or slots and a second MCS table can be used for transmissions/receptions in the second symbols or slots, wherein the second MCS table includes MCS values that are smaller (in terms of spectral efficiency) than the smallest MCS value in the first MCS table, or are smaller than respective MCS values with corresponding same indexes in the MCS table.
   For example, in the second symbols or slots and relative to the first symbols or slots, the 6G UE receives DL signals or channels with reduced transmission power, such as reduced/lower power offset values e.g. for PDSCH or for CSI-RS reception relative to SSB reception, or transmits UL signals or channels with reduced power, such as smaller open-loop power control parameters e.g., P0 or alpha, or applies a different closed-loop power control loop.
   For example, in the second symbols or slots, the 6G UE applies different Redundancy versions (RVs), such as self-decodable RVs, e.g., RV=0 or RV=3. For example, such RVs are configured by higher layers to be applied in the second symbols or slots, or other RV values are not expected in a scheduling DCI, or an RV field in a scheduling DCI are interpreted based on such reduced RV set.

With reference to FIG. 6, an example procedure is shown for a UE-based mechanism for MRSS based on rate matching.

With reference to FIG. 7, an example procedure is shown for UE-based mechanism for MRSS via NR interference cancellation.

With reference to FIG. 8, an example procedure is shown for UE-based mechanism for MRSS via TDM pattern.

UE-based avoidance, such as the examples herein, are applicable at least to 6G DL/UL signals or channels with T/F/S resources that are configurable or are indicated via L1/L2 signaling by the 6G BS.

For 6G DL/UL signals or channels with predetermined T/F/S resources or with predetermined structure for the T/F/S resource allocation or with always-on pattern, such as 6G UE/BS wake-up signal (e.g., 6G LP-WUS) or 6G periodic or aperiodic synchronization signal (6G low power state saving (LP-SS) or 6G SSB), if applicable, additional procedures may be needed to achieve avoidance relative to T/F/S resources corresponding to 5G/4G.
In one example, the specifications of 6G operation define T/F/S resources for such predetermined/always-on 6G signals or channels that are separate from predetermined/always-on signals or channels corresponding to 5G/4G.
In another example, the specifications of 6G operation defines a structure, such as periodicity, length in time and frequency domain, such as number of OFDM symbols/slot, number of sub-carriers/RBs/REs, any group or burst operation for multiple transmissions/receptions corresponding to such signals or channels, and so on, while the actual placement of the signal or channel in the time/frequency grid is left to the 6G BS configuration. For example, the second time/frequency resources corresponding to 6G signals or channels can be separate from the first time/frequency resources corresponding to 5G/4G. For example, the first time/frequency resources can be TDM or FDM.

For example, one other option is 6G UEs also being able to utilize 5G SSB and 6G LP-SS for initial access not being configured or be optionally configured for 6G UEs. Similar for CORESET #0, and PRACH resources, CSI-RS, and so on, for example, to re-use instead of avoidance to also minimize overhead at least in the DL.

Methods for determination of first T/F/S resources (corresponding to 5G signals or channels to be avoided) by a 6G UE for UE-based avoidance are subsequently described in one or more embodiments described herein.

In one example, the T/F/S resources can be associated with other domains, such as code domain, sequence domain, power domain, and so on. For example, the information from the 5G/4G BS (e.g., the BS 103) to the 6G BS (e.g., the BS 102) can include an association of each T/F/S resource or each set/list/group of T/F/S resources with values corresponding to such domains. For example, the 6G BS/UEs can avoid the T/F/S resources when applying the indicated values for the corresponding domain, and may not need to avoid the T/F/S resources when applying different values for the corresponding domains.
For example, the information from the 5G/4G BS can include an association of each T/F/S resource or each set/list/group of T/F/S resources with one or multiple beams, or spatial transmission/reception filters, or geographical angles/areas, or TCI states, or reference signals, such as SSB or CSI-RS or SRS, or other spatial domain attributes. For example, any avoidance mechanism, such as those subsequently described, apply to the T/F/S resources in the associated spatial domain direction. For example, the 6G BS/UEs avoid the time/frequency resources when applying a first beam or spatial domain filter, and may not need to avoid the time/frequency resources when applying a second beam or spatial domain filter. For example, T/F patterns can be per TCI state, and that can extended to SSBs, PRACH resources, M-TRP operation, and so on.
For example, the 6G BS/UEs can transmit or receive in the T/F/S resources by applying certain sequences, cyclic shifts, cover codes, power levels, or other transmission/reception attributes that are not used by the 5G/4G BS/UEs or are different from those used by the 5G/4G BS/UEs in the corresponding T/F/S resources. For example, the 6G BS can determine, distinguish, and separate out second receptions from 6G UEs using second sequences, cyclic shifts, cover codes, power levels, and so on, and first receptions from 5G/4G UEs using first sequences, cyclic shifts, cover codes, power levels, and so on, wherein the first receptions and the second receptions correspond to a same T/F resource. For example, at least one of the first sequences, cyclic shifts, cover codes, power levels, and so on are different from the corresponding second sequences, cyclic shifts, cover codes, power levels, and so on.

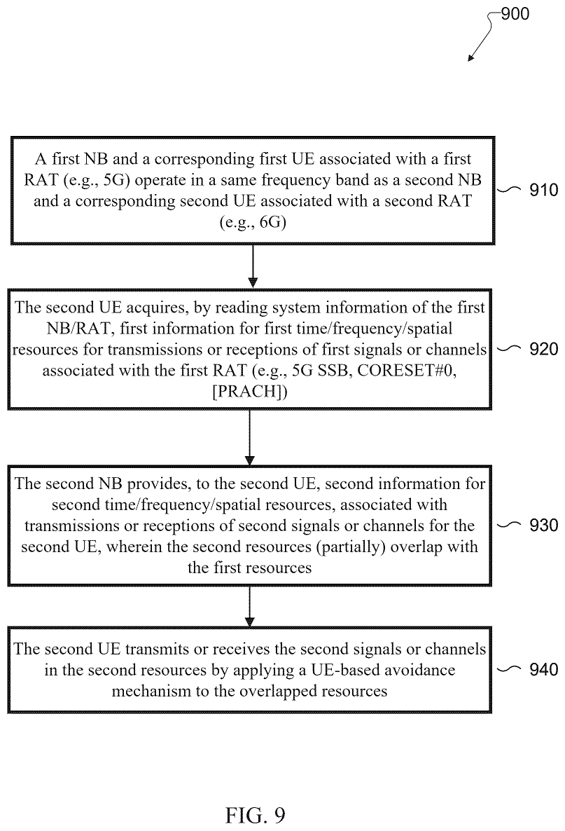

FIG. 9 illustrates a flowchart of an example procedure 900 for avoidance-based MRSS mechanism(s) according to embodiments of the present disclosure. For example, procedure 900 can be performed by the BS 102 and the BS 103, and the UE 115 and the UE 116 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 910. The second UE acquires, by reading system information of the first BS/RAT, first information for first T/F/S resources for transmissions or receptions of first signals or channels associated with the first RAT (e.g., 5G SSB, PDCCH in CORESET #0, PRACH resources), 920. The second BS provides, to the second UE, second information for second T/F/S resources, associated with transmissions or receptions of second signals or channels for the second UE, wherein the second resources overlap with the first resources, 930. The second UE transmits or receives the second signals or channels in the second resources by applying a UE-based avoidance mechanism (such as rate matching or puncturing or dropping or interference cancellation or soft TDM pattern with association to “normal” and “modified” operation, as previously described) to the overlapped resources, 940.

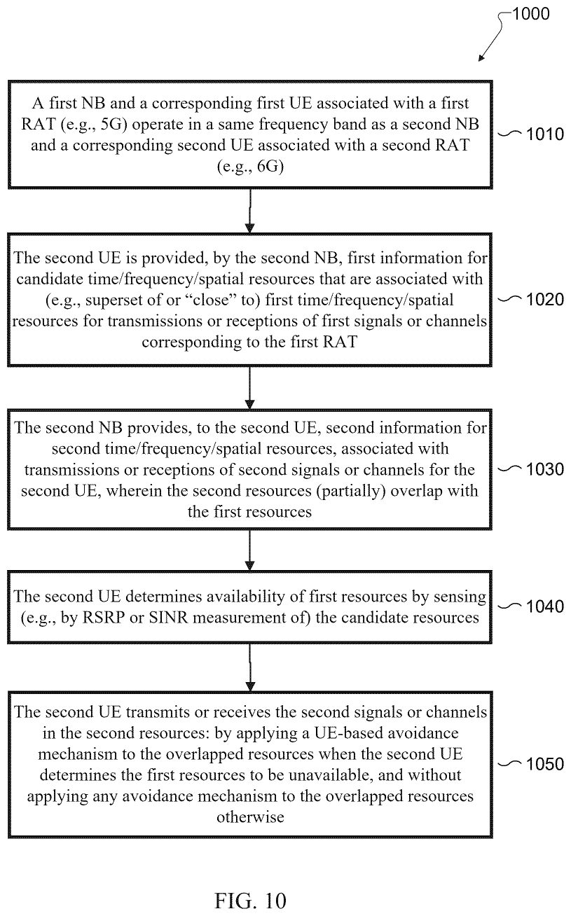

FIG. 10 illustrates a flowchart of an example procedure 1000 for avoidance-based MRSS mechanism(s) according to embodiments of the present disclosure. For example, procedure 1000 can be performed by the BS 102 and the BS 103, and the UE 115 and the UE 116 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1010. The second UE is provided by the second BS first information for candidate T/F/S resources that are associated with first T/F/S resources for transmissions or receptions of first signals or channels corresponding to the first RAT, 1020. The second BS provides to the second UE second information for second T/F/S resources associated with transmissions or receptions of second signals or channels for the second UE, wherein the second resources overlap with the first resources, 1030. The second UE determines availability of first resources by sensing (e.g., by RSRP or signal-to-interference-plus-noise ratio (SINR) measurement of) the candidate resources, 1040. The second UE transmits or receives the second signals or channels in the second resources by applying a UE-based avoidance mechanism to the overlapped resources when the second UE determines the first resources to be unavailable, and without applying any avoidance mechanism (such as rate matching or interference cancellation or TDM pattern, as previously described) to the overlapped resources otherwise, 1050.

There can be various approaches for how a 6G UE determines T/F/S resources corresponding to 5G/4G cell/UEs, such as predetermined information from the specifications of system operation, or based on certain procedures by the 6G UE, such as by acquisition of the 5G/4G system information, or by resource ‘sensing’ (such as by making measurements to determine or ‘sense’ transmissions or receptions in corresponding T/F/S resource or in resources adjacent thereto), or from information provided by higher layer configuration or L1/L2 indication by the 6G BS.

In a first approach, the 6G UE determines first T/F/S resources associated with transmissions/receptions by 5G/4G UEs from the specifications of system operation (such as the 6G specifications and/or the 5G/4G specifications), such as for location of SSBs.

For example, the UE can acquire information of predetermined or preconfigured resources/attributes/parameters from the specifications or from OAM corresponding to always-on or periodic signals, such as LTE CRS or NR SSB or NR PRACH, or partially predetermined or preconfigured resources/attributes/parameters such as for on-demand SSB or on-demand SIB1, or for adaptable PRACH or non-uniform PRACH or on-demand PRACH or muted SSB/PRACH, for example, in terms of candidate locations or placements of resources or possible parameter values or parameter combinations, or corresponding beams or TCI states or QCL relationships or spatial relations.

For example, the specifications of system operation can provide information of “anchor” signals or channels that continue to operate during an OFF period or duration of a Cell DTX/DRX procedure (for a coexisting cell/RAT). In one example, the specifications do not specify any “anchor” signals or channels for Cell DTX/DRX procedure. For example, when UE receives L1/L2 or higher layer signaling that a coexisting RAT, such as 5G RAT, is in an OFF period of a Cell DTX/DRX procedure, the UE such as a 6G UE can assume that any/all resources on the 6G cell are available for transmission or reception, and the UE does not apply any configured/indicated/active RM patterns or T/F/S resources, or at least any T/F/S resources that are associated with a coexisting 5G cell/RAT. In another example, certain signals or channels, such as SSB or CORESET #0 or PDCCH for system information/paging/RAR or PRACH (e.g., periodic SSB or Type-0/0A/1/1A/2/2A PDCCH or uniform PRACH) are specified as not being impacted or switched off by Cell DTX/DRX (otherwise known as “anchor” signals or channels), and therefore when the UE receives an implicit or explicit indication for Cell DTX/DRX for a coexisting 5G cell/RAT, the UE can assume that, except for resources or resource patterns associated with such “anchor” signals or channels, other remaining resources on the 6G cell are available for transmission or reception, and the UE does not apply other configured/indicated/active RM patterns or T/F/S resources, or at least other T/F/S resources that are associated with a coexisting 5G cell/RAT. Similar methods can apply beyond Cell DTX/DRX, such as by other indications for disabling signals or channels, for example, by a network-energy saving (NES)-related signaling or a UE-power-saving (UEPS) related signaling and so on.

In a second approach, a 6G UE acquires the information of the first T/F/S resources based on certain procedures by the 6G UE, such as by acquisition of the 5G/4G system information, or by resource ‘sensing’.

For example, the 6G UE can acquire the information from the 5G/4G BS, without establishing a connection to the 5G/4G BS, for example, by reading the 5G/4G MIB or SIB1 or SIBx>1.

For example, the 6G UE can perform resource ‘sensing’, such as measurement of energy/power corresponding to the first T/F/S resources, such as RSRP, reference signal received quality (RSRQ), RSSI, signal-to-noise ratio (SNR), SINR, based on L1 measurement, with or without L3 filtering. For example, when the measurement metric value exceeds a certain value (or falls below a certain threshold), the UE needs to avoid the corresponding T/F/S resources. For example, the measurement can be for the first T/F/S resources, or for a candidate set of T/F/S resources associated with the first T/F/S resources. Similar methods can apply when resource sensing by the 6G UE can be based on methods other than energy/power measurement, such as sequence detection or channel decoding.
For example, the candidate set of T/F/S resources can be in same frequency domain resources, e.g., same subcarrier/RE/RB/RBG, as the first T/F/S resources, while in preceding time domain resources, such as previous symbols/slots, or in preceding occasions of a time pattern, such as a periodic or semi-persistent time pattern, associated with the first T/F/S resources.
For example, the candidate set of T/F/S resources can be a superset of the first T/F/S resources that includes the T/F/S resources.
In another example, the candidate set of T/F/S resources can be provided by SIB1 or SIBx>1 or by higher layer configuration, such as by cell-specific or UE-specific or RRC configuration, or by L1/DCI indication, by the 6G BS or by the 5G/4G BSs. For example, similar methods as subsequently described for configuration/indication of the first T/F/S resources, can be used for configuration/indication of the candidate set of T/F/S resources.
For example, when the 6G UE performs resource sensing and determines certain T/F/S resources, from the first T/F/S resources or from the candidate T/F/S resources, to be available, the 6G UE can report the corresponding measurement results or such availability determination to the 6G BS (or to the 5G/4G BS?).

With reference to FIG. 9, an example procedure is shown for UE-based mechanism for MRSS with acquisition of T/F/S resources for 5G cell/UEs from the 5G system information.

With reference to FIG. 10, an example procedure is shown for UE-based mechanism for MRSS with determination of T/F resources for 5G cell/UE using resource sensing.

In a third approach, the 6G UE is provided information of the first T/F/S resources by configuration or indication by the 6G BS.

For example, the information can be provided by 6G higher layers such as the 6G MIB or 6G SIB1 or SIBx>1, or by cell-specific or UE-specific RRC configuration, or by L2/MAC-CE indication, or by L1/DCI indication such as group-common DCI or UE-specific DCI or by one or more fields in a 6G DCI format such as a scheduling DCI format. Details of indication/signaling are subsequently described in one or more embodiments described herein.

There can be various methods for a 6G BS to acquire the information of the first T/F/S resources that the 6G BS provides to the 6G UEs:
For example, the 6G BS can acquire the information based on inter-BS signaling with the 5G/4G BS or through the 6G/5G/4G CN.
For example, the 6G BS can acquire the information based on reporting from the 5G/4G UEs (such as MRSS-capable UEs), or based on reporting from 6G UEs. For example, the reporting can be based on resource ‘sensing’, as previously described.
For example, the 6G BS can acquire the information based on the BS implementation such as resource ‘sensing’/measurement, similar to that described for 6G/5G/4G UEs in the previous example.

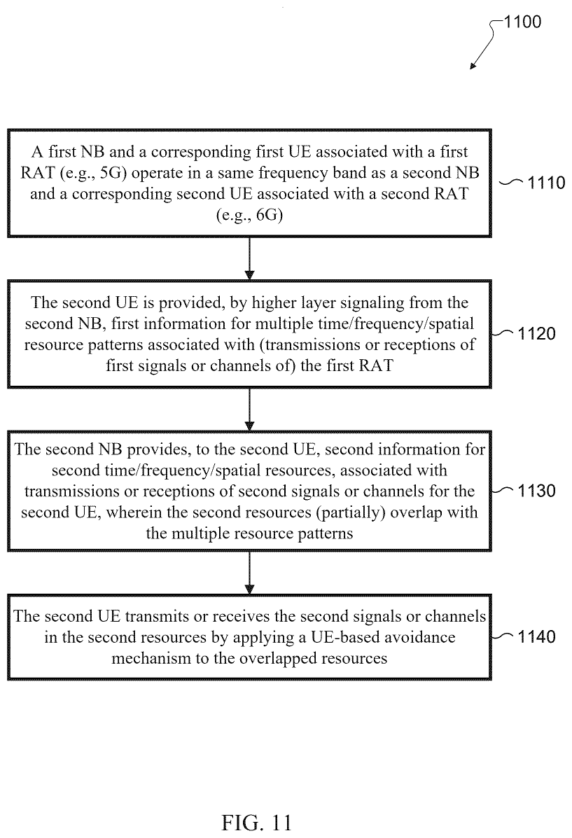

FIG. 11 illustrates a flowchart of an example procedure 1100 for avoidance-based MRSS mechanism(s) according to embodiments of the present disclosure. For example, procedure 1100 can be performed by the BS 102 and the BS 103, and the UE 111 and the UE 116 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1110. The second UE is provided, by higher layer signaling from the second BS, first information for multiple T/F/S resource patterns associated with (transmissions or receptions of first signals or channels of) the first RAT, 1120. The second BS provides to the second UE second information for second T/F/S resources associated with transmissions or receptions of second signals or channels for the second UE, wherein the second resources overlap with the multiple resource patterns, 1130. The second UE transmits or receives the second signals or channels in the second resources by applying a UE-based avoidance mechanism to the overlapped resources, 1140.

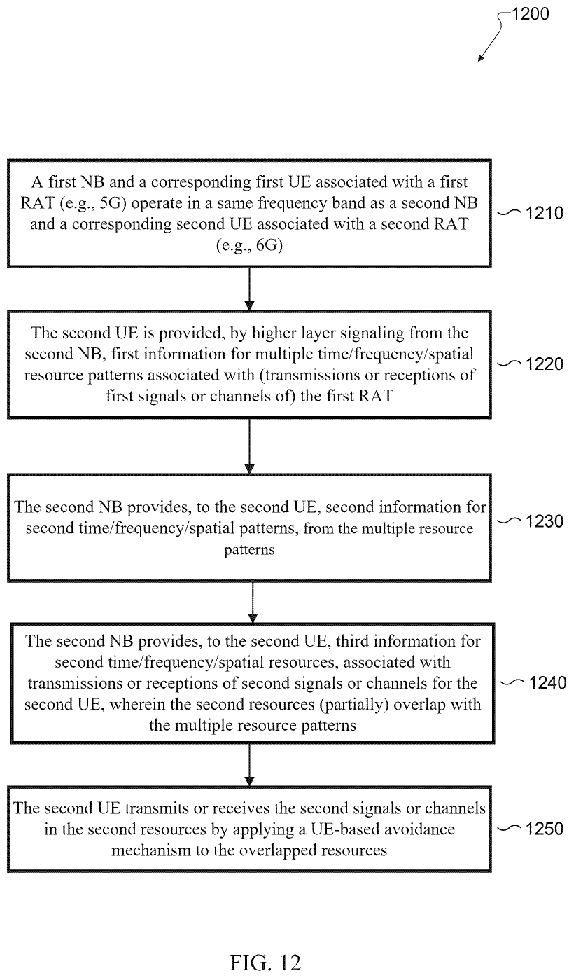

FIG. 12 illustrates a flowchart of an example procedure 1200 for avoidance-based MRSS mechanism(s) according to embodiments of the present disclosure. For example, procedure 1200 can be performed by the BS 102 and the BS 103, and the UE 111 and the UE 115 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1210. The second UE is provided, by higher layer signaling from the second BS, first information for multiple T/F/S resource patterns associated with (transmissions or receptions of first signals or channels of) the first RAT, 1220. The second UE is provided, by L1/L2 signaling from the second BS (e.g., a group-common DCI or a MAC-CE), second information for first (activated) T/F/S resource patterns, from the multiple resource patterns, 1230. The second UE is provided, by the second BS, third information for second T/F/S resources associated with transmissions or receptions of second signals or channels for the second UE, wherein the second resources (partially) overlap with the first resource patterns in third T/F/S resources, and overlap with other (non-activated) resource patterns from the multiple resource patterns in fourth T/F/S resources, 1240. The second UE transmits or receives the second signals or channels in the second resources by avoiding the third resources and without avoiding the fourth resources, 1250.

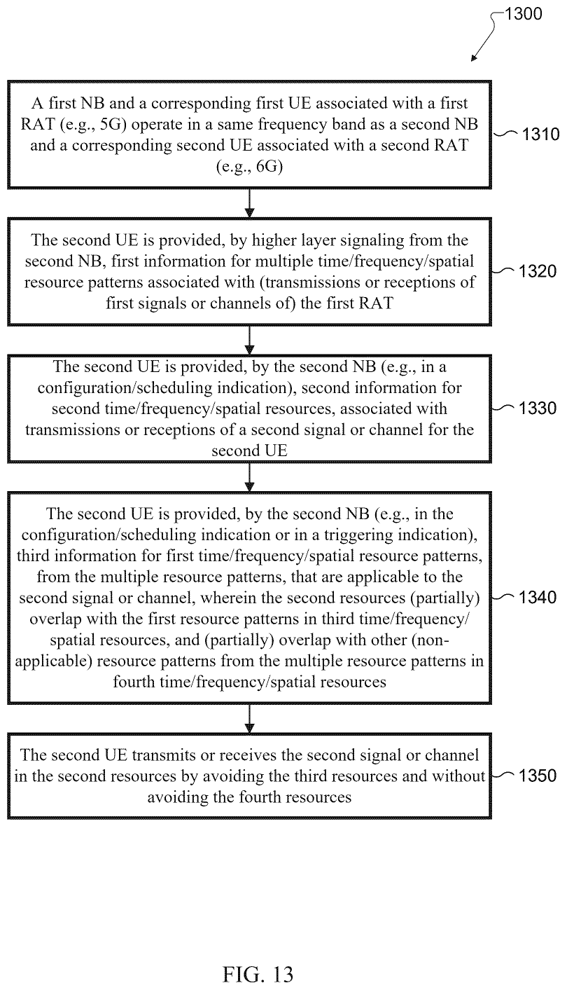

FIG. 13 illustrates a flowchart of an example procedure 1300 for avoidance-based MRSS mechanism(s) according to embodiments of the present disclosure. For example, procedure 1300 can be performed by the BS 102 and the BS 103, and the UE 111 and the UE 114 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1310. The second UE is provided, by higher layer signaling from the second BS, first information for multiple T/F/S resource patterns associated with (transmissions or receptions of first signals or channels of) the first RAT, 1320. The second UE is provided, by the second BS (e.g., in a configuration/scheduling indication), second information for second T/F/S resources associated with transmissions or receptions of a second signal or channel for the second UE, 1330. The second UE is provided, by the second BS (e.g., in the configuration/scheduling indication or in a triggering indication), third information for first T/F/S resource patterns, from the multiple resource patterns, that are applicable to the second signal or channel, wherein the second resources overlap with the first resource patterns in third T/F/S resources, and overlap with other (non-applicable) resource patterns from the multiple resource patterns in fourth T/F/S resources, 1340. The second UE transmits or receives the second signal or channel in the second resources by avoiding the third resources and without avoiding the fourth resources, 1350.

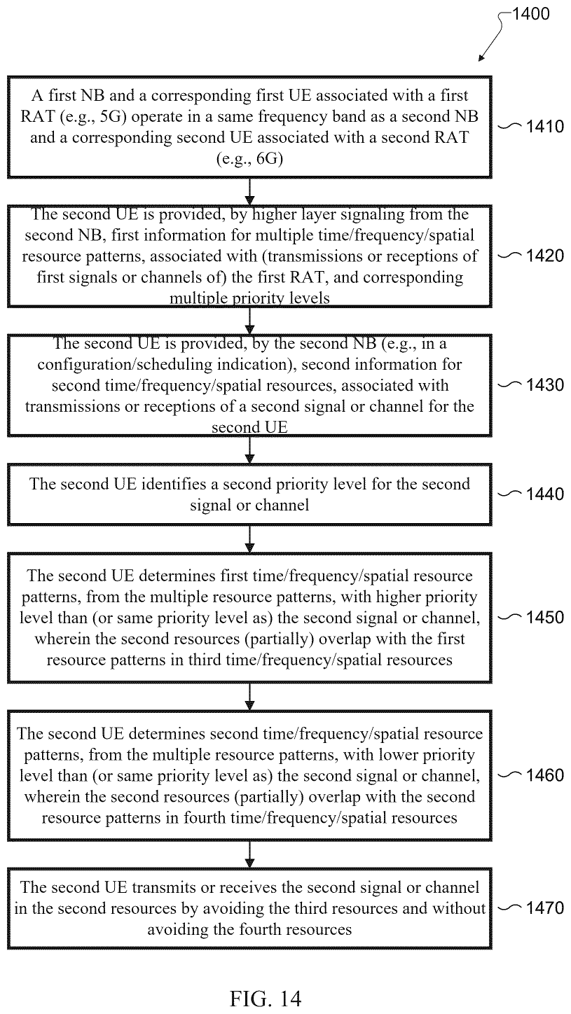

FIG. 14 illustrates a flowchart of an example procedure 1400 for avoidance-based MRSS mechanism(s) according to embodiments of the present disclosure. For example, procedure 1400 can be performed by the BS 102 and the BS 103, and the UE 111 and the UE 113 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1410. The second UE is provided, by the second BS, first information for multiple T/F/S resource patterns associated with (transmissions or receptions of first signals or channels of) the first RAT, and corresponding multiple priority levels, 1420. The second UE is provided, by the second BS (e.g., in a configuration/scheduling indication), second information for second T/F/S resources associated with transmissions or receptions of a second signal or channel for the second UE, 1430. The second UE identifies a second priority level for the second signal or channel, 1440. The second UE determines first T/F/S resource patterns, from the multiple resource patterns, with higher priority level than (or same priority level as) the second signal or channel, wherein the second resources (partially) overlap with the first resource patterns in third T/F/S resources, 1450. The second UE determines second T/F/S resource patterns, from the multiple resource patterns, with lower priority level than (or same priority level as) the second signal or channel, wherein the second resources (partially) overlap with the second resource patterns in fourth T/F/S resources, 1460. The second UE transmits or receives the second signal or channel in the second resources by avoiding the third resources and without avoiding the fourth resources, 1470.

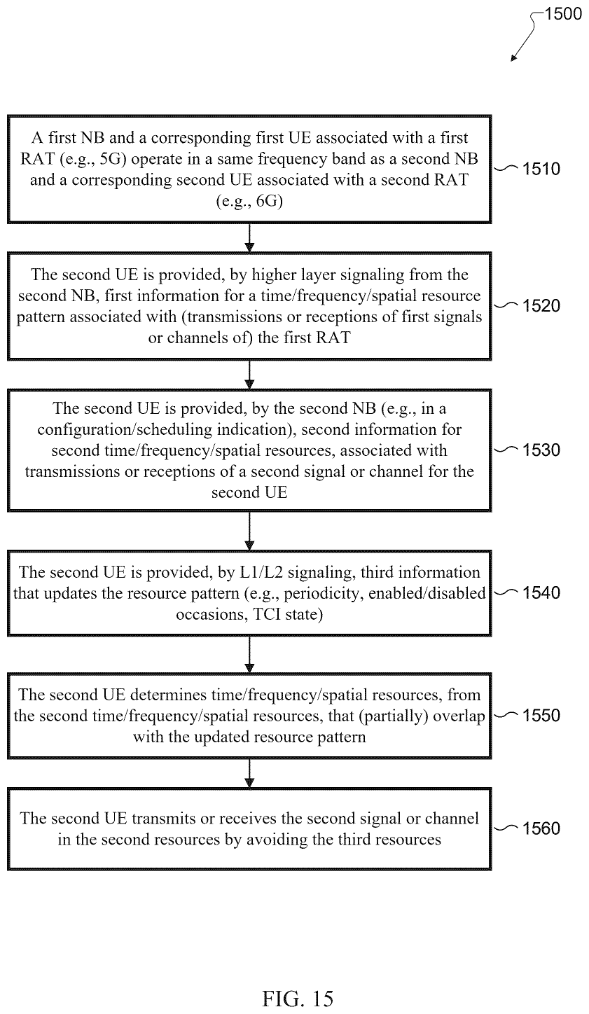

FIG. 15 illustrates a flowchart of an example procedure 1500 for avoidance-based MRSS mechanism(s) according to embodiments of the present disclosure. For example, procedure 1500 can be performed by the BS 102 and the BS 103, and the UE 116 of FIG. 3 and the UE 111 of FIG. 1. This example is for illustration only and other embodiments can be used without departing from the scope of the present disclosure.

A first BS and a corresponding first UE associated with a first RAT (e.g., 5G) operate in a same frequency band as a second BS and a corresponding second UE associated with a second RAT (e.g., 6G), 1510. The second UE is provided, by higher layer signaling from the second BS, first information for a T/F/S resource pattern that is, for example, associated with the first RAT, 1520. The second UE is provided, by the second BS (e.g., in a configuration/scheduling indication), second information for second T/F/S resources, associated with transmissions or receptions of signals or channels by the second UE, 1530. The second UE is provided, by L1/L2 signaling, third information that updates the resource pattern (e.g., updated periodicity, enabled/disabled occasions, TCI state), 1540. The second UE determines [third?] T/F/S resources, from the second T/F/S resources, that overlap with the updated resource pattern, 1550. The second UE transmits or receives the second signal or channel in the second resources by avoiding the third resources, 1560.

In one embodiment, a 6G UE (e.g., the UE 116) is provided one or multiple T/F/S patterns or one or multiple sets or groups or lists of T/F/S patterns, for example corresponding to 5G/4G cell/UEs, to be avoided. The 6G UE can be predetermined to avoid transmissions/receptions in configured T/F/S patterns, or the 6G UE can be indicated a number of “active” T/F/S patterns, from the configured T/F patterns, to avoid transmissions/receptions. In another method, the 6G UE can be provided information of priority levels for a 6G signal or channel and/or priority levels for the configured or activated T/F/S patterns, and the UE avoids T/F/S patterns that have higher priority level (or same priority level) as the 6G signal or channel, while transmitting/receiving over elements of T/F/S patterns that have lower priority level (or same priority level) as the 6G signal or channel. In other embodiments, parameters of the T/F/S patterns can be updated by L1/L2 signaling, such as indication of muting/disabling or enabling certain time occasions from a T/F/S pattern. For example, when the UE receives an indication or otherwise (implicitly) determines that certain configuration, such as certain sub-configurations from a main configuration, such as for CSI-RS or for SRS or other signals or channels, are enabled or disable due to network energy saving (NES) or UE power saving (UEPS) reasons or due to other indicated or non-indicated reasons, the UE applies T/F/S resources to be avoided based on the active/applicable configurations/sub-configurations, and does not apply the inapplicable or muted or disabled configurations or sub-configurations.

A 6G UE can be provided information of the first T/F/S resources via one or multiple T/F/S patterns.
For example, for each T/F/S pattern, the information indicates T/F/S resources in the T/F/S pattern, such as number or placement of symbols/slots or number or placement of subcarriers/REs/RBs or number of TCI states, and so on, or provides certain parameters to determine the T/F/S resources in the pattern, such as periodicity, offset, and so on, as subsequently described.
For example, when the 6G UE is provided multiple T/F/S patterns, information of each T/F/S pattern can be provided separately.
For example, the 6G UE can be provided information of one or multiple sets or groups of T/F/S patterns, wherein each set or group of T/F/S patterns can include (one or) multiple T/F/S patterns. For example, different T/F/S patterns in a same set/group can share certain features, such as being periodic or being semi-persistent, or corresponding to downlink (resp. uplink), and so on, as subsequently described.
For example, the 6G UE can be provided information of one or multiple lists of T/F/S patterns, wherein each list of T/F/S patterns can include (one or) multiple sets/groups of T/F/S patterns. For example, different sets/groups of T/F/S patterns in a same list of T/F/S pattern share certain features, such as sets/groups corresponding to a same ‘usage’ or a same ‘operation’, and so on, as subsequently described.

For example, when the 6G UE is provided multiple T/F/S patterns (or sets/groups/lists of T/F/S patterns), various options can apply to determination of the T/F/S patterns that the 6G UE avoids for transmissions/receptions.

In a first option, the 6G UE avoids any number of the multiple T/F/S patterns (or sets/groups/lists of T/F/S patterns) that overlap with a 6G signal or channel reception or transmission.

For example, when a priority flag/level is provided for the T/F/S pattern (as subsequently described), the UE avoids T/F/S patterns with (same or) higher priority than the given 6G signal or channel. For example, the UE may not avoid (or does not avoid) T/F/S patterns with lower (or same) priority than the given 6G signal or channel.

In a second option, the 6G UE is indicated a number of T/F/S patterns (or sets/groups/lists of T/F patterns) from the multiple T/F/S patterns (or sets/groups/lists of T/F/S patterns), and the UE avoids the number of T/F/S patterns that overlap with a 6G signal or channel reception or transmission. For example, the 6G UE need not avoid for transmission or reception other T/F/S patterns that are not indicated, even when overlapping with the given 6G signal or channel.
For example, the one or certain number of T/F/S patterns can be regarded as “active” T/F/S patterns, while other T/F/S patterns are regarded as “inactive” or “deactivated” T/F/S patterns. Such indication can be beneficial, for example, when a 5G/4G signal or channel can be activated or deactivated, such as for semi-persistent CSI-RS or SRS, or for on-demand signals or channels, such as on-demand SSB on SCells, or for on-demand SIB1, or for on-demand SIBx>1, or when 5G LP-WUS or 5G DCI 2_6 indicate no PDCCH monitoring, or when or DCI 2_9 indicates cell discontinuous transmission (DTX)/discontinuous transmission (DTX).
For example, the indication can be based on L1/L2 signaling, such as an indication of index(es) of the active T/F/S patterns, or of a bitmap with each bit corresponding to a different T/F/S pattern, or different T/F/S patterns within a given set/group/list of T/F/S patterns, or a different set/group/list of T/F/S patterns.
For example, the indication can be specific to a given 6G signal or channel or can correspond to different 6G signals or channels, for example, for a certain time duration, such as starting from a time when the 6G UE receives the indication (or starting from a predetermined or configured processing time after a time/symbol/slot when the 6G UE receives the indication) until reception of a next such indication, or for a time duration provided in the indication, or for a predetermined or configured time duration.
For example, the indication can be provided in a same L1/L2 signaling that schedules or triggers or activates a 6G signal or channel. For example, the indication can be by an information element (or multiple information elements) in a MAC-CE that activates the 6G signal or channel, such as semi-persistent (SP) CSI-RS or SP SRS or on-demand SSB, and so on. For example, the indication can be by a field (or multiple fields) in a DCI format that schedules or triggers the 6G signal or channel, such as a PDSCH/PUSCH that is scheduled by a DCI format, or SPS PDSCH, configured grant (CG) PUSCH, AP CSI-RS, AP SRS, and so on.
For example, such indication can be beneficial when the indication is specific to the given 6G signal or channel.
For example, the indication can be provided in an L1/L2 signaling that schedules or triggers or activates a 6G signal or channel different from the given 6G signal or channel. For example, a MAC-CE command or DCI format that schedules or triggers a 6G signal or channel can also indicate active T/F/S patterns for subsequent transmission or receptions of 6G signals or channels. For example, such indication can be beneficial when the indication applies to different 6G signals or channels such until a next indication.
For example, the indication of active T/F/S patterns can be provided in a stand-alone signaling that does not schedule or trigger or activate any 6G signal or channel transmission/reception. For example, a standalone 6G signaling, such as a MAC-CE command or a UE-specific or group-common DCI format can indicate active T/F/S patterns for a certain time duration. For example, such indication can be beneficial when the indication applies to different 6G signals or channels such as in a predetermined/configured/indicated time duration or until a next indication. For example, the MAC-CE or group-common DCI format can include an information element or field to indicate one value among a number of values for a time duration in which the indication applies. For example, the values can be in terms of a number of symbols or slots or in terms of a number of msec or usec. For example, when no value is indicated or when a reserved value (such as all-0 or all-1) is indicated, the 6G UE applies the active T/F/S pattern until a next such indication. For example, such standalone indications can be beneficial when the T/F/S pattern corresponds to a cell-specific signal or channel, such as on-demand SSB or on-demand PRACH, that different 6G UEs apply in common. In another example, different UEs are indicated different segments or elements or fields in the MAC-CE or the group-common DCI and each 6G UE T/F/S applies the active T/F/S patterns that are indicated by the segment or element or field corresponding to that 6G UE. If the 6G UE does not receive the DCI format or the MAC CE at a predetermined occasion, the UE assumes that T/F/S patterns are active and the UE avoids for transmissions/receptions associated T/F/S elements of the patterns until the UE is indicated otherwise.
For example, when a priority flag/level is provided for the T/F/S pattern (as subsequently described), the UE applies the priority flag/level of the indicated T/F/S patterns. For example, the 6G UE avoids for transmissions/receptions the indicated T/F/S patterns when the corresponding priority level is higher than (or same as) a priority flag/level for the given 6G signal or channel. For example, the 6G may not (or does not) avoid the T/F/S pattern when the corresponding priority level is lower than (or same as) a priority flag/level for the given 6G signal or channel. Such method applies, for example, when the indication is provided for different 6G signal or channel in a certain time duration.
In another example, the 6G UE avoids for transmissions/receptions an indicated T/F/S pattern regardless of a configured/indicated priority level for the T/F/S pattern, or regardless of whether a corresponding priority level for the T/F/S pattern is higher than, same as, or lower than a priority flag/level for the given 6G signal or channel. For example, the UE discards the priority flag/level of the indicated T/F/S patterns. Such method applies, for example, when the indication is provided specifically for the given 6G signal or channel.

With reference to FIG. 11, an example procedure is shown for MRSS with multiple configured T/F/S patterns.

With reference to FIG. 12, an example procedure is shown for MRSS based on standalone indication of a subset of activated T/F/S patterns from multiple configured T/F/S patterns.

With reference to FIG. 13, an example procedure is shown for MRSS with a subset of applicable T/F/S patterns from multiple configured T/F/S patterns.

With reference to FIG. 14, an example procedure is shown for MRSS with a subset of applicable T/F/S patterns, from multiple configured T/F/S patterns, with higher (or same) priority than a corresponding 6G signal or channel.

In one example, parameters of a T/F/S pattern are provided by higher layers, such as SIB1, SIBx>1, or common or dedicated RRC signaling. In another example, parameters of a T/F/S pattern can be provided by L1/L2 signaling.

In another example, information of different parameters of a T/F/S pattern can be separately provided, such as first parameters (including some or no parameters) that are provided by higher layers with little or no L1/L2 signaling, and second parameters (including some or all parameters) that are indicated or updated by L1/L2 signaling.
For example, first parameters are provided by higher layers and cannot be updated by L1/L2 signaling, and second parameters are provided by higher layers and can be updated by L1/L2 signaling;
For example, first parameters are provided by higher layers and cannot be updated by L1/L2 signaling, and second parameters are provided by L1/L2 signaling;
For example, first parameters are provided by higher layers and can be updated by L1/L2 signaling, and second parameters are provided by L1/L2 signaling;

For example, for periodic or semi-persistent T/F/S patterns (as subsequently described), a periodicity can be among the first parameters that are provided by higher layers. For example, multiple RM pattern can be configured for the UE by higher layers such as by RRC signaling, and the UE can be indicated by L1/L2 signaling such as by a DCI format (for example, a GC-DCI format) or a MAC-CE one RM pattern or a subset or group of RM patterns from the configured RM patterns to be avoided.

In various methods and examples, throughout the present disclosure, in which the UE can be indicated certain UE procedures by a MAC-CE, such MAC-CE can be provided by UE-specific/unicast PDSCH that is scheduled by a UE-specific/unicast DCI format or PDCCH, or can be provided by a group-common or cell-specific PDSCH that is scheduled by a group-common or cell-specific DCI format or PDCCH.

For example, when a periodicity of a 5G signal or channel can be updated, a corresponding periodicity can be updated by L1/L2 signaling.

In another example, the 6G UE can be provided time occasions corresponding to a T/F/S pattern can be provided by higher layers, and the UE can be provided L1/L2 signaling that indicates an ON/OFF bitmap to indicate which time occasions of the pattern are to be avoided for transmissions/receptions. Such method can be beneficial, for example, for cases when a signal or channel can be turned ON or OFF or adapted by L1/L2 signaling, for example, based on DL/UL traffic situation or can be transmitted or received on-demand, for example, due to network/UE energy saving. For example, such indication can correspond to an on-demand SSB or tracking reference signal (TRS) or CSI-RS, or on-demand/adaptable PRACH or SRS, and so on.

For example, there can be fast inter-BS signaling in order for the 5G/6G BS (e.g., the BS 102) to indicate the adaptation to its served UEs. For example, such may be also rely on indication of RM pattern (or group common (GC)-DCI can be used).

For example, a spatial filter or beam/TCI corresponding to a T/F/S pattern can be provided by higher layers and updated by L1/L2 signaling, when needed, or can be indicated by L1/L2 signaling from a number of predetermined or configured spatial filters/beams/TCI states.

For example, such methods can be based on or related to measurements, e.g. for mobility or for beam maintenance. For example, for scheduling, the UE can follow the indicated TCI state.

For example, the UE can be configured to receive L1/L2 signaling, such as a group-common DCI (GC-DCI) format or a MAC-CE that indicates a subset or group of active TCI states or spatial relations or SSB/CSI-RS/SRS resource indexes among the configured TCI states or spatial relations or SSB/CSI-RS/SRS resource indexes. For example, such indication of the subset or group of active TCI states can apply to one or more of UE procedures for beam management, mobility including LTM, or coexistence handling such as for rate matching patterns or other avoidance methods. For example, indication of applicable TCI states or spatial relations by a same GC-DCI can apply to various UE procedures, or the GC-DCI can include an indication of an applicable UE procedure, or the UE can receive separate GC-DCI formats can be used for such indication for different UE procedures. For example, the indication can apply to one UE or a number/group of UEs, with blocks of information corresponding to different UEs or corresponding to different RM patterns or different beam indexes or different UE procedures and so on.

With reference to FIG. 15, an example procedure is shown for MRSS based on T/F/S resource patterns with parameters that can be adapted by L1/L2 signaling.

For example, NR SSBs/CORESET #0 can be assumed available or unavailable due to network energy savings (NES) on a cell. For example, resources on a cell can be assumed available/unavailable for 6G if the cell is DTX/DRX for NR.

In one embodiment, various attributes can apply to the first T/F/S resources that the 6G BS/UEs need to avoid for transmissions/receptions. Such attributes can include, for example, a link direction, such as DL or UL, a corresponding time pattern, such as periodic, semi-persistent, or aperiodic, a priority flag or level, a granularity, and so on, as subsequently described.

With regard to uplink or downlink, in one example, the T/F/S resources apply to both downlink and uplink (e.g., at least for operation in an frequency division duplexing (FDD)/paired spectrum). In another example, the T/F/S resources apply to downlink only. In another example, first T/F/S resources apply to downlink, and second T/F/S resources apply to uplink, wherein the first and second T/F/S resources are partially or fully separate.

With regard to the time domain, in one example, the T/F/S resources can have certain structure in time domain, such as periodic (P), semi-persistent (SP), or aperiodic (AP).

For example, periodic T/F/S resources include a set of T/F/S resources with a predetermined or configured/indicated periodicity in at least one of time domain, frequency domain, or spatial domain.
For example, a set of periodic T/F/S resources can be based on a periodic resource pattern in time domain, with a slot/subframe offset, and with same resources in the frequency domain or spatial domain, or with a hopping pattern for the frequency domain or spatial domain resources.
For example, the information for the first T/F/S resources can include multiple sets of periodic T/F/S resources, each with a separate periodicity.

For example, semi-persistent T/F/S resources can include a set of T/F/S resources with a predetermined or configured/indicated periodicity in a number of domains and can be activated or deactivated, wherein the activation/deactivation can be based on L1/L2 indication such as MAC-CE command or UE-specific/group-common/cell-specific DCI, for example, associated with a UE-specific search space (USS) or CSS, or based on UE determination of an activation condition/event or a deactivation condition/event.
For example, a set of semi-persistent T/F/S resources can be based on a semi-persistent resource pattern in time domain, with a slot/subframe offset, and with same resources in the frequency and spatial domains, or with a hopping pattern for the frequency domain or the spatial domain resources.
For example, the 6G BS/UEs apply the activation/deactivation, e.g., start or stop to avoid the semi-persistent T/F/S resources after a certain time duration, such as a predetermined or indicated processing time, from a time of the activation or deactivation. For example, the processing time can be 3 msec from transmission of a PUCCH that provides HARQ-ACK information corresponding to a PDSCH that carries a MAC-CE command for activation or deactivation. For example, the processing time can be N symbols from a last symbol/slot of PDCCH reception that provides a DCI format for activation/deactivation.
For example, the information for the first T/F/S resources can include multiple sets of semi-persistent T/F/S resources, each with a separate periodicity. For example, each set of semi-persistent T/F/S resources can correspond to a separate activation/deactivation command or determination, or a same activation command or determination can jointly activate multiple sets of semi-persistent T/F/S resources, or a same deactivation command or determination can deactivate multiple sets of semi-persistent T/F/S resources. For example, the information of the multiple sets of semi-persistent T/F/S resources are predetermined or configured/indicated, and the activation/deactivation provide information, such as index, of the activated/deactivated set(s) from the multiple sets.

For example, aperiodic T/F/S resources include a set of T/F/S resources that are relative to an absolute time reference or frequency reference, such as the 5G/4G NR time/frequency grid, for example, first symbol of slot #0 of subframe #0 or first subcarrier/RE of the RB #0, or the common resource grid (CRB), or that are relative to an indication by the 6G BS (or the 5G/4G BS) such as an L1/DCI indication or L2/MAC-CE indication, or that are relative to a time when the 6G BS/UE determines or is indicated a condition or event such as a cell DTX/DRX for 5G operation. In case of indication or determination, the reference time can start after a time duration, such as a processing time for MAC-CE/DCI processing, or for UE preparation after UE determination or at a start of the event such as a cell DTX/DRX. For example, the information can include a structure of the aperiodic T/F/S resources.
For example, the information can include time-domain information, such as a number of symbols or a number of slots, or a slot offset from the reference time, or a slot offset between different T/F/S resources of a same set of T/F/S resources.
For example, the information can include frequency-domain information, such as a number of REs or a number of RBs/RBGs, or an RE/RB/RBG offset from the reference frequency, or an RE/RB/RBG offset between different aperiodic resources of a same set of T/F/S resources.
For example, certain information can be provided jointly, such as a joint indication of the time/frequency offset and the time/frequency length, using an SLIV-like approach as in [REF 4].
For example, the information can include a granularity level for the T/F/S resources, such as one of symbol/slot/subframe/frame or one of RE/RB/RBG, or a corresponding SCS or numerology. For example, the information can include absolute units, such as msec, usec, and so on, or kHz, MHz, GHz, and so on.
In one example, L1/L2 indication indicates one or more or all parameters corresponding to aperiodic T/F/S resources. In another example, information of a set of aperiodic T/F/S resources along with corresponding resource indexes are predetermined by the specifications of system operation or are provided by higher layer signaling or by inter-BS signaling, and an L1/L2 indication or UE/BS determination identifies information of which resources, corresponding to which resource indexes, are applied for being avoided.

Various aspects previously described for each of P/SP/AP resources can apply to others of P/SP/AP resources as well.

In one example, the T/F/S resources can be arbitrary in time domain, such as a bitmap with no certain structure (as in P/SP/AP patterns). For example, the information of T/F/S resources can include information of a number of T/F/S resources, using methods previously described for P/SP/AP resources.

With regard to the frequency domain, in one example, a T/F/S pattern can include a certain structure in the frequency domain, e.g., contiguous subcarriers/REs/RBs.
For example, a ‘length’ of the resource in the frequency domain can be described using a number of applicable subcarriers/REs/RBs/RBGs. For example, a ‘start’ parameter can be used to indicate the placement of the contiguous resource allocation. For example, the ‘start’ and ‘length’ parameters can be provided separately or can be combined into a single parameter such as resource indicator value (RIV) in the granularity of REs, REGs, RBs or RBGs, for example, as defined in [REF 4].
For example, each T/F/S resource or each subset of T/F/S resources in a same T/F/S pattern can have different frequency domain allocation, such as different number of subcarriers/REs/RBs or different RIVs.
In another example, different resources in a same T/F/S pattern can have a same number of subcarriers/REs/RBs or a same RIV.
In another example, a resource in the T/F/S pattern can correspond to multiple contiguous frequency domain allocations (or multiple segments), such a first frequency allocation with a first number of subcarriers/REs/RBs or a first RIV and a second frequency allocation with a second number of subcarriers/REs/RBs or a second RIV. For example, the first and second frequency allocations can be separated.
For example, different resources in a same T/F/S pattern can correspond to a same multiple contiguous frequency domain allocation.

In one example, the T/F/S resources can be arbitrary in frequency domain, with no certain structure (such as contiguous or multiple segments), and the information of each T/F/S resource in a T/F/S resources pattern can be provided separately, using methods previously described.

With respect to granularity, the 6G UE determines the first T/F/S resources, including T/F/S resources configured/indicated in a T/F/S resource pattern, with respect to a reference granularity, or with respect to a configured/indicated granularity.
For example, the granularity can be with respect to absolute time or frequency units, such as msec, micro-see, and so on, or kHz, MHz, GHz, and so on.
For example, the granularity can be with respect to reference time or frequency units of the system, such OFDM operation, for example, a reference SCS or numerology. For example, the reference SCS or numerology can be different for different frequency ranges, such as 15 kHz for FR1, or 60 kHz for FR2.
For example, the granularity can be same as an SCS of the 6G cell, such as, an SCS/numerology for the active DL/UL BWP of the 6G cell.
For example, the granularity can be explicitly configured or indicated to the 6G UE. For example, the granularity such as SCS/numerology can be separately configured for each T/F/S resource, or for each T/F/S resource pattern, or for each set/group of T/F/S patterns, or for each list of T/F/S resource patterns (as previously described). For example, when a granularity, such as SCS or numerology is configured or indicated for a T/F/S pattern or set/group/list of T/F/S patterns, the same SCS/numerology applies to different T/F/S resources in the corresponding T/F/S pattern or set/group/list of T/F/S patterns.
In one example, the 6G UE applies the T/F/S resource based on a granularity, such as an SCS/numerology, that is indicated in an activation commands for the T/F/S resource. For example, the T/F/S resource may not be configured with an associated granularity. For example, the T/F/S resource may be configured with an associated granularity and the activation command can override the associated granularity by indicating a different granularity.
   For example, the 6G UE receives or transmits a certain 6G signal or channel in second T/F/S resources that overlaps with the first T/F/S resources, and a corresponding scheduling/activating command for the certain 6G signal or channel indicates the granularity of the overlapping first T/F/S resources or resource pattern. For example, the scheduling/activating command can be a scheduling DCI format for a PDSCH or a PUSCH, or a MAC-CE activation command for an SP PUCCH, or a DCI format for triggering AP CSI-RS or AP SRS, and so on.
   In another example, the 6G UE (e.g., the UE 116) can receive a non-scheduling DCI format or MAC-CE that activates one or multiple T/F/S resources or T/F/S resource patterns with and indicates a corresponding granularity. For example, the activated T/F/S resources or patterns apply to (all) upcoming transmissions or receptions of 6G signals or channels, until a next indication or for a certain time duration.

For example, some beams can be deactivated for NR or 6G, e.g. when there are no corresponding UEs served by that beam, and then the rate matching (RM) pattern for the other UEs can change.

With regard to usage, A T/F/S resource configured/indicated to be avoided can be transparent on the reason why the T/F/S resource needs to be avoided, or the T/F/S resource can be associated with an explicit ‘usage’ that indicates, e.g., what 5G signal or channel the T/F/S resource corresponds to.

For example, the ‘usage’ can indicate that the T/F/S resource corresponds to one or more of: 5G SSB or 5G TRS or 5G CSI-RS or 5G CORESET/PDCCH, and so on. For example, the ‘usage’ can be indicated separately for each T/F/S resource, or can be shared for different T/F/S resources within a same T/F/S resource pattern or within a same set/group of T/F/S resource patterns, or a same list of T/F/S resources (terminology as previously defined). For example, a first T/F/S resource pattern can correspond to 5G SSB and a second T/F/S resource can correspond to 5G TRS.

In another example, a T/F/S resource pattern may not include any ‘usage’ information, for example, due to including different T/F/S resources corresponding to different 5G signals or channel, for example, to avoid RRC/DCI overhead that can be potentially caused by configuration or indication of multiple separate T/F/S patterns.

In another example, certain T/F/S resource patterns may correspond to certain 5G/4G signals or channels, for example first T/F/S resource patterns corresponding to NR SSB, and second T/F/S resource patterns to NR CORESET #0, and third T/F/S resource patterns to LTE CRS, and so on.

With regard to priority, the 6G UE can be configured or indicated a ‘priority’ level for a T/F/S resource or a T/F/S resource pattern to be avoided for transmissions or receptions, such as whether the 6G UE avoids the T/F/S resource/pattern when receiving a certain 6G signal or channels or whether the 6G UE need not avoid the T/F/S resource/pattern when receiving the 6G signal or channel. For example, the 6G UE avoids a first T/F/S resource/pattern with a higher (or same) priority, and may not avoid a second T/F/S resource/pattern with a lower (or same) priority.
For example, the 6G signal or channel can have a predetermined or configured priority level, and when a priority for the 6G signal or channel is lower than (or same as) a priority configured/indicated for the T/F/S resource/pattern, the 6G UE avoids the T/F/S resource/pattern when receiving or transmitting the 6G signal or channel.
For example, when a priority for the 6G signal or channel is higher than (or same as) a priority configured/indicated for the T/F/S resource/pattern, the 6G UE may not avoid the T/F/S resource/pattern when receiving or transmitting the 6G signal or channel.
For example, when the 6G signal is a 6G SSB (or corresponding signal for synchronization or system information), the 6G UE may not avoid reception in T/F/S resources overlapping with 5G CSI-RS, when applicable. For example, when the 6G signal is a 6G PDSCH, the 6G UE may avoid reception in T/F/S resources overlapping 5G SSB or 5G CSI-RS, when applicable.
For example, the ‘priority’ information can be a binary flag (present or absent), or can include a value from a number of values for priority levels.

For example, the ‘priority’ information can be provided separately for each T/F/S resource, or a same ‘priority’ can be provided for different T/F/S resources within a same T/F/S resource pattern or a same set/group of T/F/S resource patterns or a same list of T/F/S resource patterns (with terminology as previously described).

In another example, ‘priority’ information can additionally or alternatively indicate explicitly, for what 6G signals or channels, the T/F/S resource (or pattern/set/group/list) may be avoided. For example, the 6G UE can avoid a first T/F/S resource for reception of 6G SSB or PDCCH or PDSCH, can avoid a second T/F/S resource for reception of 6G PDSCH, and may not avoid the second T/F/S resource for reception of 6G SSB or PDCCH.

For example, a priority can be tied to a signaling method for the T/F/S resource or pattern. For example, a T/F/S resource or pattern that is indicated by L1/L2 signaling is assumed to have higher priority (even when a corresponding higher layer configuration for the T/F/S resource or pattern provides a lower priority level or does not have a priority flag).

For example, certain ordering of priority levels can be evaluated such as the following:
First, T/F/S resource or pattern indicated by L1 with higher priority level/flag, if applicable,
Second, T/F/S resource or pattern indicated by L2 with higher priority level/flag, if applicable,
Third, T/F/S resource or pattern indicated by L3 with higher priority level/flag, if applicable,
Fourth, T/F/S resource or pattern indicated by L1 with lower (or without) priority level/flag, if applicable,
Fifth, T/F/S resource or pattern indicated by L2 with lower (or without) priority level/flag, if applicable,
Sixth, T/F/S resource or pattern indicated by L3 with lower (or without) priority level/flag, if applicable.

With regard to operation, the 6G UE can be configured or indicated an ‘operation’ information for a T/F/S resource that indicates an applicable avoidance operation that the UE applies when attempting to avoid the T/F/S resource.

For example, the ‘operation’ can indicate one of ‘puncture’ or ‘rate match’ and the UE applies the corresponding method when avoiding the T/F/S resource. In another example, the ‘operation’ can also include ‘receive’ at least when the 6G UE reports a capability for interference cancellation. The capability can be separate for different 5G signals or channels or different groups of 5G/4G signals or channels, or can be a common capability that applies to different 5G/4G signals or channels.

For example, the ‘operation’ information can be provided separately for each T/F/S resource, or a same ‘operation’ can be provided for different T/F/S resources within a same T/F/S resource pattern or a same set/group of T/F/S resource patterns or a same list of T/F/S resource patterns (with terminology as previously described).

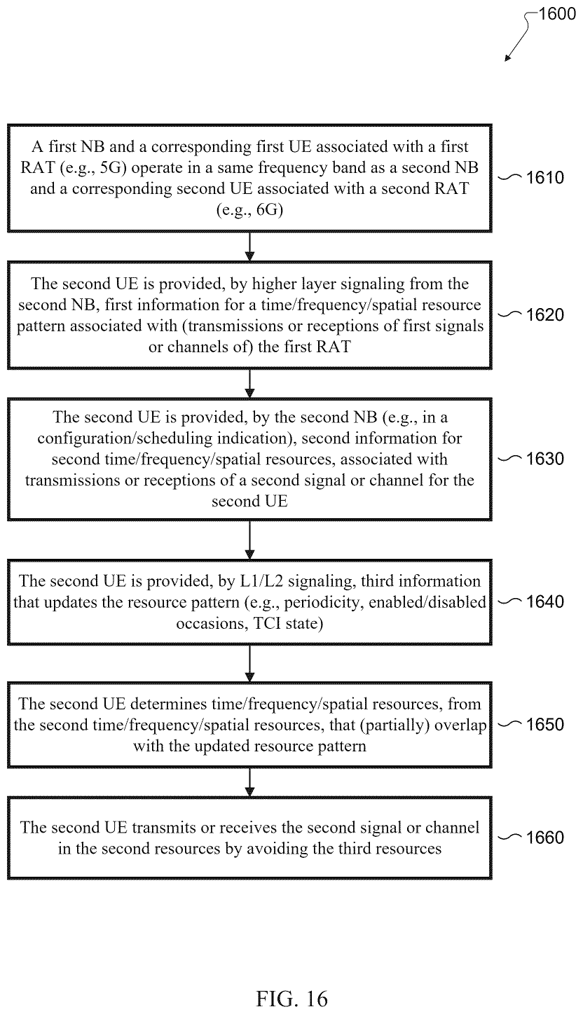

FIG. 16 illustrates a flowchart of an example procedure 1600 for reverse interference avoidance-based mechanism(s) according to embodiments of the present disclosure. For example, procedure 1600 can be performed by the BS 102 and the BS 103, and the UE 116 of FIG. 3 and the UE 112 of FIG. 1. This example is for illustration only and other embodiments can be used without departing from the scope of the present disclosure.

A first BS and corresponding first UEs associated with a first/earlier RAT (e.g., 5G) operate in a same frequency band as a second BS and corresponding second UEs associated with a second/later RAT (e.g., 6G), wherein the first BS is an MRSS-aware BS, 1610. The first BS receives from the second BS (on an inter-NB signaling interface, e.g., Xn) first information for second T/F/S resources associated with second transmissions or receptions (e.g., 6G synchronization signal, 6G system information, 6G PRACH resources) for the second UEs, 1620. The first BS provides to the first UEs second information for first T/F/S resources, associated with first transmissions or receptions for the first UEs, that do not overlap with the second T/F/S resources, 1630. The first UEs transmit or receive the first signals or the channels on the first T/F/S resources while avoiding the second T/F/S resources, 1640. The second UE determines time/frequency/spatial resources, from the second time/frequency/spatial resources, that (partially) overlap with the updated resource pattern, 1650. The second UE transmits or receives the second signal or channel in the second resources by avoiding the third resources, 1660.

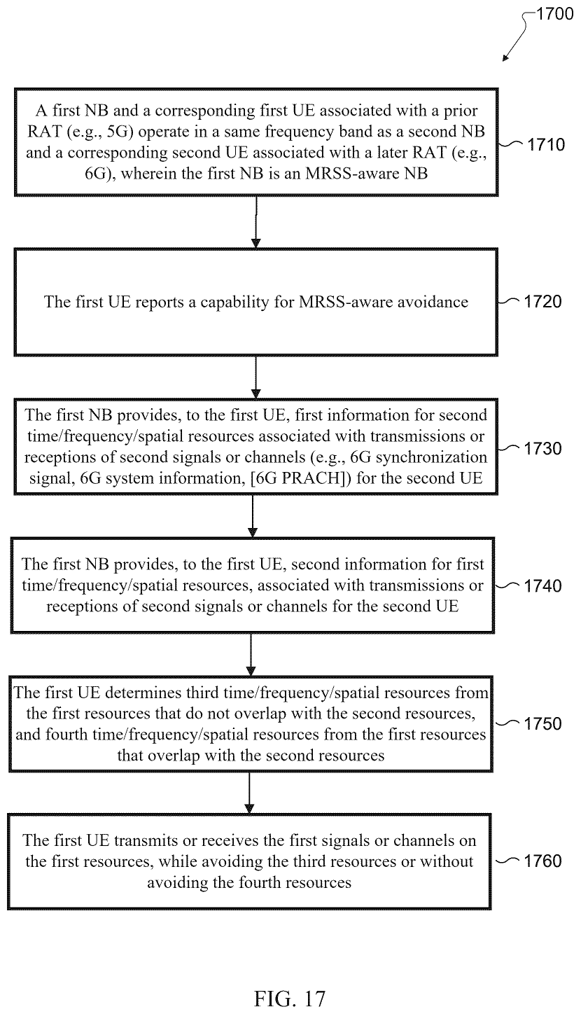

FIG. 17 illustrates a flowchart of an example procedure 1700 for reverse interference avoidance-based mechanism(s) according to embodiments of the present disclosure. For example, procedure 1700 can be performed by the BS 102 and the BS 103, and the UE 116 of FIG. 3 and the UE 113 of FIG. 1. This example is for illustration only and other embodiments can be used without departing from the scope of the present disclosure.

A first BS and a corresponding first UE associated with a prior RAT (e.g., 5G) operate in a same frequency band as a second BS and a corresponding second UE associated with a later RAT (e.g., 6G), wherein the first BS is an MRSS-aware BS, 1710. The first UE reports a capability for MRSS-aware interference avoidance, 1720. The first BS provides to the first UE first information for second T/F/S resources associated with transmissions or receptions of second signals or channels (e.g., 6G synchronization signal, 6G system information, 6G PRACH resources) for the second UE, 1730. The first BS provides to the first UE second information for first T/F/S resources associated with transmissions or receptions of first signals or channels for the first UE, 1740. The first UE determines third T/F/S resources from the first resources that do not overlap with the second resources, and fourth T/F/S resources from the first resources that overlap with the second resources, 1750. The first UE transmits or receives the first signals or channels on the first resources, while avoiding for transmissions or receptions the third resources, and without avoiding for transmissions or receptions the fourth resources, 1760.

In one embodiment, MRSS avoidance may apply to 5G/4G BSs, such as Rel-21-capable 5G/4G BS or MRSS-aware 5G/4G UEs, that can be provided information of the second T/F/S resources corresponding to the 6G cell/UEs. For example, the 5G/4G BS can use such information when configuring/indicating resources for 5G/4G cell/UEs. In one approach (BS-based reverse avoidance), the 5G/4G BS may not need to indicate any information about the second T/F/S resources to 5G/4G UEs to perform avoidance. In another approach (UE-based reverse avoidance), the 5G/4G BS may indicate information about the second T/F/S resources to 5G/4G UEs, such as Rel-21-capable 5G/4G UEs or MRSS-aware 5G/4G UEs, in order to avoid the second T/F/S resources.

In various previous examples of the present disclosure, a 6G BS/cell or a 6G UE can be regarded as “victims” of interference caused by 5G/4G BS/cell/UEs, and apply avoidance methods to protect the 6G signals or channels from being impacted by the interference from 5G/4G signals or channels. The reverse operation can be also evaluated, wherein the 5G/4G BS/cell/UEs are “victims” of interference caused by the 6G BS/cell/UEs, and apply avoidance methods to protect the 5G/4G signals or channels from being impacted by the interference from 6G signals or channels. Such reverse avoidance can be beneficial, for example, when new 5G/4G BSs or UEs are deployed and operate in shared spectrum with 6G. For example, 6G operation can be prioritized over such 5G/4G deployments, and reverse avoidance can then be applied.

Such methods apply, for example, to 5G/4G BS/cell/UEs that can be aware of the 6G presence and operation in a same spectrum, such as a same frequency band.

For example, the 5G/4G BS can be a Rel-21 5G/4G BS or MRSS-aware 5G/4G UEs are capable of interaction with the 6G BS over corresponding air interfaces (e.g., the like of Xn interface in 6G). In another example, same air interface (e.g., Xn) is applicable in 6G as in 5G, and/or various characteristics of transmissions or receptions in 6G are same or similar to those in 5G and, in such case, a new capability for interference avoidance between 6G BS/UEs and 5G/4G BS/UEs may not be needed.

In another example, the 5G/4G BS can provide to 5G UEs information related to T/F/S resources or resource patterns associated with 6G signals or channels. In one example, providing such information can be transparent without any new UE capability or procedure in 5G NR, for example, when the T/F/S resources corresponding to 6G can be incorporated into existing 5G NR mechanisms for avoidance, such as rate matching pattern configuration and indication of a pattern by a DCI field, or zero power (ZP) CSI-RS trigger configuration and an indication by a DCI field for PDSCH reception.

In another example, providing such information can include aspects that cannot be supported by existing 5G NR mechanisms, such as a new numerology, different avoidance granularity, and so on, thereby avoidance by 5G/4G UEs can be based on indication of additional information. To enable such indication, a new capability 5G/4G UE can be supported to accommodate interference from 6G cell/UEs. A 5G/4G UE with such capability can be referred to as MRSS-aware 5G/4G UE. For example, such information can be provided to the 5G/4G UE as a new information element in the 5G/4G SIB1 or an existing or new SIBx>1 or as a new RRC parameter, or as a new field, or via new/extended values for an existing field in the DCI format, such as a DCI 1_1/1_2/1_3 for scheduling a PDSCH reception or a DCI 0_1/0_2/0_3 for scheduling a PUSCH transmission.

For example, predetermined 6G signals or channels, if any, can be indicated to a 5G/4G UE as part of the 5G/4G specifications or as information provided by higher layers such as SIB or RRC.

Various methods previously applied to avoidance by 6G UEs can also apply to 5G/4G UEs, having an associated 6G-coexistence capability, when needed.

With reference to FIG. 16, an example procedure is shown for BS-based “reverse” interference avoidance-based mechanism for MRSS in case of MRSS-aware 5G BSs.

With reference to FIG. 17, an example procedure is shown for UE-based “reverse” avoidance-based mechanism for MRSS.

A first BS and a corresponding first UE associated with a prior RAT (e.g., 5G) operate in a same frequency band as a second BS and a corresponding second UE associated with a later RAT (e.g., 6G), wherein the first BS is an MRSS-aware BS, 1710. The first UE reports a capability for MRSS-aware interference avoidance, 1720. The first BS provides to the first UE first information for second T/F/S resources associated with transmissions or receptions of second signals or channels (e.g., 6G synchronization signal, 6G system information, 6G PRACH resources) for the second UE, 1730. The first BS provides to the first UE second information for first T/F/S resources associated with transmissions or receptions of first signals or channels for the first UE, 1740. The first UE determines third T/F/S resources from the first resources that do not overlap with the second resources, and fourth T/F/S resources from the first resources that overlap with the second resources, 1750. The first UE transmits or receives the first signals or channels on the first resources, while avoiding for transmissions or receptions the third resources, and without avoiding for transmissions or receptions the fourth resources, 1760.

In some realizations, a UE can provide assistance-information or side information to a gNB/BS to improve a configuration or indication of T/F/S resources that are to be avoided. For example, a UE can be configured to report measurements of candidate T/F/S resources, and the BS can use such measurement reports to determine whether certain DL/UL resources are to be configured or indicated to be avoided by the UE.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE), the method comprising:
receiving first information, from higher layers, for a number of resource patterns;
receiving a first downlink control information (DCI) format or a first medium-access-control control-element (MAC-CE) command indicating respective updated resources for first resource patterns, from the number of resource patterns, wherein the respective updated resources for a first resource pattern, from the first resource patterns:
have a respective periodicity different from,
add first resources to,
exclude second resources from, or
correspond to a value of a parameter different from,
respective resources of the first resource pattern as indicated by the first information;
receiving a second DCI format or a second MAC-CE command indicating activated resource patterns from the number of resource patterns;
receiving a third DCI format scheduling or activating a reception of a physical downlink shared channel (PDSCH) in third resources;
determining applicable resource patterns, from the activated resource patterns, for the PDSCH reception based on an indication;
determining fourth resources for the PDSCH reception, wherein the fourth resources are the third resources, except any resources overlapping with:
the respective updated resources in resource patterns from the applicable resource patterns that are among the first resource patterns, and
respective resources in resource patterns from the applicable resource patterns that are not among the first resource patterns; and
receiving the PDSCH in the fourth resources.

2. The method of claim 1, wherein each resource pattern, from the number of resource patterns, includes a number of resources in at least one of time, frequency, code, power, and spatial domains.

3. The method of claim 1, wherein:
the respective updated resources for the first resource pattern are associated with activation or deactivation or adaptation or skipping of at least one of:
a synchronization signal and physical broadcast channel (SS/PBCH),
a system information block #1 (SIB1) or another system information block (SIB),
a control resource set (CORESET), and
a cell-specific or a UE-group-specific downlink signal or channel,
associated with a first radio access technology (RAT) or with a second RAT that operates in a same frequency band as the first RAT; and
the PDSCH is associated with the first RAT.

4. The method of claim 1, wherein at least one of the first DCI format and the second DCI format is a group-common DCI (GC-DCI) format that is provided by a physical downlink control channel (PDCCH) reception in a common search space (CSS) set.

5. The method of claim 1, wherein:
the indication is by a value of a field in the third DCI format that points to second resource patterns from the activated resource patterns, and
the applicable resource patterns for the PDSCH reception are resource patterns, from the second resource patterns, that include overlapping resources with the third resources.

6. The method of claim 1, further comprising:
determining a number of transmission configuration indication (TCI) states associated with the activated resource patterns; and
determining, based on a field in the second DCI format, a first TCI state for the PDSCH reception,
wherein:
the indication includes the number of TCI states and the first TCI state, and
the applicable resource patterns:
include second resource patterns, from the activated resource patterns, with respective second TCI states, from the number of TCI states, that are same as or quasi-co-located (QCL) with the first TCI state, and
do not include third resource patterns, from the activated resource patterns, with respective third TCI states, from the number of TCI states, that are different from or not QCL with the first TCI state.

7. The method of claim 1, further comprising:
determining, based on the first information, a number of priority levels associated with the activated resource patterns; and
determining, based on a field in the second DCI format, a first priority level for the PDSCH reception,
wherein:
the indication includes the number of priority levels and the first priority level, and
the applicable resource patterns:
include second resource patterns, from the activated resource patterns, with respective second priority levels, from the number of priority levels, that are higher than or equal to the first priority level, and
do not include third resource patterns, from the activated resource patterns, with respective third priority levels, from the number of priority levels, that are lower than the first priority level.

8. A user equipment (UE) comprising:
a transceiver configured to:
receive first information, from higher layers, for a number of resource patterns;
receive a first downlink control information (DCI) format or a first medium-access-control control-element (MAC-CE) command indicating respective updated resources for first resource patterns, from the number of resource patterns, wherein the respective updated resources for a first resource pattern, from the first resource patterns:
have a respective periodicity different from,
add first resources to,
exclude second resources from, or
correspond to a value of a parameter different from,
respective resources of the first resource pattern as indicated by the first information;
receive a second DCI format or a second MAC-CE command indicating activated resource patterns from the number of resource patterns; and
receive a third DCI format scheduling or activating a reception of a physical downlink shared channel (PDSCH) in third resources; and
a processor operably coupled with the transceiver, the processor configured to:
determine applicable resource patterns, from the activated resource patterns, for the PDSCH reception based on an indication; and
determine fourth resources for the PDSCH reception, wherein the fourth resources are the third resources, except any resources overlapping with:
the respective updated resources in resource patterns from the applicable resource patterns that are among the first resource patterns, and
respective resources in resource patterns from the applicable resource patterns that are not among the first resource patterns,
wherein the transceiver is further configured to receive the PDSCH in the fourth resources.

9. The UE of claim 8, wherein each resource pattern, from the number of resource patterns, includes a number of resources in at least one of time, frequency, code, power, and spatial domains.

10. The UE of claim 8, wherein:
the respective updated resources for the first resource pattern are associated with activation or deactivation or adaptation or skipping of at least one of:
a synchronization signal and physical broadcast channel (SS/PBCH),
a system information block #1 (SIB1) or another system information block (SIB),
a control resource set (CORESET), and
a cell-specific or a UE-group-specific downlink signal or channel,
associated with a first radio access technology (RAT) or with a second RAT that operates in a same frequency band as the first RAT; and
the PDSCH is associated with the first RAT.

11. The UE of claim 8, wherein at least one of the first DCI format and the second DCI format is a group-common DCI (GC-DCI) format that is provided by a physical downlink control channel (PDCCH) reception in a common search space (CSS) set.

12. The UE of claim 8, wherein:
the indication is by a value of a field in the third DCI format that points to second resource patterns, from the activated resource patterns, and
the applicable resource patterns for the PDSCH reception are resource patterns, from the second resource patterns, that include overlapping resources with the third resources.

13. The UE of claim 8, wherein:
the processor is further configured to:
determine a number of transmission configuration indication (TCI) states associated with the activated resource patterns, and
determine, based on a field in the second DCI format, a first TCI state for the PDSCH reception;
the indication includes the number of TCI states and the first TCI state; and
the applicable resource patterns:
include second resource patterns, from the activated resource patterns, with respective second TCI states, from the number of TCI states, that are same as or quasi-co-located (QCL) with the first TCI state, and
do not include third resource patterns, from the activated resource patterns, with respective third TCI states, from the number of TCI states, that are different from or not QCL with the first TCI state.

14. The UE of claim 8, wherein:
the processor is further configured to:
determine, based on the first information, a number of priority levels associated with the activated resource patterns, and
determine, based on a field in the second DCI format, a first priority level for the PDSCH reception;
the indication includes the number of priority levels and the first priority level; and
the applicable resource patterns:
include second resource patterns, from the activated resource patterns, with second respective priority levels, from the number of priority levels, that are higher than or equal to the first priority level, and
do not include third resource patterns, from the activated resource patterns, with third respective priority levels, from the number of priority levels, that are lower than the first priority level.

15. A base station comprising:
a transceiver configured to:
transmit first information, from higher layers, for a number of resource patterns;
transmit a first downlink control information (DCI) format or a first medium-access-control control-element (MAC-CE) command indicating respective updated resources for first resource patterns, from the number of resource patterns, wherein the respective updated resources for a first resource pattern, from the first resource patterns:
have a respective periodicity different from,
add first resources to,
exclude second resources from, or
correspond to a value of a parameter different from,
respective resources of the first resource pattern as indicated by the first information;
transmit a second DCI format or a second MAC-CE command indicating activated resource patterns from the number of resource patterns; and
transmit a third DCI format scheduling or activating a transmission of a physical downlink shared channel (PDSCH) in third resources; and
a processor operably coupled with the transceiver, the processor configured to:
determine applicable resource patterns, from the activated resource patterns, for the PDSCH transmission based on an indication; and
determine fourth resources for the PDSCH transmission, wherein the fourth resources are the third resources, except any resources overlapping with resources in resource patterns from the applicable resource patterns,
wherein the transceiver is further configured to transmit the PDSCH in the fourth resources.

16. The base station of claim 15, wherein:
each resource pattern, from the number of resource patterns, includes a number of resources in at least one of time, frequency, code, power, and spatial domains;
the respective updated resources for the first resource pattern are associated with activation or deactivation or adaptation or skipping of at least one of:
a synchronization signal and physical broadcast channel (SS/PBCH),
a system information block #1 (SIB1) or another system information block (SIB),
a control resource set (CORESET), and
a cell-specific or a user equipment (UE)-group-specific downlink signal or channel,
associated with a first radio access technology (RAT) or with a second RAT that operates in a same frequency band as the first RAT; and
the PDSCH is associated with the first RAT.

17. The base station of claim 15, wherein at least one of the first DCI format and the second DCI format is a group-common DCI (GC-DCI) format that is provided by a physical downlink control channel (PDCCH) reception in a common search space (CSS) set.

18. The base station of claim 15, wherein:
the indication is by a value of a field in the third DCI format that points to second resource patterns, from the activated resource patterns, and
the applicable resource patterns for the PDSCH transmission are resource patterns, from the second resource patterns, that include overlapping resources with the third resources.

19. The base station of claim 15, wherein:
the processor is further configured to:
determine a number of transmission configuration indication (TCI) states associated with the activated resource patterns, and
determine, based on a field in the second DCI format, a first TCI state for the PDSCH transmission;
the indication includes the number of TCI states and the first TCI state; and
the applicable resource patterns:
include second resource patterns, from the activated resource patterns, with second respective TCI state, from the number of TCI states, that are s same as or quasi-co-located (QCL) with the first TCI state, and
do not include third resource patterns, from the activated resource patterns, with third respective TCI states, from the number of TCI states, that are different from or not QCL with the first TCI state.

20. The base station of claim 15, wherein:
the processor is further configured to:
determine, based on the first information, a number of priority levels associated with the activated resource patterns, and
determine, based on a field in the second DCI format, a first priority level for the PDSCH transmission;
the indication includes the number of priority levels and the first priority level; and
the applicable resource patterns:
include second resource patterns, from the activated resource patterns, with second respective priority levels, from the number of priority levels, that are higher than or equal to the first priority level, and
do not include third resource patterns, from the activated resource patterns, with third respective priority levels, from the number of priority levels, that are lower than the first priority level.
